(19) United States
(12) Patent Application Publication
(10) Pub. No.: US 2024/0192512 A1
(43) Pub. Date: Jun. 13, 2024

(54) Directional optical devices

(71) Applicant: RealD Spark, LLC, BOULDER, CO (US)

(72) Inventors: Michael G. Robinson, Boulder, CO (US); Graham J. Woodgate, Henley-on-Thames (GB); Jonathan HARROLD, Leamington Spa (GB)

(21) Appl. No.: 18/523,664

(22) Filed: Nov. 29, 2023

Related U.S. Application Data
(60) Provisional application No. 63/430,974, filed on Dec. 7, 2022.
(60) Provisional application No. 63/434,409, filed on Dec. 21, 2022.
(60) Provisional application No. 63/441,722, filed on Jan. 27, 2023.
(60) Provisional application No. 63/454,836, filed on Mar. 27, 2023.

(51) Int. Cl. G02B 27/09; F21S 41/24; F21S 43/40; F21Y 115/10; G01S 7/481; G02B 26/10; G03B 21/20

(52) U.S. Cl. CPC G02B 27/0911; F21S 41/24; F21S 43/40; G01S 7/4817; G02B 26/10; G03B 21/2033; F21Y 2115/10

(57) ABSTRACT

An anamorphic directional illumination device comprises an array of light sources arranged to input light into an anamorphic optical system. The anamorphic optical system comprises a transverse anamorphic component arranged to provide optical imaging of the array of light sources in a transverse direction. Opposed guide surfaces are arranged to guide input light along a waveguide from the transverse optical system to an extraction reflector, the extraction reflector being arranged to extract the input light. The extraction reflector is a lateral anamorphic component arranged to image the array of light sources in a lateral direction orthogonal to the transverse direction. A thin, high brightness and high efficiency controllable directional illumination device is provided that can be used for vehicle headlights, image projectors and other directional illumination and display applications.

### TECHNICAL FIELD

This disclosure generally relates to illumination from directional illumination devices and to optical stacks for providing narrow angle illumination. Embodiments include directional illumination devices for use in a vehicle external light that include headlights, reversing lights, fog lights, indicators and other vehicle lights; an ambient illumination apparatus; a light detection and ranging apparatus; or an image projection apparatus.

### BACKGROUND

Illumination systems for environmental lighting such as automobile headlights, architectural, commercial or domestic lighting may provide a narrow directional light output distribution, for example by means of focussing optics to provide spotlighting effects, or can achieve a wide directional light output distribution for example by means of diffusing optics.

Beam switching control for external vehicle headlights can achieve some control of the illuminated zone in front of the vehicle. For example, headlights that switch between dip beam and full beam profiles, reduce dazzle to oncoming vehicles while the road and kerb features remain illuminated. Adaptive Beam Control systems can produce increased control and definition of illumination zones. In one type of known adaptive beam control headlight, light from a light source is deflected by an array of micromirrors into the aperture of a projection lens, which projects on to the road.

In another known directional illumination device such as described in U.S. Pat. No. 8,985,810, herein incorporated by reference in its entirety, an array of micro-LEDs is aligned to an array of catadioptric optical elements. Light from each micro-LED is directed into a respective beam direction.

In known displays, a backlight is provided with an optical waveguide such that light from an array of LEDs is directed into the edge of a waveguide. Light escaping from the waveguide is directed towards a transmissive spatial light modulator with substantially uniform illumination. Embodiments of an imaging waveguide for a directional display backlight such as an autostereoscopic display or a privacy display are described in U.S. Pat. No. 9,519,153 and in U.S. Pat. No. 10,054,732, both of which are herein incorporated by reference in their entireties. Such embodiments of an imaging waveguide provide an image of an array of LEDs in front of the display. An observer placing an eye in the image of the LED (an optical cone) sees a substantially uniform image across the whole of the spatial light modulator.

### BRIEF SUMMARY

According to a first aspect of the present disclosure there is provided an anamorphic directional illumination device comprising: an illumination system comprising an array of light sources distributed in a lateral direction, the illumination system being arranged to output light from the light sources; and an optical system arranged to receive light from the illumination system, wherein the optical system has an optical axis and has anamorphic properties in the lateral direction and a transverse direction that are perpendicular to each other and perpendicular to the optical axis, wherein the optical system comprises: a transverse anamorphic component having positive optical power in the transverse direction, wherein the transverse anamorphic component is arranged to receive light from the illumination system and the illumination system is arranged so that light output from the transverse anamorphic component is directed in directions that are distributed in the transverse direction; and a waveguide comprising: front and rear guide surfaces arranged to guide light from the transverse anamorphic component along the waveguide; an extraction reflector arranged to reflect light that has been guided along the waveguide, wherein the extraction reflector is a lateral anamorphic component having positive optical power in the lateral direction and the extraction reflector is oriented to extract light out of the waveguide through at least one of the guide surfaces as output illumination. A compact, high efficiency, low cost illumination apparatus may be provided. The height of the emitting aperture may be reduced to advantageously achieve desirable aesthetic appearance. High illuminance of illuminated scenes may be achieved with high resolution imaging of addressable light cones in one or two dimensions. High image contrast may be achieved for adjustable beam shaping. Image glare to oncoming viewers of the illumination device may be reduced while improved visibility of scenes around the oncoming viewers may be achieved.

The optical system may comprise an input section comprising an input reflector that is the transverse anamorphic component and may be arranged to reflect the light from the illumination system and direct it along the waveguide. Increased brightness and efficiency may be achieved with reduced aberrations and increased modulation transfer function. Complexity of fabrication and assembly may be reduced.

The transverse anamorphic component may further comprise a lens. Advantageously reduced aberrations and improved fidelity for off-axis aberrations may be achieved. Contrast of operation may be increased.

The input section may further comprise an input face disposed on a front or rear side of the waveguide and facing the input reflector, and the input section may be arranged to receive the light from the illumination system through the input face. The size of the illumination device may be reduced.

The input face may extend at an acute angle to the front guide surface in the case that the input face is on the front side of the waveguide or to the rear guide surface in the case that the input face is on the rear side of the waveguide. The waveguide may further comprise a separation face extending outwardly from the one of the front and rear guide surfaces to the input face. Stray light may be reduced and efficiency of illumination increased.

The input face may extend parallel to the front guide surface in the case that the input face is on the front side of the waveguide or to the rear guide surface in the case that the input face is on the rear side of the waveguide. The input face may be coplanar with the front guide surface in the case that the input face is on the front side of the waveguide or with the rear guide surface in the case that the input face is on the rear side of the waveguide. The input face may be disposed outwardly of one of the front or rear guide surfaces. The complexity of the moulding of the waveguide may be reduced. The size of the circuitry board on which the light sources are mounted may be increased. Thermal management may be improved and luminous flux and lifetime of the light sources improved.

The input section may be integral with the waveguide. Complexity of moulding of the optical apparatus may be reduced, achieving reduced cost.

The waveguide may have an end that may be an input face through which the waveguide is arranged to receive light from the illumination system, and the input section may be a separate element from the waveguide that may further comprise an output face and may be arranged to direct light reflected by the input reflector through the output face and into the waveguide through the input face of the waveguide. Complexity of molding of the individual optical components may be reduced, achieving increased yield.

The transverse anamorphic component may comprise a lens. Losses due to reflections from metallic reflective surfaces may be reduced. Off-axis aberrations may be improved.

The lens of the transverse anamorphic component may be a compound lens. Reduced aberrations may be advantageously achieved.

The waveguide may have an end that may be an input face through which the waveguide may be arranged to receive light from the illumination system. The transverse anamorphic component may be disposed outside the waveguide, and the waveguide may be arranged to receive light from the transverse anamorphic component through the input face. Complexity of the moulding of the waveguide may be reduced.

The direction of the optical axis through the transverse anamorphic component may be inclined at an acute angle with respect to the front and rear guide surfaces of the waveguide. The input face may be inclined at an acute angle with respect to the front and rear guide surfaces of the waveguide. The extracted light cone may be provided without replicated images of the array of light sources. Advantageously stray light may be reduced.

The extraction reflector may be an end of the waveguide. Advantageously increased efficiency may be achieved. Complexity and cost of fabrication may be reduced. An emitting aperture with small height may be achieved, advantageously achieving desirable aesthetic appearance.

At least one of an input face of the waveguide, the transverse anamorphic component and the array of light sources may have a curvature in the lateral direction that compensates for field curvature of the extraction reflector. Advantageously the uniformity of the fidelity of optical cones may be increased across the field of output of the illumination device.

The front and rear guide surfaces of the waveguide may be planar and parallel. Advantageously fidelity of light cones may be improved.

The array of light sources may comprise a spatial light modulator. Resolution of light cones may be advantageously improved.

The light sources may be light emitting diodes. The cost of the array of light sources may be reduced.

The light emitting diodes may each comprise: a well; a light generation element disposed in the well and arranged to generate light in an emission band; and wavelength conversion material disposed in the well and arranged to convert at least some of light in the emission band into a conversion band, wherein the light generation elements may be disposed at different positions within the wells in which they are disposed, the different positions being arranged to compensate for chromatic dispersion in the output illumination. Advantageously the visibility of colour blur at the edge of optical light cones may be reduced. Improved fidelity of white light illumination may be achieved.

The array of light sources may comprise a backlight and a mask illuminated by the backlight, the mask having an array of apertures to form the light sources. A low cost and complexity directional illumination device may be provided high efficiency and high brightness.

The array of light sources may also be distributed in the transverse direction so that the light output from the transverse anamorphic component may be directed in the directions that are distributed in the transverse direction. Advantageously the complexity and cost of the illumination system may be reduced.

The array of light sources may have pitches in the lateral and transverse directions with a ratio that may be the same as the inverse of the ratio of optical powers of the lateral and transverse anamorphic optical elements. The light cones may be substantially the same sizes in the lateral and transverse directions.

The array of light sources may comprise two sub-arrays of light sources, each sub-array of light sources being distributed in both the lateral direction and the transverse direction, wherein the sub-arrays of light sources may have pitches in the lateral and transverse directions that may be different as between the sub-arrays. Advantageously the visibility of colour blur at the edge of optical light cones may be reduced. Improved fidelity of white light illumination may be achieved. The location of visible and infra-red optical cones may be provided to overlap. Improved fidelity of sensing of external scenes may be achieved.

The anamorphic directional illumination device may further comprise a mask extending across the array of light sources, the mask being arranged to shape a transverse boundary of the output illumination. Desirable edge profiles for illumination such as for dipped beam operation may advantageously be achieved.

The illumination system may further comprise a deflector element arranged to deflect light output from the transverse anamorphic component by a selectable amount, the deflector element being selectively operable to direct the light output from the transverse anamorphic component in the directions that may be distributed in the transverse direction. The complexity of the array of light sources and addressing system may be reduced.

The extraction reflector may be oriented to extract light out of the waveguide through the front guide surfaces as output illumination. The complexity of the optical system may be reduced. A small height emitting aperture may be achieved to provide desirable aesthetic appearance. Improved fidelity of optical cones may be provided with high efficiency.

The illumination system may comprise plural arrays of light sources and a light combiner arranged to combine light from each of the arrays of light sources to form the output light of the illumination system. Multiple spectral bands of light output may be achieved.

The anamorphic directional illumination device may further comprise a further light source arranged behind rear guide surfaces of the waveguide to output light through the waveguide. The anamorphic directional illumination device may further comprise a light sensor arranged behind rear guide surfaces of the waveguide to receive light through the waveguide. Improved functionality may be achieved in a compact arrangement.

The anamorphic directional illumination device may comprise plural illumination systems and plural optical systems, wherein each optical system may be arranged to receive light from a respective illumination system, and the waveguides of each optical system may be stacked to provide output illumination in a common direction. Each illumination system and the corresponding optical system may be arranged to provide output illumination into optical cones having angular pitches that may be different in at least one of the transverse and lateral directions. Increased fidelity of optical cones may be provided in desirable regions. Illuminance may be increased and more complex addressing of the illuminated environment achieved.

The light from the light sources may be visible light or infra-red light. Illuminance may be provided for human observation or sensing systems.

The array of light sources may comprise light sources with different spectral outputs. The different spectral outputs may include: a white light spectrum, plural different white light spectra, red light, orange light, and/or infra-red light. Desirable spectral outputs for various different functions of operation may be provided.

The anamorphic directional illumination device may further comprise a control system arranged to selectively control the illumination system. The optical cones may be controlled to achieve desirable illumination profiles.

The anamorphic directional illumination device may be a directional illumination device for a vehicle external light apparatus, wherein the light from the light sources may be visible light. Road illumination may be provided with high illuminance, high contrast, high image fidelity in a compact package with low power consumption.

According to a second aspect of the present disclosure there is provided a vehicle external light apparatus comprising: a housing for fitting to a vehicle; a transmissive cover extending across the front guide surface of the waveguide; and an anamorphic directional illumination device mounted on the housing and arranged to direct the output illumination through the transmissive cover. A robust external light may be provided.

The output illumination may be collimated output illumination. Illuminance may be provided for far field operation, for example to illuminate at or around the horizon of operation of the vehicle.

The vehicle external light apparatus may further comprise an actuator arranged to move the array of light sources in the transverse direction. The directional alignment of the illuminance pattern may be controlled to achieve desirable beam location at a resolution which is greater than that provided by the pitch of the array of light sources. Improved fidelity of illumination of a desirable scene may be achieved. The size, cost and complexity of the actuator may be reduced in comparison to an actuator that adjusts the location of the entire vehicle external light.

The vehicle external light apparatus may be a vehicle headlight apparatus wherein optionally the luminous flux of output illumination may be at least 100 lumens. Scenery may be illuminated with desirable illuminance levels.

The vehicle external light apparatus may be a vehicle reversing light apparatus or a vehicle brake light apparatus. Light may be controlled to illuminate desirable regions and reducing excessive glare.

According to a third aspect of the present disclosure there is provided an anamorphic directional illumination device according to the first aspect, being an anamorphic directional illumination device for a light detection and ranging apparatus, wherein the light from the light sources is infra-red light. According to a fourth aspect of the present disclosure there is provided a light detection and ranging apparatus comprising an anamorphic directional illumination device according to the third aspect. A compact, low cost, high brightness, high efficiency illumination apparatus with high light cone fidelity light source may be provided to achieve illumination of a scene for which measurement of object location is desirably achieved.

The light detection and ranging apparatus may further comprise a control system arranged to selectively control the illumination system to operate the light sources successively for scanning of the output illumination. Detected back-reflected illumination may be used to determine the location of objects in the illuminated scene.

According to a fifth aspect of the present disclosure there is provided an image projection apparatus comprising an anamorphic directional illumination device according to the first aspect that is arranged to focus the output illumination on a focal plane. A compact, low cost, high brightness, high efficiency image projection apparatus with acceptable image fidelity light source may be provided.

The image projection apparatus may further comprise a lens having positive optical power arranged to focus the output illumination on the focal plane. Improved image fidelity may be achieved.

The extraction reflector may have positive optical power in the lateral direction and in the transverse direction. Reduced cost and complexity may be achieved.

According to a sixth aspect of the present disclosure there is provided a directional illumination device comprising: an array of light sources distributed in a lateral direction; and a waveguide arranged to receive light from the array of light sources, wherein the waveguide may comprise: front and rear guide surfaces arranged to guide light from the light sources along the waveguide; and an extraction reflector arranged to reflect light that has been guided along the waveguide, wherein the extraction reflector has positive optical power in the lateral direction and is oriented to extract light out of the waveguide through at least one of the guide surfaces as output illumination. A compact, high efficiency, low cost illumination apparatus may be provided. The height of the emitting aperture may be reduced to advantageously achieve desirable aesthetic appearance. High illuminance of illuminated scenes may be achieved with high resolution imaging of addressable light cones in one dimension. High image contrast may be achieved for adjustable beam shaping. Image glare to oncoming viewers of the illumination device may be reduced while improved visibility of scenes around the oncoming viewers may be achieved.

The waveguide may have no optical power in a transverse direction that may be perpendicular to the lateral direction. Advantageously complexity and cost may be reduced.

The array of light sources may have an arrangement such that an intensity of light emitted by the light sources summed along each line through the light sources in the transverse direction may be the same. Improved uniformity of the illuminated scene may be achieved.

The array of light sources may also be distributed in the transverse direction. Reduced complexity of construction may be achieved.

The directional illumination device may also be a light detection device further comprising: a light detection system comprising an array of light detectors distributed in a lateral direction in an area overlapping with the array of light sources, wherein the optical system is also arranged to input light from a remote scene and direct the input light to the light detection system in an opposite direction through the optical system from the light received from the illumination system. An illumination and detection system may be provided advantageously with low cost and complexity in a small package. A compact LIDAR detection system may be provided for measurement of the external environment of a vehicle.

Any of the aspects of the present disclosure may be applied in any combination.

Embodiments of the present disclosure may be used in a variety of optical systems. The embodiments may include or work with a variety of projectors, projection systems, optical components, displays, microdisplays, computer systems, processors, self-contained projector systems, visual and/or audiovisual systems and electrical and/or optical devices. Aspects of the present disclosure may be used with practically any apparatus related to optical and electrical devices, optical systems, presentation systems or any apparatus that may contain any type of optical system. Accordingly, embodiments of the present disclosure may be employed in optical systems, devices used in visual and/or optical presentations, visual peripherals and so on and in a number of computing environments.

Before proceeding to the disclosed embodiments in detail, it should be understood that the disclosure is not limited in its application or creation to the details of the particular arrangements shown, because the disclosure is capable of other embodiments. Moreover, aspects of the disclosure may be set forth in different combinations and arrangements to define embodiments unique in their own right. Also, the terminology used herein is for the purpose of description and not of limitation.

These and other advantages and features of the present disclosure will become apparent to those of ordinary skill in the art upon reading this disclosure in its entirety.

### BRIEF DESCRIPTION OF THE DRAWINGS

Embodiments are illustrated by way of example in the accompanying FIGURES, in which like reference numbers indicate similar parts, and in which;

FIG. 1A is a schematic diagram illustrating in rear perspective view an anamorphic directional illumination device comprising a waveguide with a curved reflective transverse anamorphic component and a curved reflective lateral anamorphic component;

FIG. 1B is a schematic diagram illustrating in an alternative rear perspective view the waveguide of FIG. 1A;

FIG. 1C is a schematic diagram illustrating in side view the waveguide of FIG. 1A;

FIG. 1D is a schematic diagram illustrating in front view the waveguide of FIG. 1A;

FIG. 1E is a schematic diagram illustrating in side view an alternative anamorphic directional illumination device wherein the input face is arranged on the same side of the waveguide as the front surface of the waveguide;

FIG. 1F is a schematic diagram illustrating in side view an alternative arrangement of an anamorphic directional illumination device comprising plural members and the waveguide;

FIG. 1G is a schematic diagram illustrating in side view an alternative arrangement of an anamorphic directional illumination device wherein the front guide surface and input face are arranged on a common surface;

FIG. 1H is a schematic diagram illustrating in side view an alternative arrangement of an anamorphic directional illumination device wherein the rear guide surface and input face are arranged on a common surface;

FIG. 1I is a schematic diagram illustrating in side view an alternative arrangement of an anamorphic directional illumination device wherein the front guide surface and input face are inclined to each other;

FIG. 1J is a schematic diagram illustrating in side view an alternative arrangement of an anamorphic directional illumination device wherein the front guide surface and input face are offset from each other;

FIG. 1K is a schematic diagram illustrating in side view an alternative arrangement of an anamorphic directional illumination device comprising an alternative arrangement of separation faces;

FIG. 1L is a schematic diagram illustrating in rear perspective view an alternative arrangement of an anamorphic directional illumination device wherein the waveguide region is shortened;

FIG. 1M is a schematic diagram illustrating in side view the directional illumination device of FIG. 1L;

FIG. 1N is a schematic diagram illustrating in front view the directional illumination device of FIG. 1L;

FIG. 2A is a schematic diagram illustrating in side view a vehicle external light comprising: a housing for fitting to a vehicle, and an illumination device mounted on the housing; and a transmissive cover extending across the first light guiding surface of the waveguide;

FIG. 2B is a schematic diagram illustrating in front view the vehicle external light of FIG. 2A;

FIG. 2C is a schematic diagram illustrating in rear perspective view the optical output from a vehicle external light;

FIG. 2D is a schematic diagram illustrating in side view the optical output from a vehicle external light;

FIG. 3A is a schematic diagram illustrating in front view a light source array for the directional illumination device of FIG. 1A;

FIG. 3B is a schematic diagram illustrating in front view an alternative light source array for the directional illumination device of FIG. 1A;

FIG. 3C is a schematic diagram illustrating in side view an alternative light source array for the directional illumination device of FIG. 1A;

FIG. 3D is a schematic diagram illustrating in front view an alternative light source array for the directional illumination device of FIG. 1A;

FIG. 4A is a schematic diagram illustrating in front view a light source array for the directional illumination device of FIG. 1A further comprising a mask;

FIG. 4B is a schematic graph illustrating a variation of output profile with polar angle;

FIG. 4C is a schematic diagram illustrating a view of an illuminated driving scene for an illumination profile to provide a structured dipped beam illumination;

FIG. 5A is a schematic graph illustrating the variation of luminous flux with wavelength for a typical light source;

FIG. 5B is a schematic diagram illustrating in end view extraction of coloured light from a waveguide illuminated by a white light source;

FIG. 5C is a schematic diagram illustrating in front view extraction of coloured light from a waveguide illuminated by a white light source;

FIG. 5D is a schematic diagram illustrating in side view chromatic aberrations in a vehicular application using the waveguide of FIG. 1A and the light source array of FIG. 3B;

FIG. 6A is a schematic diagram illustrating in front view an alternative light source array for the directional illumination device of FIG. 1A;

FIG. 6B is a schematic diagram illustrating in end view extraction of coloured light from a waveguide illuminated by a light source array such as illustrated in FIG. 6A;

FIG. 6C is a schematic diagram illustrating in front view extraction of coloured light from a waveguide illuminated by a white light source by a light source array such as illustrated in FIG. 6A;

FIG. 6D is a schematic diagram illustrating in side view chromatic aberrations in a vehicular application using the waveguide of FIG. 1A and the light source array of FIG. 6A;

FIG. 7A is a schematic diagram illustrating in rear perspective view an anamorphic directional illumination device comprising a waveguide comprising a curved reflective lateral anamorphic component that is a reflection extractor and is an end of the waveguide, and a transverse anamorphic component that is a lens;

FIG. 7B is a schematic diagram illustrating in side view a waveguide comprising a curved reflective lateral anamorphic component that is a reflection extractor and is an end of the waveguide and a transverse anamorphic component that comprises a compound lens;

FIG. 7C is a schematic diagram illustrating in front view the operation of the waveguide of FIGS. 7A-B;

FIG. 8 is a schematic diagram illustrating in perspective front view the waveguide of FIG. 7A with an alternative alignment of optical cones;

FIG. 9A is a schematic diagram illustrating in side view a spatial light modulator arrangement for use in the anamorphic directional illumination device of FIG. 7A comprising separate red, green and blue spatial light modulators and a beam combining element;

FIG. 9B is a schematic diagram illustrating in side view an illumination system for use in the anamorphic directional illumination device of FIG. 7A comprising a birdbath folded arrangement;

FIG. 10A is a schematic diagram illustrating in perspective front view an alternative arrangement of an input focussing lens;

FIG. 10B is a schematic diagram illustrating in side view a light source array arrangement for use in the anamorphic directional illumination device of FIG. 1A or FIG. 7A comprising a light source array comprising a laser scanner and light diffusing screen;

FIG. 11A is a schematic diagram illustrating in side view input to the waveguide comprising a laser sources and scanning arrangement;

FIG. 11B is a schematic diagram illustrating in front view a light source array arrangement comprising an array of laser light sources for use in the arrangement of FIG. 11A;

FIG. 11C is a schematic diagram illustrating in side view a light source array arrangement comprising an array of laser light sources, a beam expander and a scanning mirror;

FIG. 12 is a schematic diagram illustrating in perspective rear view a stack of waveguides arranged to provide complementary illumination;

FIG. 13 is a schematic diagram illustrating in perspective rear view an anamorphic directional illumination device comprising a curved input face and a curved light source array;

FIG. 14A is a schematic diagram illustrating in front view an anamorphic directional illumination device wherein an input end of the waveguide has curvature in the lateral direction;

FIG. 14B is a schematic diagram illustrating in front view an anamorphic directional illumination device wherein an input end of the waveguide has curvature in the lateral direction and a transverse anamorphic component has curvature in the lateral direction;

FIG. 14C is a schematic diagram illustrating in front view an anamorphic directional illumination device wherein an input end of the waveguide has curvature in the lateral direction, a transverse anamorphic component has curvature in the lateral direction, and a light source array has curvature in the lateral direction;

FIG. 14D is a schematic diagram illustrating in front view an anamorphic directional illumination device wherein an input end of the waveguide has curvature in the lateral direction, a transverse anamorphic component has curvature in the lateral direction, and a light source array has curvature in the lateral direction, where the direction of curvature is in an opposite direction to that of FIG. 14C;

FIG. 14E is a schematic diagram illustrating in front view an anamorphic directional illumination device wherein an input end of the waveguide has curvature in the lateral direction, a transverse anamorphic component has curvature in the lateral direction, and a light source array has curvature in the lateral direction, where the direction of curvature of these components is different;

FIG. 15A is a schematic diagram illustrating in side view a vehicle comprising vehicle external lights of the present embodiments;

FIG. 15B is a schematic diagram illustrating in top view a vehicle comprising vehicle external lights of the present embodiments;

FIG. 15C is a schematic diagram illustrating in side view part of a vehicle comprising vehicle external lights that are mounted with tilted orientations;

FIG. 16 is a schematic diagram illustrating in front view vehicle external lights and a control system for vehicle external lights;

FIG. 17 is a schematic diagram illustrating in rear view vehicle external lights;

FIG. 18A is a schematic diagram illustrating in side view a vehicle external light;

FIG. 18B is a schematic diagram illustrating in front view an alternative array of light sources for the vehicle external light of FIG. 18A;

FIG. 18C is a schematic diagram illustrating in top view illumination onto a road of the vehicle external light comprising the array of light sources of FIG. 18B when the angle η is 90°;

FIG. 18D is a schematic diagram illustrating in top view illumination onto a road of the vehicle external light comprising the array of light sources of FIG. 18B when the angle η is 0°;

FIG. 18E is a schematic diagram illustrating in front view an alternative array of light sources for a vehicle external light comprising an array of elongate linear light sources;

FIG. 18F is a schematic diagram illustrating in front view an alternative array of light sources for a vehicle external light comprising an array of elongate curved light sources;

FIG. 18G is a schematic diagram illustrating in top view illumination onto a road of the vehicle external light comprising the array of light sources of FIG. 18E when the angle η is 90°, or comprising the array of light sources of FIG. 18F when the angle η is 0°;

FIG. 18H is a schematic diagram illustrating in front view an alternative array of light sources for a vehicle external light comprising a mark for a desirable angle η;

FIG. 18I is a schematic diagram illustrating in top view illumination onto a road of the vehicle external light comprising the array of light sources of FIG. 18H for the desirable angle η;

FIG. 19A is a schematic diagram illustrating in rear perspective view an anamorphic image projection device comprising a waveguide with a curved reflective transverse anamorphic component, a curved reflective lateral anamorphic component and a refractive image-forming lens arranged to provide an image on a screen;

FIG. 19B is a schematic diagram illustrating in side view the image projection device of FIG. 19A;

FIG. 19C is a schematic diagram illustrating in rear perspective view an anamorphic image projection device comprising a waveguide with a curved reflective transverse anamorphic component, and a curved reflective lateral anamorphic component arranged to provide an image on a screen;

FIG. 19D is a schematic diagram illustrating in side view the image projection device of FIG. 19C;

FIG. 20 is a schematic diagram illustrating in rear perspective view an anamorphic image projection device comprising a waveguide with a transmissive transverse anamorphic component comprising a lens and a curved reflective lateral anamorphic extraction reflector arranged to provide an image on a screen;

FIG. 21A is a schematic diagram illustrating in rear perspective view a directional illumination device comprising a waveguide with a curved reflective lateral anamorphic component arranged to provide a one-dimensional array of optical cones;

FIG. 21B is a schematic diagram illustrating in side view the directional illumination device of FIG. 21A;

FIG. 21C is a schematic diagram illustrating in front view the directional illumination device of FIG. 21A;

FIG. 22A is a schematic diagram illustrating in rear perspective view a directional illumination device comprising a waveguide with a planar reflective end and a lateral anamorphic component comprising a curved extraction reflector;

FIG. 22B is a schematic diagram illustrating in side view a directional illumination device comprising a waveguide with an input section comprising a planar reflective end and a waveguide comprising a lateral anamorphic component comprising a curved extraction reflector;

FIG. 22C is a schematic diagram illustrating in side view an alternative waveguide wherein the waveguide is formed of materials with different light absorption properties;

FIG. 22D is a schematic diagram illustrating in rear perspective view an alternative waveguide wherein the extraction reflector comprises a Fresnel reflector;

FIG. 23A is a schematic diagram illustrating in front view a light source array comprising contiguous columns of light emitters for use in the directional illumination device of FIGS. 21A-C and FIG. 22A;

FIG. 23B is a schematic diagram illustrating in front view an alternative light source array comprising contiguous columns of light emitters for use in the directional illumination device of FIGS. 21A-C and FIG. 22A;

FIG. 23C and FIG. 23D are schematic diagrams illustrating in front view a light source array comprising columns of overlapping light emitters for use in the directional illumination device of FIGS. 21A-C and FIG. 22A;

FIG. 24A is a schematic diagram illustrating in side view a waveguide arranged to illuminate a scene wherein the directional illumination device further comprises additional sensors and light sources wherein light is transmitted through at least part of the waveguide without guiding;

FIG. 24B is a schematic diagram illustrating in front view an alternative light source array for the directional illumination device of FIG. 24A;

FIG. 25A is a schematic diagram illustrating in rear perspective view an anamorphic directional illumination and light detection device comprising a waveguide with a curved reflective transverse anamorphic component and a curved reflective lateral anamorphic component;

FIG. 25B is a schematic diagram illustrating in side view an anamorphic directional illumination and light detection device;

FIG. 25C is a schematic diagram illustrating in side view a light detector array and light source array for the anamorphic directional illumination and light detection device of FIG. 25B;

FIG. 25D is a schematic diagram illustrating in front view a light detector and light source array for the anamorphic directional illumination and light detection device of FIG. 25B;

FIG. 25E is a schematic diagram illustrating in side view an alternative arrangement of an anamorphic directional illumination and light detection device comprising plural members and a waveguide;

FIG. 25F is a schematic diagram illustrating in front perspective view an anamorphic directional illumination and light detection device comprising a waveguide comprising a curved reflective lateral anamorphic component that is an injection reflector and a transverse anamorphic component that is a lens;

FIG. 25G is a schematic diagram illustrating in side view an alternative arrangement of an anamorphic directional illumination and light detection device wherein the rear guide surface and output face are arranged on a common surface;

FIG. 25H is a schematic diagram illustrating in rear perspective view an anamorphic directional illumination and light detection device comprising a curved output face and a curved detector array;

FIG. 25I is a schematic diagram illustrating in front view an anamorphic directional illumination and light detection device wherein the output end of the waveguide has curvature in the lateral direction;

FIG. 26A is a schematic diagram illustrating in front perspective view a directional illumination and light detection device comprising a waveguide with a curved reflective lateral anamorphic component arranged to provide a one-dimensional array of detection optical cones;

FIG. 26B is a schematic diagram illustrating in side view the directional illumination and light detection device of FIG. 26A; and

FIG. 26C is a schematic diagram illustrating in front view the directional illumination and light detection device of FIG. 26A.

### DETAILED DESCRIPTION

The structure and operation of various directional illumination devices will now be described. In this description, common elements have common reference numerals. It is noted that the disclosure relating to any element applies to each device in which the same or corresponding element is provided. Accordingly, for brevity such disclosure is not repeated.

It would be desirable to provide a directional illumination device for a vehicle with adjustable illumination profile by means of electronic control.

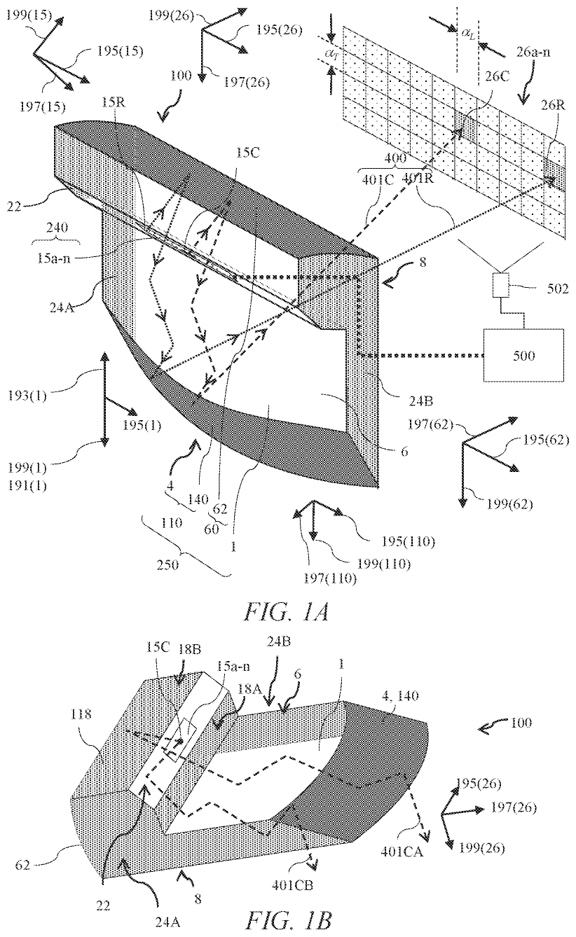

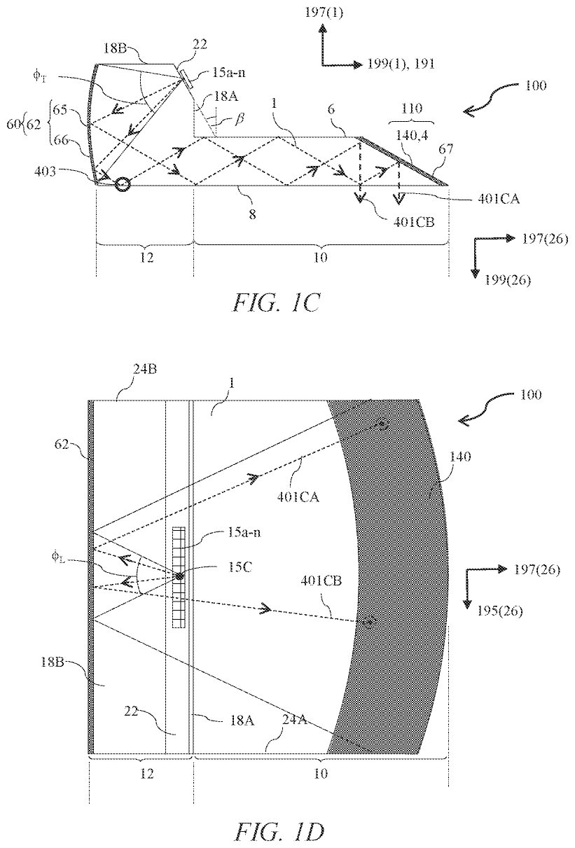

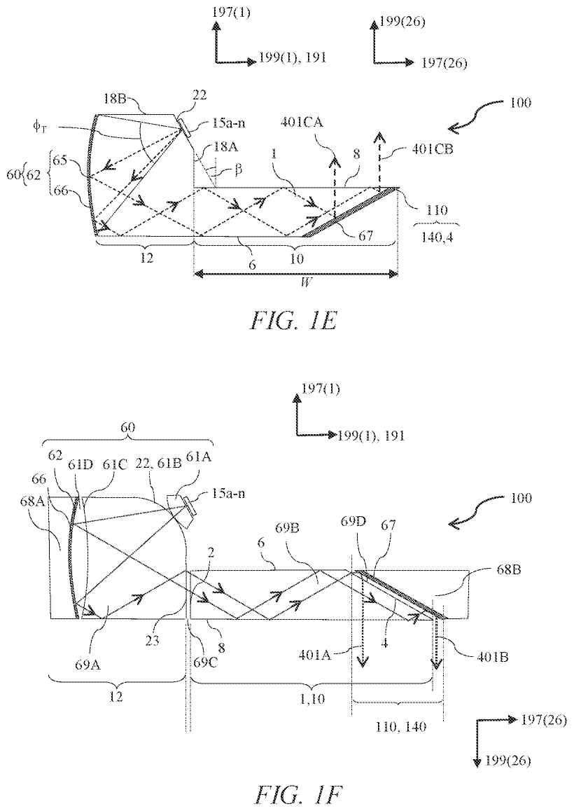

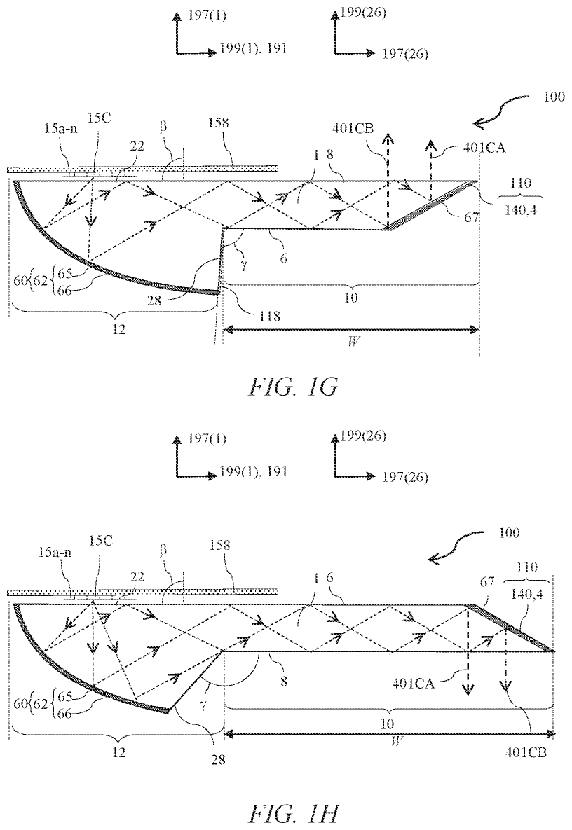

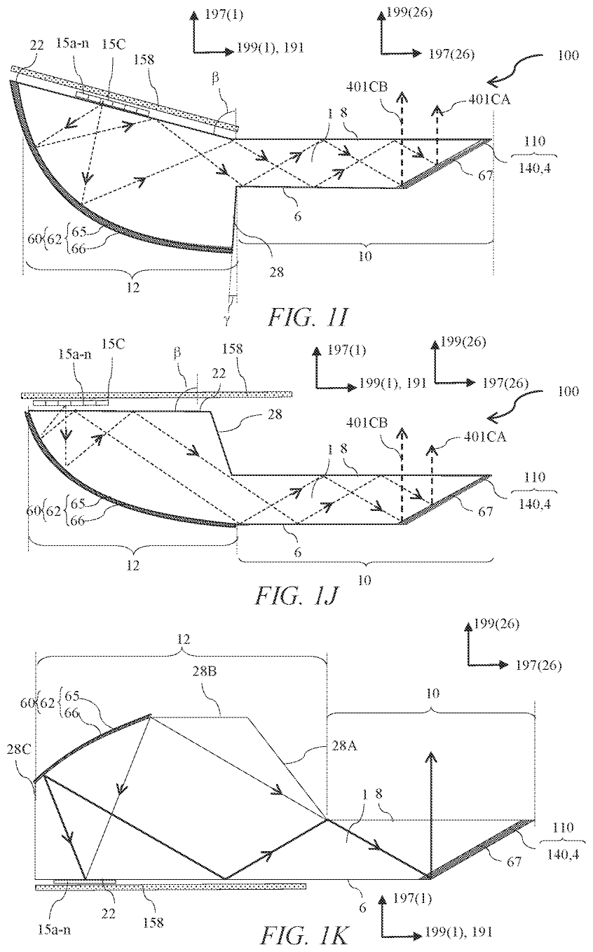

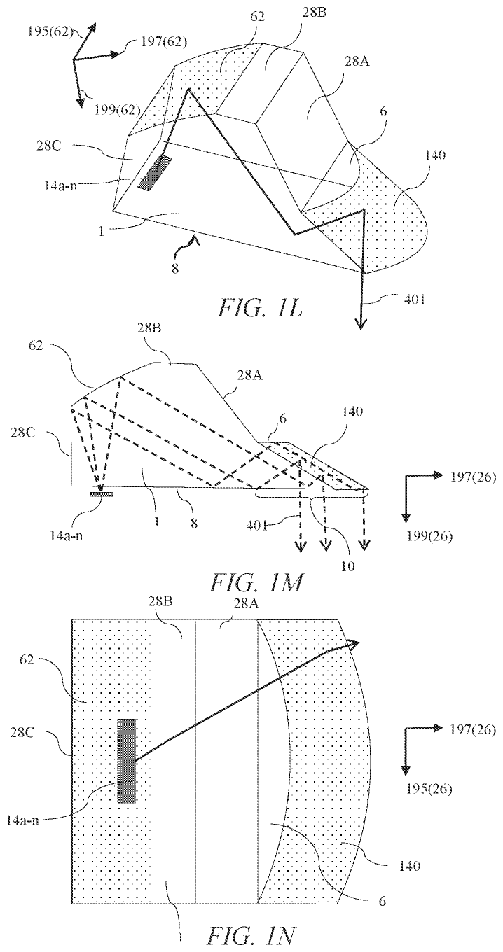

FIG. 1A is a schematic diagram illustrating in rear perspective view an anamorphic directional illumination device 100 comprising a waveguide 1 with a curved reflective transverse anamorphic component 60 and a curved reflective lateral anamorphic component 110; FIG. 1B is a schematic diagram illustrating in an alternative rear perspective view the waveguide 1 of FIG. 1A; FIG. 1C is a schematic diagram illustrating in side view the waveguide 1 of FIG. 1A; and FIG. 1D is a schematic diagram illustrating in front view the waveguide 1 of FIG. 1A.

The anamorphic directional illumination device 100 comprises: an illumination system 240 comprising an array of light sources 15a-n distributed in a lateral direction 195, the illumination system 240 being arranged to output light 400 from the light sources 15a-n.

Optical system 250 is arranged to receive light from the illumination system 240, wherein the optical system 250 has an optical axis 199 and has anamorphic properties in the lateral direction 195 and a transverse direction 197 that are perpendicular to each other and perpendicular to the optical axis 199.

Mathematically expressed, for any location within the anamorphic directional illumination device 100, the optical axis direction 199 may be referred to as the O unit vector, the transverse direction 197 may be referred to as the T unit vector and the lateral direction 195 may be referred to as the L unit vector wherein the optical axis direction 199 is the crossed product of the transverse direction 197 and the lateral direction 195:

O=T×L eqn. 1

Various surfaces of the anamorphic directional illumination device 100 transform or replicate the optical axis direction 199; however, for any given light ray 400 the expression of eqn. 1 may be applied.

The optical system 250 comprises: a transverse anamorphic component 60 having positive optical power in the transverse direction 197, wherein the transverse anamorphic component 60 is arranged to receive light from the illumination system 240. The transverse anamorphic component 60 in the embodiment of FIG. 1A is an input reflector 62 that is extended in a lateral direction 195(62) parallel to the lateral direction 195(15) of the array of light sources 15a-n. The input reflector 62 has positive optical power in a transverse direction 197(62) that is parallel to the direction 197(15) and orthogonal to the lateral direction 195(62); and no optical power in the lateral direction 195(62).

The input reflector 62 may comprise a reflective material 66 provided on the curved surface 65 of the waveguide 1. The reflective material 66 may for example comprise an aluminium or silver coating and appropriate protection layers and may be applied to the surface 65 by means of evaporation, sputtering, printing or other known application methods. Alternatively the reflective material 66 may comprise a reflective film such as ESR™ from 3M corporation that is attached to a curved surface 65 of the waveguide 1.

The input reflector 62 is arranged to receive light rays 400 from the array of light sources 15a-n. The optical system 250 is arranged so that light output from the input reflector 62 is directed in directions that are distributed in the transverse direction 197(62).

The array of light sources 15a-n comprises light sources 15a-n that provide for example a white light spectrum, plural different white light spectra, red light, orange light, and/or infra-red light. Waveguide 1 may comprise a material or combination of materials that are transparent in the wavelengths of the light 400, for example but not limited to glass, polycarbonate (PC), polymethylmethacrylate (PMMA), acrylates, urethanes, and silicone materials.

The optical system 250 comprises an input section 12 comprising an input reflector 62 that is the transverse anamorphic component 60 and is arranged to reflect the light 400 from the illumination system 240 and direct it along the waveguide 1. In the embodiment of FIGS. 1A-D, the waveguide 1 comprises input section 12 and further comprises a guiding section 10, wherein the input section 12 is integral with the waveguide 1.

The input section 12 further comprises an input face 22 disposed outwardly (i.e. rearwardly) of the rear guide surface 6 and facing the input reflector 62, and the input section 12 is arranged to receive the light 400 from the illumination system 240 through the input face 22. In the embodiment of FIGS. 1A-C, the input face 22 is disposed outwardly of the rear guide surface 6. The input face 22 is a planar surface that extends at an acute angle β to the front and rear guide surfaces 6, 8 of the waveguide 1.

More generally, the input face 22 extends at an acute angle β to the rear guide surface 6 in the case that the input face 22 is on the rear side 6 of the waveguide 1. In the illustrative example of FIG. 1C, β is 30° and is preferably between 20° and 40°. The input section 12 further comprises a separation face 18A extending outwardly (i.e. rearwardly) from the rear guide surface 6 to the input face 22. The input section 12 also comprises a face 18B extending between the input face 22 and the extraction reflector 62. Light cone with cone angle or within the waveguide 1 is directed towards the input reflector 62 with central light ray 401CA being output with maximum luminous intensity. High on-axis efficiency is advantageously achieved.

For input section 12, the illumination system 240 is arranged so that light 400 input into the waveguide 1 propagates from the input face 22 in a second direction 193 to the input reflector 62 (that is the transverse anamorphic component 60) and is output from the input reflector 62 in a first direction 191 along the waveguide 1 and such that the light 400 is directed in directions that are distributed in the transverse direction 197. In the embodiment of FIGS. 1A-D, the array of light sources 15a-n are also distributed in the transverse direction 197 so that the light output from the transverse anamorphic component 60 that comprises input reflector 62 is directed in the directions that are distributed in the transverse direction 197.

In the guiding section 10, waveguide 1 comprises: front and rear guide surfaces 8, 6 arranged to guide light from the input reflector 62 along the waveguide 1 in the first direction 191(1) that is the optical axis 199(1) along the waveguide 1 towards the extraction reflector 140. The front and rear guide surfaces 8, 6 of the waveguide 1 are planar and parallel such that light rays 401A, 401B guide between the front and rear guide surfaces 8, 6 after reflection from the input reflector 62 and towards the extraction reflector 140 in the first direction 191.

Extraction reflector 140 is arranged to reflect light that has been guided along the waveguide 1 in the first direction 191, wherein the extraction reflector 140 is a lateral anamorphic component 110 having positive optical power in the lateral direction 195, for example as illustrated in FIG. 1D. The extraction reflector 140 is oriented to extract light out of the waveguide 1 through the front guide surface 8 as output illumination for example as illustrated in FIG. 1C.

The extraction reflector 140 is an end of the waveguide 1 and comprises the curved end surface 4 of the waveguide 1. A reflective material 67 may be provided on the curved end surface 4 of the waveguide 1. The reflective material 67 may be the same as the reflective material 66. Advantageously cost and complexity of fabrication may be reduced. The extraction reflector 140 is oriented to extract light out of the waveguide 1 through the front guide surface 8 as output illumination 401A. 401B.

Referring to FIG. 1A, control system 500 is arranged to selectively control the illumination system 240 and the array of light sources 15a-n is addressable such that illustrative light source 15C may be controlled independently. The control system may further comprise camera 502 arranged to detect objects in the illuminated environment as will be described further hereinbelow.

The operation of the embodiment of FIGS. 1A-D will now be further described.

It would be desirable to provide an optical output that provides a desirable profile of illuminance onto an illuminated scene. In the present embodiment, each light source 15a-n of the illumination system 240 is arranged to be directed to a respective corresponding illumination optical cone 26a-n, wherein each illumination optical cone 26a-n is controlled by means of control of the respective light source 15a-n. For example, central illumination optical cone 26C is controlled by control of central light source 15C and illumination optical cone 26R is controlled by control of light source 15R.

Illumination optical cone 26C has an angular pitch α_{L} in the lateral direction 195 and an angular pitch α_{T} in the transverse direction 197. As will be described further hereinbelow, the angular pitches α_{L}, α_{T} are determined by the pitch P_{L}, P_{T} of the respective light source 15C and the magnification properties of the lateral anamorphic component 110 and transverse anamorphic component 60, respectively.

In the present embodiments the term optical cone, or light cone, refers to an angular cone of light that is provided by one or more light sources by the optical system 250. When projected onto a surface, the optical cones form a structured illumination pattern. Such structured illumination pattern is illustrated to represent the optical cones of the present embodiments. The term cone may alternatively be described as an optical window (or simply “window”), which is a region of space in which the illumination is provided, typically in a viewing plane. This is different from a physical window, that is the optical window of the present embodiments is not formed from a material but is a property of a light beam.

Considering FIG. 1A, light rays 401C are directed by the optical system 250 to the illumination optical cone 26C and light rays 401R are directed by the optical system 250 to the illumination optical cone 26R.

In operation, a desirable profile of illumination optical cones 26a-n is determined, for example by selecting desirable operational parameters or detecting the content of a scene using a camera and image processing. In an automotive headlight application, oncoming vehicles may for example be detected and the illumination optical cones 26a-n illumination structure adjusted accordingly, as will be described further hereinbelow.

At the input surface 2, light rays from the light sources 15a-n are refracted to a light cone within the critical angle in the material of the waveguide 1.

Considering FIG. 1B, light source 15C provides light rays 401CA, 401CB that are directed into the waveguide 1 and towards the illumination optical cone 26C from different regions on the input reflector 62 and extraction reflector 140. Light rays 401CA, 401CB are substantially parallel, and the illumination optical cone 26C is provided in the far field, for example at a distance of 25 m from a waveguide 1.

FIG. 1B further illustrates that light absorbing arrangement 118 may be provided for surfaces that are not desirably light reflecting, light transmitting or light guiding. Light absorbing arrangement 118 may thus be provided on at least one of edges 24A, 24B and faces 18A, 18B. The light absorbing arrangement 118 may comprise for example a light absorbing coating provided on the respective surfaces, or may be a roughened surface arranged to diffuse incident light onto a coating or an external light absorber. In operation, stray light that is incident onto the light absorbing arrangement 118 may not be reflected back into the waveguide 1. Advantageously the contrast ratio that may be achieved between respective adjacent illumination optical cones 26 may be improved.

Considering FIG. 1C, light rays 401CB guides within the input section 12 from the front guide surface 8 such as in the illustrative region 403 and within the guiding section 10, the light rays 401CA. 401CB each guide between the front and rear guide surfaces 8, 6.

Considering FIG. 1D, light rays 401CA, 401CB from light source 15C that are incident onto the extraction reflector 140 are provided with positive optical power in the lateral direction 195 and are subsequently output substantially parallel, in the example of FIG. 1D being out of the plane of the image and towards illumination optical cone 26C.

Edges 24A, 24B of the waveguide 1 may be arranged to absorb incident light incident thereon. Advantageously stray light may be reduced. In an alternative embodiment, edges 24A, 24B may be arranged to reflect light by metallic reflection or total internal reflection. Illumination of high angles from the waveguide 1 in the lateral direction 195 may advantageously be achieved.

Waveguide 1 of FIGS. 1A-D thus provides illumination optical cones 26a-n from respective light sources 15a-n by means of optical power in the transverse direction 197 from transverse anamorphic component 60 and optical power in the lateral direction 195 from lateral anamorphic component 110. Input reflector 62 and extraction reflector 140 may provide high numerical aperture of collection of light 400 within the waveguide 1 while achieving reduced aberrations in comparison to refractive projection lenses. Thus the maximum cone angular pitch α_{L} that may be achieved in the lateral direction 195 and the maximum cone 26 angular pitch α_{T} that may be achieved in the transverse direction 197 may be increased for desirable aberrational performance. In operation, desirable fidelity of illumination optical cones 26a-n may be provided for increased capture angles α_{L}′ α_{T}. Advantageously power consumption of the illumination apparatus may be reduced and efficiency increased.

The embodiments of FIGS. 1A-D may advantageously be achieved in a compact package that may be conveniently formed by injection moulding or other fabrication techniques at low cost. High efficiency of operation may be achieved and desirable fidelity of illumination optical cones 26a-n achieved that may be independently controlled.

FIG. 1E is a schematic diagram illustrating in side view an alternative arrangement of anamorphic directional illumination device 100 wherein the input face 22 is arranged on the same side of the waveguide 1 as the front surface 8 of the waveguide. Features of the embodiment of FIG. 1E not discussed in further detail may be assumed to correspond to the features with equivalent reference numerals as discussed above, including any potential variations in the features.

By way of comparison with the embodiment of FIG. 1C, in the alternative embodiment of FIG. 1E, the input face 22 is disposed outwardly (or on the side of) the front guide surface 8. The input face 22 extends at an acute angle β to the front guide surface 8 in the case that the input face 22 is on the front side 8 of the waveguide 1. The total thickness rearwardly of the anamorphic directional illumination device 100 is reduced. Further, as will be described with respect to FIGURES IG-H hereinbelow, the desirable length W of the guiding section 10, that may be determined by the propagation of light ray 401CA within the guiding section 10, may be different to that illustrated in FIG. 1C, achieving an alternative mechanical layout with shorter throw.

In other words, in the alternative embodiment of FIG. 1E the input face 22 is disposed outwardly (i.e. forwardly) of the front guide surface 8 and the separation face 18A extends outwardly (i.e. forwardly) from the front guide surface 8 to the input face 22. In general, where an input section 12 is provided, either integrated with the waveguide 1 or as a separate element, then the input section 12 may be disposed projecting either forwards or backwards so that the input face 22 may be provided forwardly of the front guide surface 8 or rearwardly of the rear guide surface 6. An alternative compact packaging arrangement may advantageously be achieved.

Alternative arrangements of various components of the waveguide 1 will now be described.

FIG. 1F is a schematic diagram illustrating in side view an alternative arrangement comprising plural members 68A, 68B, 69A and the waveguide 1. Features of the embodiment of FIG. 1F not discussed in further detail may be assumed to correspond to the features with equivalent reference numerals as discussed above, including any potential variations in the features.

The transverse anamorphic component 60 further comprises a lens 61 wherein the lens 61 of the transverse anamorphic component 60 is a compound lens 61. Lens 61 may comprise a refractive element 61A. Further lens 61 may comprise a lens 61B comprising the curved input surface 2 of the waveguide 1. Further lens 61 may comprise a curved surface 61C and a material 61D that may be air or a material with different refractive index to the refractive index of the waveguide 1 material. The lenses 61A-D may be arranged to reduce the aberrations of the input reflector 62 of FIGS. 1A-D. The transverse anamorphic component 60 is thus a catadioptric optical element comprising refractive and reflective optical functions. Advantageously the fidelity of the illumination optical cones 26a-n may be improved in the transverse direction.

FIG. 1F further illustrates an alternative embodiment wherein the input reflector 62 is arranged on the surface of a member 68A. The surface of the input reflector 62 may advantageously be further protected. FIG. 1F further illustrates an alternative embodiment wherein the extraction reflector 140 is arranged on the surface of a member 68B. The surface of the extraction reflector 140 may advantageously be further protected. The coatings 66, 67 may be formed on the members 68A. 68B respectively. Higher temperature processing conditions may be achieved than for coating of polymer waveguides 1. Advantageously cost may be reduced and efficiency of operation increased. Gap 69D may be provided between the waveguide 1 end 4 and member 68B, wherein the gap 69D may comprise air or a bonding material such as an adhesive.

In the alternative embodiment of FIG. 1F, the input section 12 is not integral with the waveguide 1. The waveguide 1 has an end that is an input face 2 through which the waveguide 1 is arranged to receive light from the illumination system 240, and the input section 12 is a separate element from the waveguide 1 that further comprises an output face 23 and is arranged to direct light reflected by the input reflector 62 through the output face 23 and into the waveguide 1 through the input face 2 of the waveguide 1. Further, the transverse anamorphic component 60 is disposed outside the waveguide 1, and the waveguide 1 is arranged to receive light 400 from the transverse anamorphic component 60 through the input face 2. In other words. FIG. 1F further illustrates an alternative embodiment wherein the input section 12 and the guide section 10 of the waveguide 1 are formed by separate members 69A. 69B respectively and aligned across gap 69C which may comprise air or a bonding material such as an adhesive. The members 69A. 69B may be formed separately during manufacture, reducing complexity of processing of the waveguide 1 surfaces and advantageously increasing yield.

It may be desirable to increase the area of the circuit board on which the array of light sources 15a-n is provided.

FIG. 1G is a schematic diagram illustrating in side view an alternative arrangement of anamorphic directional illumination device 100 wherein the front guide surface 8 and input face 22 are arranged on a common surface; and FIG. 1H is a schematic diagram illustrating in side view an alternative arrangement of anamorphic directional illumination device 100 wherein the rear guide surface 6 and input face 22 are arranged on a common surface. Features of the embodiments of FIGS. 1G-H not discussed in further detail may be assumed to correspond to the features with equivalent reference numerals as discussed above, including any potential variations in the features.

In the alternative embodiment of FIG. 1G, and in comparison to the embodiments hereinabove, the input section 12 further comprises an input face 22 disposed on the front side 8 of the waveguide 1 and facing the input reflector 62, and the input section 12 is arranged to receive the light 401 from the illumination system 240 through the input face 22. In the alternative embodiment of FIG. 1H, the input section 12 further comprises an input face 22 disposed on the rear side 6 of the waveguide 1 and facing the input reflector 62, and the input section 12 is arranged to receive the light 401 from the illumination system 240 through the input face 22.

The input face 22 extends parallel to the front guide surface 8 in the case that the input face 22 is on the front side of the waveguide 1 such as illustrated in FIG. 1G or to the rear guide surface 6 in the case that the input face 22 is on the rear side of the waveguide 1 such as illustrated in FIG. 1H.

Further, in the alternative embodiments of FIGS. 1G-H, the input face 22 is coplanar with the front guide surface 8 in the case that the input face 22 is on the front side of the waveguide 1 or with the rear guide surface 6 in the case that the input face 22 is on the rear side of the waveguide 1.

As described with reference to FIG. 1C and FIG. 1E hereinabove, the length W of the guiding section 10 is different between the embodiments of FIGS. 1G-H, advantageously providing alternative packaging arrangements.

Separation face 28 is provided between one of the front and rear guide surfaces 6, 8 and the input reflector 62, and inclined at an angle γ to the respective guide surfaces 6, 8 and may be arranged to minimise the visibility of stray light in the output light cones 26a-n, advantageously achieving increased contrast.

In construction, the circuitry board 158 that for example may be a metal core printed circuit board (MCPCB) may be increased in size. Advantageously thermal design may be improved, providing higher output luminance and longer lifetime at desirable luminous flux for the light sources 15a-n.

It may be desirable to provide alternative arrangements of the input face 22.

FIG. 1I is a schematic diagram illustrating in side view an alternative arrangement of anamorphic directional illumination device 100 wherein the front guide surface 8 and input face 22 are inclined to each other; and FIG. 1J is a schematic diagram illustrating in side view an alternative arrangement of anamorphic directional illumination device 100 wherein the front guide surface 8 and input face 22 are offset from each other. Features of the embodiments of FIGS. 1I-J not discussed in further detail may be assumed to correspond to the features with equivalent reference numerals as discussed above, including any potential variations in the features.

The alternative embodiments of FIGURES II-J may achieve optional arrangements for the circuit board 158 and provide alternative mechanical arrangements. The illumination properties may further be modified.

It may be desirable to reduce the visibility of stray light.

FIG. 1K is a schematic diagram illustrating in side view an alternative arrangement of anamorphic directional illumination device 100 comprising an alternative arrangement of separation faces 28A-C. Features of the embodiment of FIG. 1K not discussed in further detail may be assumed to correspond to the features with equivalent reference numerals as discussed above, including any potential variations in the features.

In the alternative embodiment of FIG. 1K, an alternative arrangement of separation faces 28A-C is provided. The separation faces 28A-C are arranged to minimise the visibility of stray light directed into the waveguide 1. Advantageously improved image contrast is achieved for the illumination optical cones 26a-n.

It may be desirable to reduce the difference in the magnification in lateral and transverse directions 195, 197.

FIG. 1L is a schematic diagram illustrating in rear perspective view an alternative arrangement of anamorphic directional illumination device 100 wherein the waveguide 1 guiding section 10 is shortened; FIG. 1M is a schematic diagram illustrating in side view the directional illumination device 100 of FIG. 1L; and FIG. 1N is a schematic diagram illustrating in front view the directional illumination device 100 of FIG. 1L. Features of the embodiments of FIGURES IL-N not discussed in further detail may be assumed to correspond to the features with equivalent reference numerals as discussed above, including any potential variations in the features.

In the alternative embodiment of FIGURES IL-N some of the light guides between front and rear light guide surfaces 8, 6 while other light is guided by one of the front and rear light guide surfaces 8, 6, illustrated by rear light guide surface 6. In comparison to FIG. 1K, in the alternative embodiment of FIGURES IL-N the separation of the extraction reflector 140 from the array of light sources 15a-n is reduced, so that the angular size of the light cones 26a-n is increased. In operation, the difference between the magnification in the lateral and transverse directions 195, 197 is reduced. The total width of the cones 26a-n in the lateral direction 195 may be increased for a given array of light sources 15a-n, so that an increased total field of illumination is achieved. Further, the separation of the transverse anamorphic component 60 from the array of light sources 15a-n may be increased, so reducing the cone 26a-n size in the lateral direction 197. Advantageously increased resolution of light cones 26a-n may be achieved in the transverse direction 197.

A vehicle external light comprising the illumination device of FIGS. 1A-D will now be described.

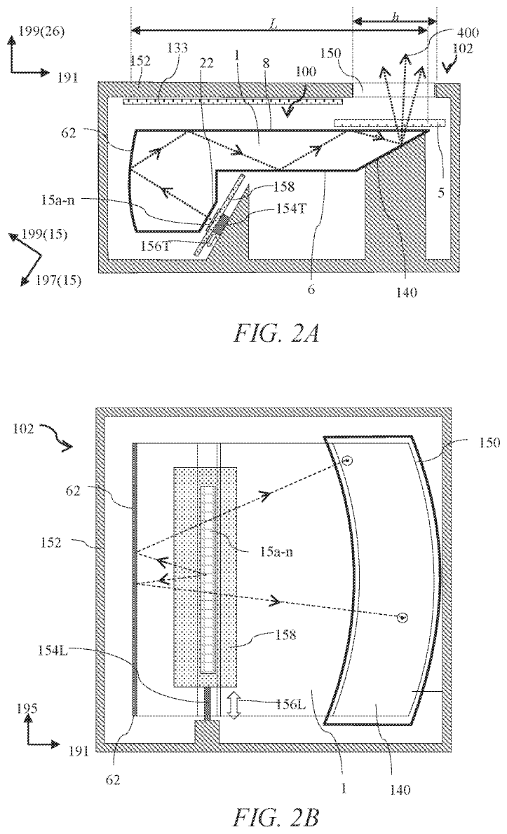

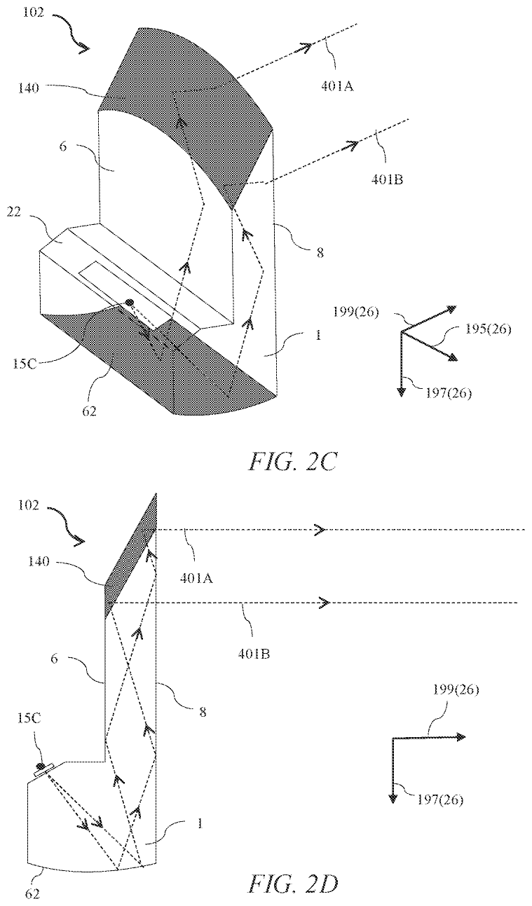

FIG. 2A is a schematic diagram illustrating in side view a vehicle external light 102 comprising: a housing 152 for fitting to a vehicle 600, and an illumination device 100 mounted on the housing; and a transmissive cover extending across the first light guiding surface of the waveguide 1; and FIG. 2B is a schematic diagram illustrating in front view the vehicle external light 102 of FIG. 2A. Features of the embodiments of FIGS. 2A-B not discussed in further detail may be assumed to correspond to the features with equivalent reference numerals as discussed above, including any potential variations in the features.

FIGS. 2A-B illustrate an alternative embodiment comprising an anamorphic directional illumination device 100, being an anamorphic directional illumination device 100 for vehicle external light apparatus 102, wherein the light from the light sources 15a-n is visible light. A vehicle external light apparatus 102 comprises: a housing 152 for fitting to a vehicle 600 (not shown); and a transmissive cover 150 extending across the front guide surface 8 of the waveguide 1. Anamorphic directional illumination device 100 is mounted on the housing 152 and arranged to direct the output illumination 400 through the transmissive cover 150. The illumination device 100 is a backlight for the transmissive cover 150.

In the alternative embodiment of FIG. 2A, the housing 152 is arranged to extend over part of the front guide surface 8 and the transmissive cover 150 is arranged to provide transmission of light output from the extraction reflector 140. In operation, the cover 150 provides high transmission to incident light and further prevents water contacting the waveguide 1. The emitting aperture height h may be small compared to the length L of the waveguide 1. The transmissive cover 150 and housing 152 may typically be curved with desirable shapes to match the shape of the vehicle exterior for example to improve aerodynamic performance and cosmetic appearance. Advantageously desirable aesthetic appearance for the light emitting aperture of the vehicle external light 102 may be achieved.

The array of light sources 15a-n may be mounted on a circuit board 158 such as a metal core printed circuit board (MC-PCB), or mounted on a flexible printed circuit which may incorporate one or more heat spreading metal layers. Housing 152 may further be provided for attachment of the LED lightbar 156, and may provide a heat-sink. Advantageously LED junction temperature may be reduced and efficiency and lifetime increased.

Support members, foams and adhesive tapes may be provided to achieve mechanical alignment of the waveguide 1 to the array of light sources 15a-n. A heater 133 may be provided on the housing 152 or within the housing 152 to provide de-misting and de-icing of the transmissive cover 150. Waste heat from the light sources may be directed to the transparent cover 150 for example by means of the housing 152. Further, heater elements such as transparent resistive coatings may be formed on the transmissive cover 150 to minimise fogging.

Optional diffuser 5 may be provided to achieve some blurring between adjacent illumination optical cones 26a-n. The diffuser 5 may be attached to the cover 150 or may be formed in the surface of the cover 150, for example by injection moulding. Advantageously uniformity of the illumination profile may be increased.

It may be desirable to achieve angular control of the nominal direction of the array of illumination optical cones 26a-n that is smaller than the size of the individual illumination optical cones 26a-n.

FIGS. 2A-B further illustrate an alternative embodiment comprising actuators 154T. 154L arranged to provide translation 156T. 156L respectively of the array of light sources 15a-n in the transverse direction 197(15) or lateral direction 195 respectively. In operation, the array of light sources 15a-n are translated so that the nominal optical axis direction 199(26) of the illumination optical cones 26a-n is tuned. In an illustrative example, the angular size of the illumination optical cone 26C is determined by the size of the light source 15C and transverse anamorphic component 60 optical power is 1° and the desirable pointing accuracy towards the horizon direction is 0.1°. Such control of pointing accuracy can be achieved by translation 156T in the transverse direction 197. Advantageously the size and power requirements of the actuator 154T may be substantially lower than for actuators that are arranged to steer the vehicle external light apparatus 102.

FIG. 2C is a schematic diagram illustrating in rear perspective view the light 401A. 401B output from a vehicle external light 102; and FIG. 2D is a schematic diagram illustrating in side view the light 401A. 401B output from a vehicle external light 102. Features of the embodiments of FIGS. 2C-D not discussed in further detail may be assumed to correspond to the features with equivalent reference numerals as discussed above, including any potential variations in the features.

In the alternative embodiments of FIGS. 2C-D, the output illumination illustrated by rays 401A. 401B is collimated output illumination, that is the light rays 401A. 401B are substantially parallel across the extraction reflector 140 for a single light source 15C. In practice, some non-parallel behaviour is provided by aberrations of the optical system 250 although desirably the aberrations are minimised.

Such an arrangement of collimated output rays 401A. 410B advantageously achieves increased fidelity of illumination optical cones 26a-n when the illumination optical cones 26a-n are in the far field of the vehicle external light 102, for example illuminating a scene 450 as described elsewhere herein.

Arrangements of light source array 15a-n will now be described.

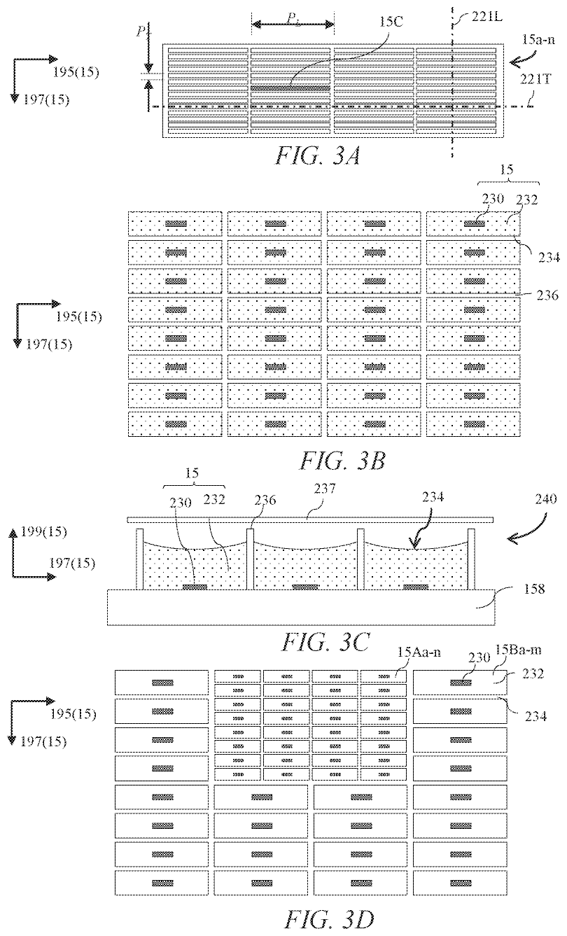

FIG. 3A is a schematic diagram illustrating in front view a light source array 15a-n for the anamorphic directional illumination device 100 of FIG. 1A; FIG. 3B is a schematic diagram illustrating in front view an alternative light source array 15a-n for the anamorphic directional illumination device 100 of FIG. 1A; FIG. 3C is a schematic diagram illustrating in side view an alternative light source array 15a-n for the directional illumination device of FIG. 1A; and FIG. 3D is a schematic diagram illustrating in front view an alternative light source array 15a-n for the anamorphic directional illumination device 100 of FIG. 1A. Features of the embodiments of FIGS. 3A-D not discussed in further detail may be assumed to correspond to the features with equivalent reference numerals as discussed above, including any potential variations in the features.

FIG. 3A illustrates an arrangement of light sources 15a-n which have pitches P_{L}, P_{T} in the lateral and transverse directions 195, 197. The row 221T of light sources 15 provides a row of illumination optical cones 26 when imaged by the lateral anamorphic component 110, and column 221L of light sources provides a column of illumination optical cones 26 when imaged by the transverse anamorphic component 60 as described hereinabove.

The angular magnification M_{L}, M_{T} of the lateral and transverse anamorphic optical elements 110, 60 is proportional to the respective optical power K_{L}, K_{T} of said elements 60, 110. In the alternative embodiment of FIG. 3A, the array of light sources 15a-n may be arranged with pitches P_{L}, P_{T} in the lateral and transverse directions 195, 197 with a ratio that is the same as the inverse of the ratio of optical powers K_{L}, K_{T} of the lateral and transverse anamorphic optical elements 110, 60. In operation the illumination optical cones 26 have the same angular extent in the lateral and transverse directions 195, 197.

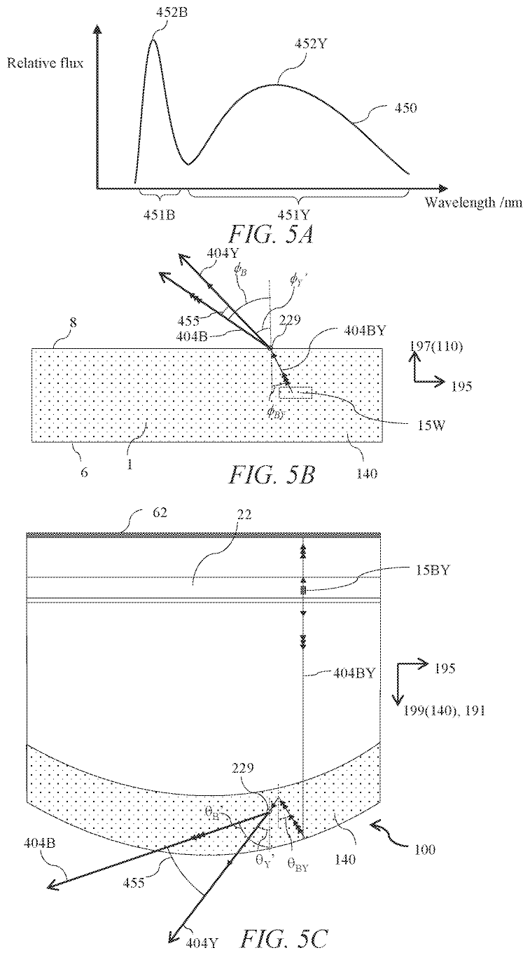

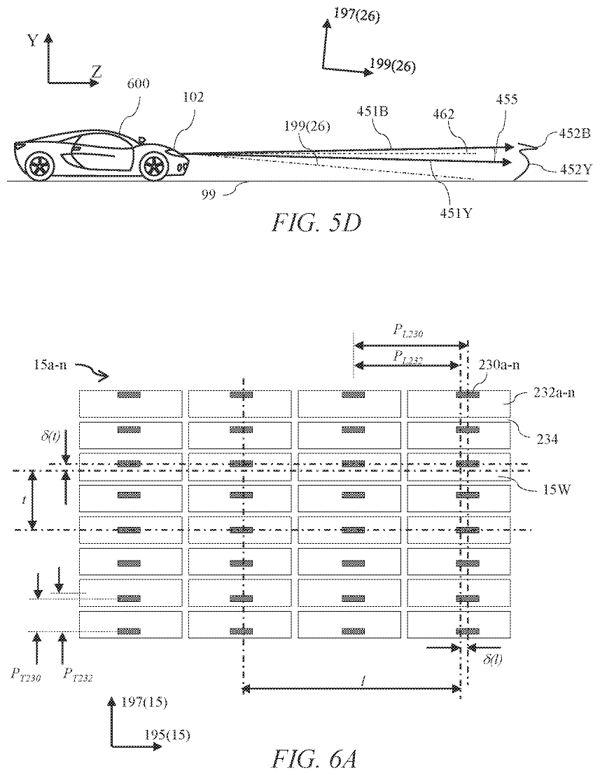

The light sources 15a-n may comprise light emitting diodes. In the alternative embodiment of FIG. 3B, the light emitting diodes each comprise: a well 234; and a light generation element 230 disposed in the well 234 and arranged to generate light in an emission band 451B as will be illustrated in FIG. 5A hereinbelow. A wavelength conversion material 232 is disposed in the well 234 and arranged to convert at least some of light in the emission band 451B into a conversion band 451Y.

In other words, each light source 15 comprises a light generation element 230 and a wavelength conversion element 232 arranged in a well 234 as illustrated in FIG. 3C. Wells 234 are separated by barriers 234. The light generation element 230 may for example comprise a gallium nitride LED arranged to provide a blue central wavelength band and the wavelength conversion material may comprise a phosphor or quantum dot material arranged to provide a yellow central wavelength band so that the combined output is white of a desirable colour temperature.

It may be desirable to provide higher resolution of illumination optical cones 26a-n in the direction close to the horizon 462 and in directions most likely to encounter nearby vehicles 610.

The alternative embodiment of FIG. 3D illustrates a light source array 15a-n comprising two different sizes and pitches P_{L}, P_{T} of light sources 15A, 15B respectively. The smaller light sources 15Aa-n are arranged to provide smaller illumination optical cones 26Aa-n after imaging by the anamorphic directional illumination device 100, and in particular in the angular regions where the modulation transfer function of the optical system 250 is the greatest. Outside the angular region of the smaller illumination optical cones 26A, illumination optical cones 26B are provided by larger light sources 15Ba-m. The cost and complexity of the outer light sources 15Ba-m and control system 500 may be advantageously reduced. In alternative embodiments not shown, the sizes and pitches of the light sources 15 may vary across the light source array 15a-n with different packing arrangements to achieve desirable output illumination characteristics.

In the embodiment of FIG. 1A, there is a one-to-one correspondence between the number of light sources 15a-n and the number of illumination optical cones 26a-m, wherein m n. In alternative embodiments, some of the light sources 15a-n may be addressed to provide common output so that there is not a one-to-one correspondence between the number of light sources 15a-n and the number of illumination optical cones 26a-m, wherein m n. As illustrated in FIG. 3C, optionally diffusers 237 and/or alternative light mixing mechanisms may be arranged in the illumination system 240 to mix light from the array of light sources 15a-m to provide improved uniformity of illumination optical cones 26a-n.

In other alternative embodiments described further hereinbelow, a spatial light modulator 48 may be arranged between the array of light sources 15a-n so that the number of illumination optical cones 26a-p is provided wherein p≥n and n≥1.

It may be desirable to provide a modified edge profile of illumination of the illumination optical cones 26a-n.

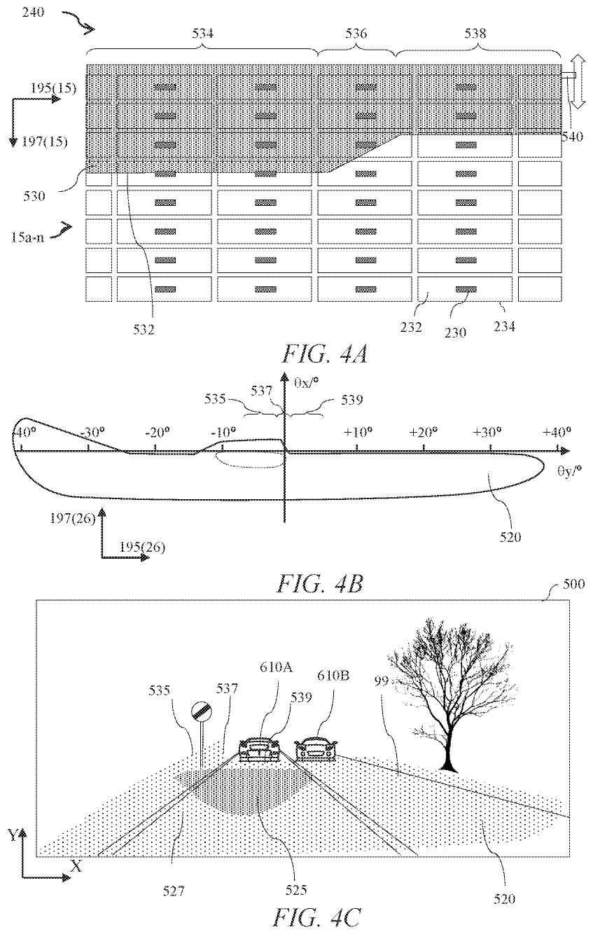

FIG. 4A is a schematic diagram illustrating in front view a light source array 15a-n for the anamorphic directional illumination device 100 of FIG. 1A further comprising a mask 238; FIG. 4B is a schematic graph illustrating a variation of output profile with polar angle for a dipped beam; and FIG. 4C is a schematic diagram illustrating a view of an illuminated driving scene 450 for the illumination profile to provide a structured dipped beam illumination of FIG. 4B. Features of the embodiments of FIGS. 4A-C not discussed in further detail may be assumed to correspond to the features with equivalent reference numerals as discussed above, including any potential variations in the features.

In the alternative embodiment of FIGS. 4A-C, the light from the light sources 15a-n of a vehicle headlight apparatus 102 provide visible light and are arranged to provide illumination of a driving scene 450 comprising road 99, street furniture and other vehicles wherein the luminous flux of output illumination is at least 100 lumens and more typically 1000 lumens.

FIG. 4A illustrates an alternative array of light sources 15a-n. The illumination system 240 further comprises a mask 530 extending across the array of light sources 15a-n, the mask 530 being arranged to shape a transverse boundary 531 of the output illumination, to provide illumination optical cones 26a-n that are shaped in the transverse direction 197(26) across the lateral direction 195(26).

The illumination system 240 further comprises a light absorbing mask 530 arranged to block light 400 from aligned light sources 15a-n propagating into the optical system 250 of FIG. 1A for example. Mask 532 may comprise a metal mask for example. The edge 532 of the mask is illustrated for a central portion of the illumination pattern 520 of FIG. 4B. Mask edge portion 534 has a different position in the lateral direction 197 to the mask edge portion 538 and mask edge portion 536 is inclined at an angle in the lateral and transverse directions 195, 197.

As illustrated in FIGS. 4B-C, mask edge portions 534, 536, 538 are imaged as illumination edge portions 535, 537, 539 respectively in the far field illumination profile 520. Advantageously cars 610A. 610B do not receive excessive glare from the anamorphic illumination device 100.

The profile of high and low illuminance regions 525, 527 is adjusted by control of the light sources 15a-n that are not covered by the mask.

To switch between high beam and low beam operation, the mask may be removed by actuator 540 such that more light sources 15 are arranged to provide illumination into the optical system 250. Alternatively the actuator 540 may be arranged to translate in dip beam mode so that the horizon line is adjusted against the direction of the visual horizon in dependence on the road 99 geometry and vehicle 600 alignment. Advantageously glare may be reduced and illumination of road furniture enhanced.

An origin of chromatic aberrations at illumination edges of the illumination profile 520 will now be described.

FIG. 5A is a schematic graph illustrating the variation of luminous flux with wavelength for a typical light source of the array of light sources 15a-n; FIG. 5B is a schematic diagram illustrating in end view extraction of coloured light from a waveguide 1 illuminated by a white light source 15W; and FIG. 5C is a schematic diagram illustrating in front view extraction of coloured light from a waveguide 1 illuminated by a white light source 15. Features of the embodiments of FIGS. 5A-C not discussed in further detail may be assumed to correspond to the features with equivalent reference numerals as discussed above, including any potential variations in the features.

FIG. 5A is an illustrative spectral profile for a blue light generation element 230 and a yellow wavelength conversion element 232 such as a phosphor, for example as illustrated in FIGS. 3B-C.

FIG. 5B illustrates a view of propagation of a white light ray 404BY comprising blue spectral peak 452B and yellow spectral peak 452Y from a single point on an illustrative white light source 15W after reflection from extraction reflector 140. In alternative embodiments (not shown), the white light sources 15a-n may provide other spectral peaks such as red, green and blue spectral peaks, the analysis hereinbelow being extended correspondingly.

The white light ray 404BY is incident at location 229 on the front guide surface 8 and output towards the far field. The dispersion of the material from which the extraction waveguide 1 is formed means that for a given angle of incidence ϕ_{BT} (with lateral and transverse direction components) output directions 404B, 404Y are provided for illustrative blue and yellow spectral peaks 452B, 452Y, providing output directions ϕ_{B}′, ϕ_{Y}′. For typical dispersive materials, ϕ_{T}′ or is less than ϕ_{B}′. The colour blur 455 when imaged into the far field provides undesirable splitting of blue and yellow edges in the illumination profile 520.

FIG. 5C further illustrates a different view of the propagation of a light ray 404BY. In operation, ray 404BY is outputted to the far field in a ray bundle that is most typically output from illustrative white light source 15BY in a direction close to the optical axis 199(140) direction when propagating in the first direction 191. Such operation may be referred to as telecentric operation. Ray 404BY is reflected by the extraction reflector 140 to the front guide surface 8 at location 229 provide the output light rays 404B. 404Y separated by an angle of colour blur 455.

FIG. 5D is a schematic diagram illustrating in side view chromatic aberrations in a vehicular application using the waveguide 1 of FIG. 1A and the light source array 15a-n of FIG. 3B.

Horizon direction 462 is offset from the optical axis 199(26) of the vehicle headlight apparatus 102. Colour blur 455 provides different light rays 451B. 451Y arising from the refraction at the front guide surface 8 illustrated in FIGS. 5B-C.

It would be desirable to reduce the angular size of the colour blur 455.

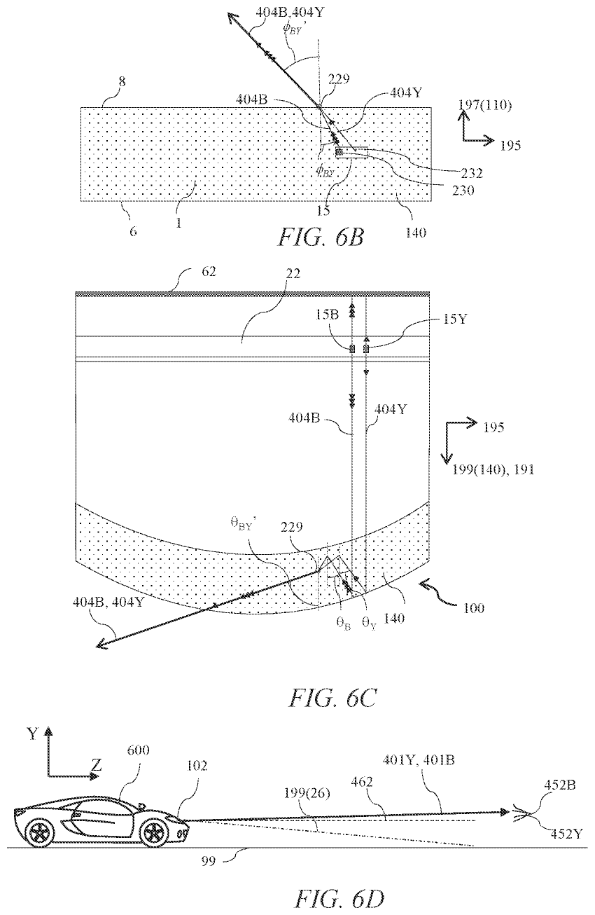

FIG. 6A is a schematic diagram illustrating in front view an alternative light source array 15a-n for the anamorphic directional illumination device 100 of FIG. 1A; FIG. 6B is a schematic diagram illustrating in end view extraction of coloured light from a waveguide illuminated by a light source array such as illustrated in FIG. 6A; FIG. 6C is a schematic diagram illustrating in front view extraction of coloured light from a waveguide illuminated by a white light source by a light source array such as illustrated in FIG. 6A; and FIG. 6D is a schematic diagram illustrating in side view chromatic aberrations in a vehicular application using the waveguide 1 of FIG. 1A and the light source array 15a-n of FIG. 6A. Features of the embodiments of FIGS. 6A-D not discussed in further detail may be assumed to correspond to the features with equivalent reference numerals as discussed above, including any potential variations in the features.

In comparison to the embodiment of FIG. 3B, in the alternative embodiment of FIG. 6A, the array of light sources 15a-n comprises two sub-arrays of light sources comprising light generation elements 230a-n, and wavelength conversion elements 232a-n respectively, each sub-array of light sources being distributed in both the lateral direction 195 and the transverse direction 197 wherein the sub-arrays of light sources 230a-n, 232a-n have pitches P_{L230}, P_{L232} in the lateral direction 195 and pitches P_{T230}, P_{T232} in the transverse direction 197 that are different as between the sub-arrays.

The light generation elements 230a-n are disposed at different positions within the wells 234 in which they are disposed, the different positions being arranged to compensate for chromatic dispersion in the output illumination directed towards illumination optical cones 26a-n. In other words, the location of the blue light generation element 230a-n compared to the central location of the respective light source 15W is offset from the nominal light source centre by an amount δ(l) in the lateral direction 195 in correspondence to the lateral location l and δ(t) in the transverse direction 197 in correspondence to the transverse location t.

In operation, the light source 15W has luminous intensity variation across the well 234 with a blue centre of gravity around the blue light generation element 230a-n and a yellow centre of gravity corresponding to the distribution of wavelength conversion material 232a-n within the well 236.

In an alternative embodiment of light source array 15a-n (not shown), the array of light sources 15a-n may be provided with an array of blue light sources 15Ba-n and an array of yellow light sources 15Ya-n that may each comprise a respective blue emitting element and a yellow conversion element so that mostly yellow light is output. The blue light sources 15B are not co-located in the respective wells 236 of the yellow light sources 15Y. The relative location of the blue and yellow light sources is as illustrated in FIG. 6A.

In comparison to FIGS. 5B-C, FIGS. 6B-C illustrate output ray directions 404BY that are the same for the rays 404B, 404Y incident onto the location 229 at the front guide surface 8. Thus in FIG. 6B, angles of incidence ϕ_{B}, ϕ_{T}, for rays 404B, 404Y respectively are output with a common angle of refraction ϕ_{BY}′, and for FIG. 6C, angles of incidence θ_{B}, θ_{Y}, for rays 404B, 404Y respectively are output with a common angle of refraction θ_{BY}′. To achieve the rays 404B, 404Y the light sources 15B. 15Y (being the centre of gravity of yellow light emission) are spatially separated on the array of light sources 15a-n.

As illustrated in FIG. 6D, advantageously chromatic blur due to refraction at the front guide surface 8 is reduced and advantageously appearance of colour splitting of illumination between adjacent illuminated and non-illuminated zones reduced.

Arrangements of transverse anamorphic component 60 comprising lenses will now be described.

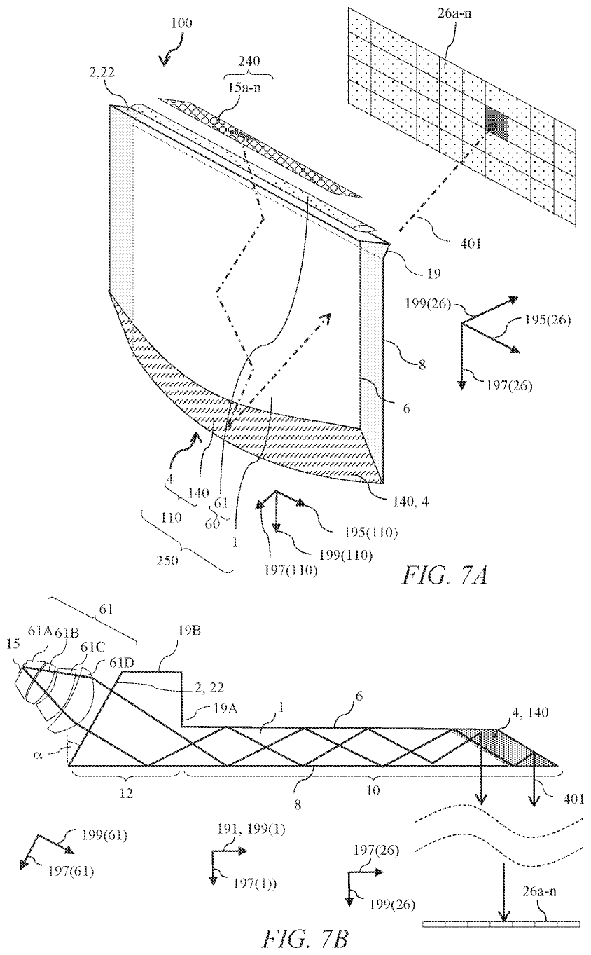

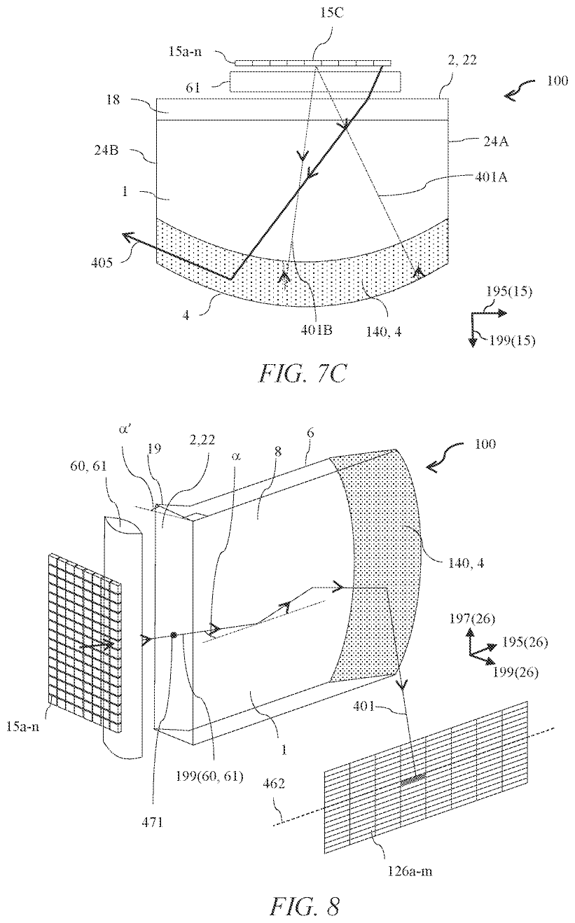

FIG. 7A is a schematic diagram illustrating in front perspective view an anamorphic directional illumination device 100 comprising a waveguide 1 comprising a curved reflective lateral anamorphic component 110 that is a reflection extractor 140 and is an end 4 of the waveguide 1, and a transverse anamorphic component 60 that is a lens 61; FIG. 7B is a schematic diagram illustrating in side view a waveguide 1 comprising a curved reflective lateral anamorphic component 110 that is a reflection extractor 140 and is an end 4 of the waveguide 1, and a transverse anamorphic component 60 that comprises a compound lens 61A-D; and FIG. 7C is a schematic diagram illustrating in front view the operation of the waveguide 1 of FIGS. 7A-B. Features of the embodiments of FIGS. 7A-C not discussed in further detail may be assumed to correspond to the features with equivalent reference numerals as discussed above, including any potential variations in the features.

By way of comparison with FIG. 1A, in the alternative embodiment of FIG. 7A, the waveguide 1 has an end 2 that is an input face 22 through which the waveguide 1 is arranged to receive light from the illumination system 240. The transverse anamorphic component 60 is disposed outside the waveguide 1, and the waveguide 1 is arranged to receive light 400 from the transverse anamorphic component 60 through the input face 22 that is an end 2 of the waveguide 1.

Further, the transverse anamorphic component 60 comprises a lens 61. As illustrated in the alternative embodiment of FIG. 7B, the lens 61 may be a compound lens comprising lens elements 61A-D of FIG. 7B. Advantageously aberrational performance may be improved in the transverse direction 197 and the illumination optical cones 26a-n may be provided with increased fidelity. Sharpness of the edges of the illumination optical cones 26a-n may be increased and contrast between illuminated and non-illuminated illumination optical cones 26 increased.

FIG. 7B further illustrates that the input section 12 comprises non-input surfaces 19A. 19B such that light 401 is input into the guiding section 10 at an angle and propagates in the first direction 191 along the waveguide 1.

Light is input through the input face 22 that is an end 2 of the waveguide 1 whereas in FIG. 1A the input reflector 62 comprises an end 2 of the waveguide 1. Advantageously light losses from the reflectivity of the input reflector 62 in FIG. 1A are not present.

The alternative embodiment of FIG. 7A illustrates a single separation face 19 extending between the front guide surface 8 and the input face 22 whereas FIG. 7B further illustrates a first separation face 19B extending outwardly (i.e. rearwardly) from the rear guide surface 6 to a second separation face 19A extending between the first separation face 19B and the input face 22. The arrangement of separation faces 19 may be provided to minimize stray light, advantageously increasing contrast of illumination optical cones 26a-n.

It may be desirable to provide a different orientation of the anamorphic directional illumination device 100.

FIG. 8 is a schematic diagram illustrating in perspective front view a waveguide 1 of FIG. 7A with an alternative alignment of illumination optical cones 26a-n. Features of the embodiment of FIG. 8 not discussed in further detail may be assumed to correspond to the features with equivalent reference numerals as discussed above, including any potential variations in the features.

In the alternative embodiments of FIGS. 7A-C and FIG. 8, the direction of the optical axis 199 through the transverse anamorphic component 60 is inclined at an acute angle α with respect to the front and rear guide surfaces 8, 6 of the waveguide 1 and the input face 22 is inclined at an acute angle α′ with respect to the front and rear guide surfaces 8, 6 of the waveguide 1. The acute angles α, α′ may be the same and in operation, light rays that are parallel to the optical axis 199(60) are passed through the input face 22, for example at illustrative point 471, without deviating due to refraction. Advantageously reduced aberrations are achieved for on-axis light. Further, the light cones are arranged to guide along the waveguide at angles different to directions along the waveguide in the transverse direction 197(1). The light cones 26a-n may be provided without a set of light cones that have been reflected in the transverse direction, advantageously reducing the visibility of stray light and fidelity of the output set of light rays.

In comparison to the embodiment of FIG. 7A, the extraction reflector 140 is arranged with a portrait orientation which may be considered more aesthetically desirable. Further the aberration performance of the illumination optical cones 26a-n may be different between the transverse and lateral directions 197, 195. Aberrations along the horizon 462 may be controlled differently in comparison to the embodiment of FIG. 1A by compound lens 61A-D. Advantageously a sharper transition may be achieved.

Alternative light source input arrangements will now be described.

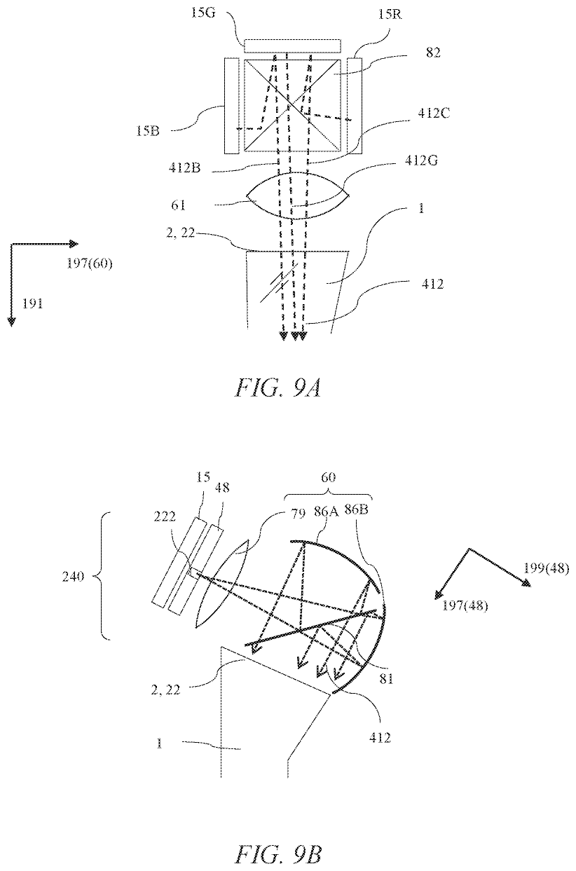

FIG. 9A is a schematic diagram illustrating in side view an illumination system 240 for use in the anamorphic directional illumination device of FIG. 1A or FIG. 7A comprising separate red, green and blue light source arrays 15R. 15G. 15B and a light combiner 82. Features of the embodiment of FIG. 9A not discussed in further detail may be assumed to correspond to the features with equivalent reference numerals as discussed above, including any potential variations in the features.

The illumination system 240 comprises plural arrays of light sources 15Ra-m, 15Ga-n, 15Ba-p and a light combiner 82 arranged to combine light from each of the arrays of light sources 15a-n to form the output light of the illumination system 240.

The embodiments described hereinbefore have comprised light generation element 230 and a wavelength conversion element 232 arranged in a well 234. It may be desirable to provide illumination from multiple different light source arrays.

The alternative embodiment of FIG. 9A illustrates that the illumination system 240 may comprise red, green and blue light source arrays 15Ra-m, 15Ga-n, 15Ba-p and a colour combining prism arrange to direct light rays 412R, 412G, 412B towards the transverse anamorphic component 60. Such an arrangement may be used to provide high resolution colour control of optical cones 26Ra-m, 26Ga-n, 26Ba-p. Such coloured illumination optical cones 26Ra-m, 26Ga-n, 26Ba-p may achieve controlled illumination of scenes with appropriate coloured light. Advantageously increased information may be provided to drivers for example to provide coloured illumination of particular hazards or safe driving directions.

The light source arrays 15Ra-m, 15Ga-n, 15Ba-p may be provided with common semiconductor technologies for each of the light source arrays 15Ra-m, 15Ga-n, 15Ba-p to achieve high efficiency coloured output. The light source arrays may comprise monolithic wafers or may comprise separate elements provided by pick and place of LED packages or mass transfer technologies.

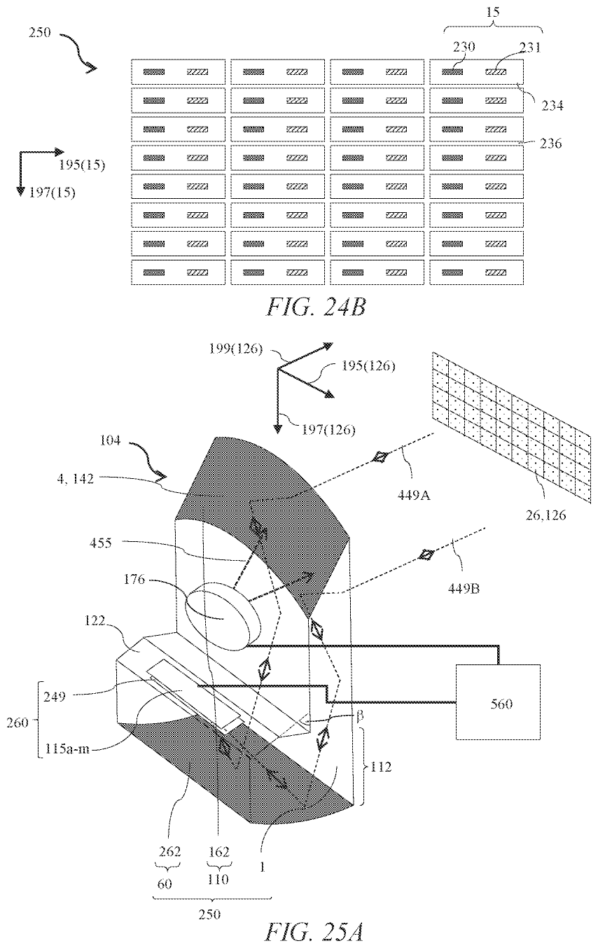

In alternative embodiments, the light source arrays 15 may be provided with different wavelengths such as infra-red wavelengths as will be described further hereinbelow with respect to FIG. 24A for example.

FIG. 9B is a schematic diagram illustrating in side view an illumination system 240 for use in the anamorphic directional illumination device of FIG. 7A comprising a birdbath folded arrangement. Features of the embodiment of FIG. 9B not discussed in further detail may be assumed to correspond to the features with equivalent reference numerals as discussed above, including any potential variations in the features.

In the present embodiments, the anamorphic directional illumination device 100 may further comprise a spatial light modulator 48 that may be arranged between an array of light sources and the transverse anamorphic component 60. The illumination optical cones 26a-n may be provided by imaging of pixels 222 of the spatial light modulator 48. Advantageously increased resolution of illumination optical cones 26a-n may be achieved. In other embodiments, the array of light sources 15a-n may comprise the pixels 222 of a spatial light modulator.

In the alternative embodiment of FIG. 9B, the spatial light modulator 48 illuminates a catadioptric illumination system 240 comprising input lens 79, curved mirror 86A and partially reflective mirror 81 such that rays 412 are directed into the input side 2 of the waveguide 1. Advantageously chromatic aberrations in the transverse direction 197 may be reduced. The partially reflective mirror 81 may be a polarising beam splitter or may be a thin metallised layer for example.

Additionally or alternatively, curved mirror 86B may be provided to increase efficiency of operation.

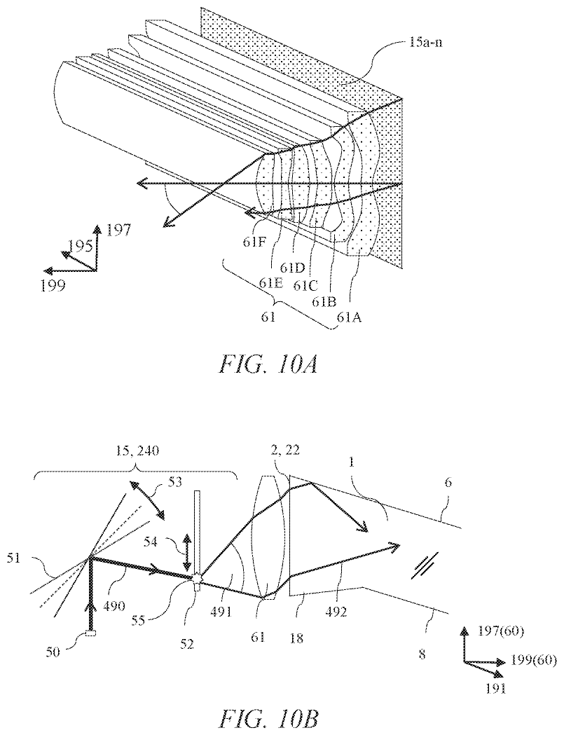

FIG. 10A is a schematic diagram illustrating in perspective front view an alternative arrangement of an input focussing lens 61. Features of the embodiment of FIG. 10A not discussed in further detail may be assumed to correspond to the features with equivalent reference numerals as discussed above, including any potential variations in the features.

Light source array 15a-n is aligned to the lens 61 of the transverse anamorphic component 60 that is a compound lens comprising lenses 61A-F. Some of the lenses 61A-F may comprise surfaces that have a constant radius and some may comprise variable radius surfaces such that in combination aberration correction is advantageously improved. Advantageously improved resolution of illumination optical cones 26a-n may be achieved.

Alternative arrangements of illumination system 240 will now be described.

FIG. 10B is a schematic diagram illustrating in side view a spatial light modulator arrangement for use in the anamorphic directional illumination device of FIG. 1A or FIG. 7A comprising a light source array 15 comprising a laser 50, a scanning arrangement 51 and a light diffusing screen 52. Features of the embodiment of FIG. 10B not discussed in further detail may be assumed to correspond to the features with equivalent reference numerals as discussed above, including any potential variations in the features.

In the alternative embodiment of FIG. 10B, the light source array comprises the laser 50 arranged to direct a beam 490 towards deflector element 51 that may be a rotating mirror for example, with oscillation 53 that is synchronised to the illumination optical cone 26 data.

The beam 490 is arranged to illuminate a screen 52 to provide a diffuse light source 55 at the screen. The screen 52 may comprise a diffusing arrangement so that the transmitted light is diffused into light cone 491 arranged to provide input light rays 492 into the transverse anamorphic component 60 and waveguide 1.

The screen 52 may alternatively comprise a photoemission layer such as a phosphor laser at which the laser beam 490 is arranged to produce emission from the photoemission layer. The output colour can advantageously be independent of the laser 50 emission wavelength. Further laser speckle may be reduced.

The laser 50 may comprise a one-dimensional array of laser emitting pixels 222 across a row 221T and the scanning arrangement 51 may provide one-dimensional array of light sources 55 at the screen 52 for each addressable row of the spatial light modulator 48. The scanning speed of the scanning arrangement 51 is reduced, advantageously achieving reduced cost and complexity.

Alternatively the laser 50 may comprise a single laser emitter and the scanning arrangement 51 may provide two-dimensional scanning of the beam 490 to achieve a two-dimensional pixel array of emitters 55 at the screen 52. Advantageously laser 50 cost may be reduced.

Further arrangements comprising laser sources will now be described.

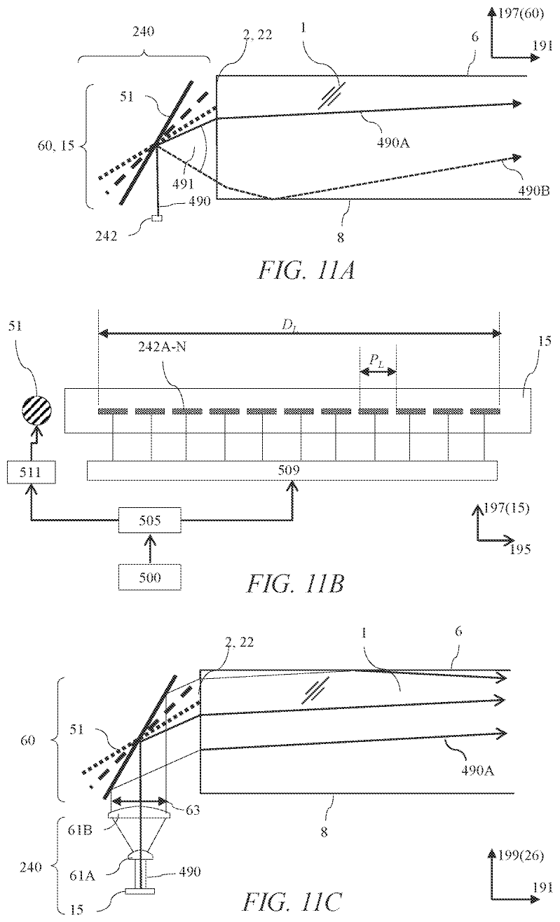

FIG. 11A is a schematic diagram illustrating in side view input to the waveguide 1 wherein the light source array 15a-n comprises laser light sources 242 and scanning arrangement 51; FIG. 11B is a schematic diagram illustrating in front view a light source array 15 comprising an array of laser light sources 242A-N for use in the arrangement of FIG. 11A; and FIG. 11C is a schematic diagram illustrating in side view a light source array arrangement comprising an array of laser light sources, a beam expander and a deflector element comprising a scanning mirror 51.

The alternative embodiment of FIG. 11A comprises a transverse anamorphic component 60 that is formed by a deflector element 50 that comprises scanning mirror 51.

FIG. 11B illustrates a light source array 15a-n suitable for use in the arrangement of FIG. 11A comprising a one-dimensional array of emitters 242A-N wherein the emitters 242A-N each comprise a laser source. Control system 500 is arranged to supply line-at-a-time image data to light source array controller 505 that outputs illumination optical cone 26a-n data to laser emitters 242A-N by means of driver 509; and location data to scanning arrangement 51 by means of scanner driver 511. The laser emitters 242A-N are arranged in a single row with pitch P_{L} in the lateral direction 195 that is the same as illustrated in FIG. 3A for example.

Returning to the description of FIG. 11A, in operation, illumination optical cone 26a-n data for a first addressed row of illumination optical cone 26a-n data are applied to the laser emitters 242A-N and the scanning arrangement 51 adjusted so that the laser light from the light source array 15a-n is directed as ray 490A in a first direction across the transverse direction 197. At a different time, illumination optical cone 26a-n data for a different addressed row of illumination optical cone 26a-n data are applied to the laser emitters 242A-N and the scanning arrangement 51 adjusted so that the laser light is directed as ray 490B in a different direction across the transverse direction 197. The transverse anamorphic component 60 is thus arranged to receive light from the light source array 15a-n and the illumination system 240 is arranged so that light output from the transverse anamorphic component 60 is directed in directions illustrated by rays 490A. 490B that are distributed in the transverse direction with cone 491.

In other words, the scanning arrangement 51 scans about the lateral direction 197(60) and serves to provide illustrative light rays 490A. 490B sequentially. By means of sequential scanning, the scanning arrangement 51 effectively has positive optical power in the transverse direction 197(60) for light from the laser emitters 242A-N, achieving output cone 491 in a sequential manner. In this manner, the scanning arrangement 51 directs light in directions that are distributed in the transverse direction, allowing it to serve as a transverse anamorphic component 60. Advantageously the cost and complexity of the illumination system 240 and transverse anamorphic component 60 may be reduced.

The alternative embodiment of FIG. 11C provides beam expander 61A. 61B that increases the width 63 of the output beam from the illumination system 240. In FIG. 11C, the illumination system 240 further comprises a deflector element 50 arranged to deflect light output from the transverse anamorphic component 60 by a selectable amount, the deflector element 50 being selectively operable to direct the light output from the transverse anamorphic component 60 in the directions that are distributed in the transverse direction 197. Improved uniformity of the output illumination optical cones 26a-n is advantageously achieved.

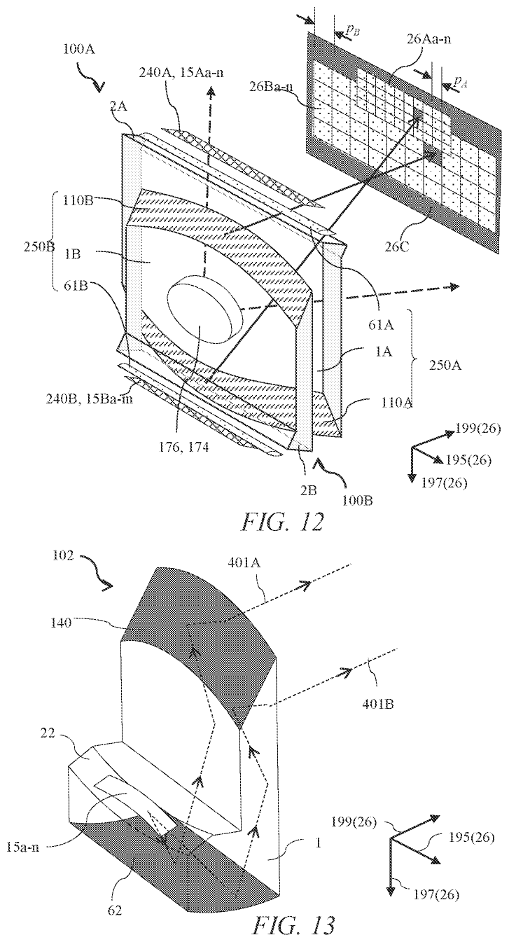

FIG. 12 is a schematic diagram illustrating in perspective rear view a stack of waveguides 1 arranged to provide complementary illumination. Features of the embodiment of FIG. 12 not discussed in further detail may be assumed to correspond to the features with equivalent reference numerals as discussed above, including any potential variations in the features.

In the alternative embodiment of FIG. 12, the anamorphic directional illumination device 100 comprises plural illumination systems 240A, 240B and plural optical systems 250A, 250B, wherein each optical system 250A, 250B is arranged to receive light from a respective illumination system 240A, 240B, and the waveguides 1A, 1B of each optical system 250A, 250B are stacked to provide output illumination in a common direction 199(26).

Further, in the alternative embodiment of FIG. 12, each illumination system 240A, 240B and the corresponding optical system 250A, 250B are arranged to provide output illumination into illumination optical cones 26Aa-n, 26Ba-m having pitches p_{A}, p_{B} that are different in at least one of the transverse and lateral directions 197, 195.

In operation, increased illuminance and resolution of light control may be achieved in at least one region of overlap of illumination optical cones 26Aa-n, 26Ba-m. Improved control of overall illumination profile may be achieved. The spectral output of the illumination systems 240A, 240B may be different, for example one illumination system 240A may provide visible illumination and the other may provide infra-red illumination for example for a LIDAR function as described with reference to FIGS. 24A-B hereinabove.

The alternative embodiment of FIG. 12 illustrates the type of directional illumination device 100 of FIG. 7A for example. In other embodiments, one or both of the directional illumination devices 100A. 100B may comprise the type of directional illumination device 100 of FIG. 1A or described elsewhere herein for example.

It may be desirable to reduce illumination optical cone 26 blur at higher lateral field angles.

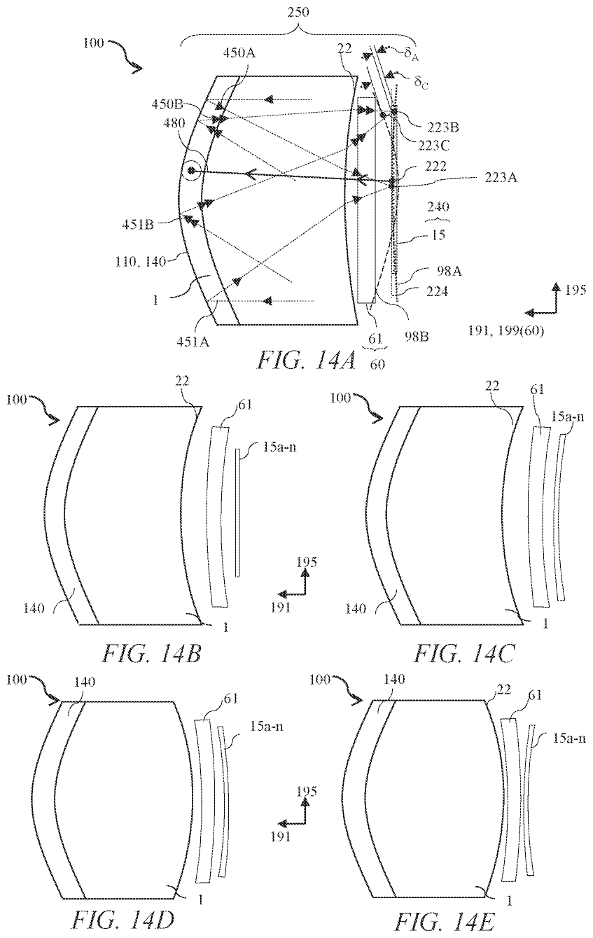

FIG. 13 is a schematic diagram illustrating in rear perspective view an anamorphic directional illumination device 100 comprising a curved input face 22 and a curved light source array 15a-n; and FIG. 14A is a schematic diagram illustrating in front view an anamorphic directional illumination device 100 wherein the input face 22 of the extraction waveguide 1 has curvature in the lateral direction 195. Features of the embodiments of FIGS. 13 and 14A not discussed in further detail may be assumed to correspond to the features with equivalent reference numerals as discussed above, including any potential variations in the features.

In comparison to the embodiments of FIG. 1A and FIG. 7A, in the alternative embodiments of FIG. 13 and FIG. 14A respectively, at least one of an input face 22 of the waveguide 1, the transverse anamorphic component 60 and the array of light sources 15a-n has a curvature in the lateral direction 195 that compensates for field curvature of the extraction reflector 140.

The operation of the curved surfaces of FIG. 13 and FIG. 14A will now be described further with reference to FIG. 14A, however such arrangements may alternatively be provided for the embodiment of FIG. 13.

By way of comparison with the present embodiment. FIG. 7A illustrates an input face 22, transverse anamorphic component 60 and light source array 15a-n with light source array 15a-n lying on illumination face 224 that has no curvature in the lateral direction 195.

In practice, aberrations of the lateral anamorphic component 110 have Petzval field curvature with an illustrative curved field surface 98B shown in FIG. 14A that is separated by distance 8 from the illumination face 224 that varies. Light sources 15 on illumination face 224 that are more widely separated in the direction 191 from the field surface 98B have reduced modulation transfer function (MTF), appearing more blurry. Considering the field surface 98B then light sources 15 that are off-axis in the lateral direction 195 may be perceived with increased illumination optical cone 26 blur in comparison to light sources 15 that are on-axis.

It would be desirable to provide light sources 15 of the light source array 15a-n that are on a field surface 98A that is close to the illumination face 224 of the illumination system 240 across the light source array 15a-n in the lateral direction 195.

Considering the embodiment of FIG. 14A, the curved input face 22 of the extraction waveguide 1 provides a modified field surface 98A. The curved input face 22 may be an input face 22 as illustrated in FIG. 7A for example or may be the input face 22 as illustrated in FIG. 1A for example.

In operation, light ray 480 is an illustrative light ray for output light from light source 15 on the transverse anamorphic component 60 that is directed towards a respective illumination optical cone 26. Indicative light rays 450A. 451A. 450B. 451B illustrate light rays that would propagate from the illumination optical cone 26 towards the light source array 15a-n if a light source were to be arranged at a location corresponding to the illumination optical cone 26. Indicative light rays 450A. 451A form indicative image point 223A and indicative light rays 450B. 451B form indicative image point 223B where indicative image points 223A, 223B lie in the surface 98A.

Considering the point of best focus 223B, the separation δ_{AB} of the surface 98A from the plane of the light sources 15 of the light source array 15a-n is reduced across the field of view in comparison to the separation δ_{B} provided by surface 98B that would provide a point of best focus 223C.

In the alternative embodiment of FIG. 14A, the input face 22 of the extraction waveguide 1 thus has a curvature in the lateral direction 195 that compensates for Petzval field curvature of the lateral anamorphic component 110. Thus the desirable field surface 98A provided by FIG. 14B is more closely aligned to the pixel plane 224 of the light source array 15a-n. MTF for off-axis field points is increased and advantageously illumination optical cone 26 blur is reduced.

Alternative embodiments to reduce field curvature will now be described.

FIG. 14B is a schematic diagram illustrating in front view an anamorphic directional illumination device 100 wherein the input face 22 of the extraction waveguide 1 has curvature in the lateral direction 195 and the transverse anamorphic component 60 has curvature in the lateral direction 195; FIG. 14C is a schematic diagram illustrating in front view an anamorphic directional illumination device 100 wherein the input face 22 of the extraction waveguide 1 has curvature in the lateral direction 195, the transverse anamorphic component 60 has curvature in the lateral direction 195, and the light source array 15a-n has curvature in the lateral direction 195; FIG. 14D is a schematic diagram illustrating in front view an anamorphic directional illumination device 100 wherein the input face 22 of the extraction waveguide 1 has curvature in the lateral direction 195, the transverse anamorphic component 60 comprising curvature in the lateral direction 195 and the light source array 15a-n has curvature in the lateral direction 195, where the direction of curvature of each of the input face 22, the transverse anamorphic component 60 and the light source array 15a-n is opposite to that of FIG. 14C; and FIG. 14E is a schematic diagram illustrating in front view an anamorphic directional illumination device 100 wherein the input face 22 of the extraction waveguide 1 has curvature in the lateral direction 195, the transverse anamorphic component 60 has curvature in the lateral direction 195, and the light source array 15a-n has curvature in the lateral direction 195, where the direction of curvature of each of the input face 22 and the transverse anamorphic component is the opposite to that of FIG. 14C, and the direction of curvature of the light source array 15a-n is the same as that of FIG. 14C. Features of the embodiments of FIGS. 14B-E not discussed in further detail may be assumed to correspond to the features with equivalent reference numerals as discussed above, including any potential variations in the features.

The alternative embodiments of FIGS. 14B-E are examples illustrating the case that at least one of the input face 22 of the extraction waveguide 1, the transverse anamorphic component 60 and the light source array 15a-n has a curvature in the lateral direction 195 in a manner that compensates for Petzval field curvature of the lateral anamorphic component 110. The directions of curvature of respective elements 2, 60, 48 may be modified to achieve optimised illumination optical cone 26 performance so that the MTF for off-axis field points is further increased and advantageously illumination optical cone 26 blur is reduced.

In comparison to non-anamorphic components, the curvature may be arranged about only one axis. In particular, the light source array 15a-n may comprise a silicon or glass backplane. Such backplanes are not typically suitable for curvature about two axes. However in the present embodiments, single axis curvature may achieve desirable correction for field curvature. Advantageously the cost of achieving a suitably curved light source array 15a-n may be reduced.

Illustrative arrangements of vehicle external lights 102 will now be described.

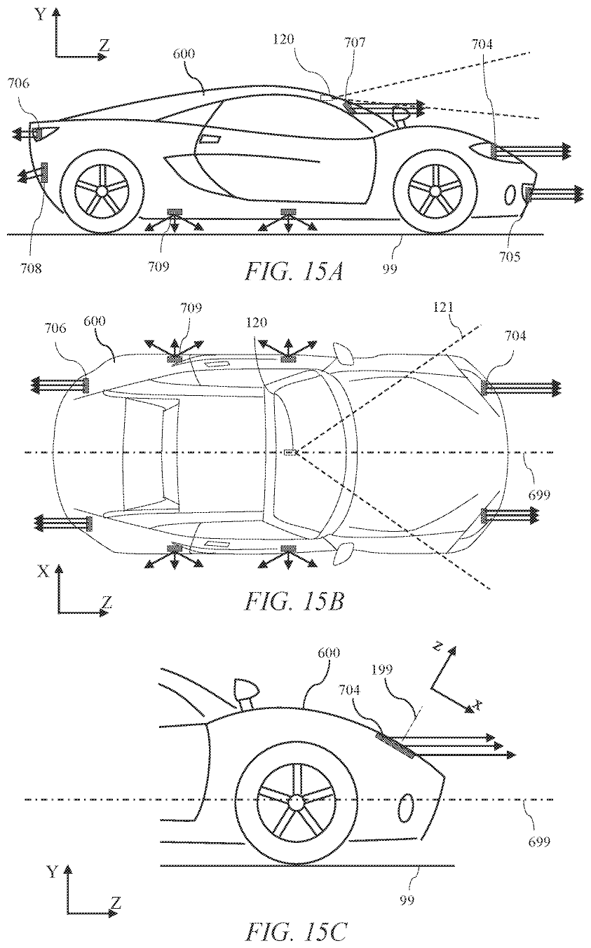

FIG. 15A is a schematic diagram illustrating in side view a vehicle comprising vehicle external lights 102 of the present embodiments; FIG. 15B is a schematic diagram illustrating in top view a vehicle comprising vehicle external lights 102 of the present embodiments; and FIG. 15C is a schematic diagram illustrating in side view part of a vehicle comprising vehicle external lights 102 that are mounted with tilted orientations. Features of the embodiments of FIGS. 15A-C not discussed in further detail may be assumed to correspond to the features with equivalent reference numerals as discussed above, including any potential variations in the features.

The vehicle external lights 102 of the present embodiments have thin profile and may provide reduction of illumination device volume in comparison to known illumination structures.

Vehicle headlights 704 comprise a vehicle external light 102 wherein the output luminous flux is at least 100 lumens, preferably at least 300 lumens and most preferably at least 600 lumens. The headlights 704 may comprise uniform white light sources.

The array of light sources 15a-n may comprise at least two light sources with different spectral outputs. The two different spectral outputs may comprise two of: a first white light spectrum, a second white light spectrum different from the first white light spectrum, red light, orange light, and/or infra-red light.

Alternatively, white and orange light sources 15a-n may be provided on the input side 2 of waveguide 1 and the headlight 704 may further operate as a direction indicator. The headlight may be dimmed or extinguished in the region for which visibility of the indicator function is desirable. Advantageously reduced number of light sources and increased area of output for indicators may be achieved.

A fog light 705 may be mounted low down on the vehicle 600. Fog light 705 may have reduced blue spectral content compared to headlight 704 to reduce scatter in fog.

A vehicle reversing (or back-up) light 708 comprises a vehicle external light 702 and white light sources 15a-n. A rearward facing light 706 comprising the vehicle external light 702 wherein the light sources 15a-n provide red light.

Alternatively red, orange and white light sources may be provided on the input side 2 of the waveguide 1. In one mode of operation red light may be provided for braking and fog light purposes. In another mode of operation a rear reversing light may be provided. In another mode of operation a direction indicator function may be provided.

Camera 120 may be provided with field of view illustrated by image capture cone 121. As will be described below, image data from camera 120 may be used to determine output illumination profiles in the illuminated scene.

In another embodiment the vehicle external light 707 may be provided next to or on the windscreen of the vehicle 600. The output of some or all of the anamorphic illumination devices 100 of the present embodiments may comprise white light sources and/or infra-red light sources. Infra-red sources can be used to illuminate the illuminated scene with illumination that may be scanned. Advantageously the vehicle external light can achieve enhanced signal-to-noise ratio for the camera 120 used to monitor the road scene.

In another embodiment at least one vehicle external light 102 may be provided to illuminate the road surface 99 near to the doors of the driver and passengers. Increased illumination for an occupant leaving or entering the vehicle at night may be achieved, advantageously achieving increased safety.

The present embodiments advantageously achieve significant reduction of volume of vehicle external lights. It may be desirable to further reduce the volume of the vehicle that is occupied and to modify cosmetic appearance.

FIG. 15C is a schematic diagram illustrating in side view part of a vehicle 600 comprising vehicle external lights 102 that comprise headlights 704 that are mounted with tilted orientations.

In the present figures, the coordinate system denoted by small letters x, y, z is in the frame of the anamorphic directional illumination device 100, and the coordinate frame denoted by capital letters X, Y, Z is in the frame of the vehicle 600. The coordinate frame x, y, z is not typically aligned to the coordinate frame X, Y, Z, that is, the illumination device 100 is typically rotated in the vehicle 600 as illustrated for example in FIG. 15C. The lateral direction in the present embodiments is the direction in which the illumination optical cones 26 are controlled, and thus the x-axis direction in FIG. 1.

Vehicle external lights 102 may have features 12, 312 with profile shapes that are arranged to provide nominal output directions in the lateral direction that are offset from the normal 199 to the anamorphic illumination device 100. The headlight 704 or other vehicle external lights 102 may be arranged with orientations that are similar to body panel orientations. Advantageously volume of the vehicle external lights 102 may be reduced.

A control system for a vehicle 600 will now be described.

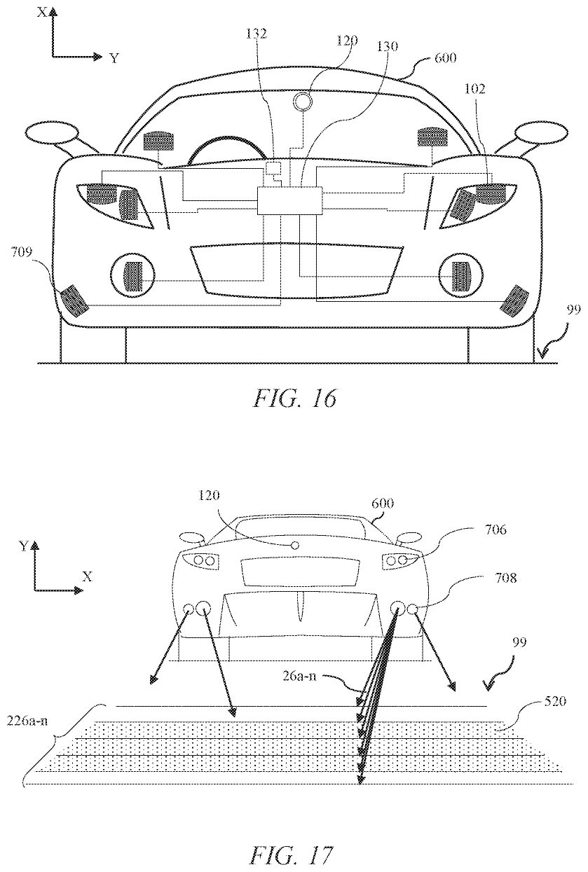

FIG. 16 is a schematic diagram illustrating in front view vehicle external lights 102 and a control system for vehicle external lights 102. Features of the embodiment of FIG. 16 not discussed in further detail may be assumed to correspond to the features with equivalent reference numerals as discussed above, including any potential variations in the features.

The anamorphic directional illumination device 100 further comprises a control system 130 arranged to selectively control the light sources 15. Information from camera 120 and from other control data 132 is passed to control unit 130. The control system 130 provides control of which light sources 15a-n are illuminated for each vehicle external lights 102.

The control data 132 may provide information on vehicle loading, vehicle acceleration or deceleration, left-hand or right-hand driving conditions, ambient light levels and other data related to control of vehicle external lights 102. The camera 120 may be provided with image recognition processors that provide location of other vehicle lights, road directions, kerb locations and street furniture for example as will be described further below.

Advantageously the illumination output may be directed to regions of importance and dazzle for oncoming users reduced.

Further the control system may provide additional illumination for signalling or communication with pedestrians or with other vehicles.

Arrangements for illumination of road surface near to the vehicle will now be described.

FIG. 17 is a schematic diagram illustrating in rear view vehicle external lights 102. Features of the embodiment of FIG. 17 not discussed in further detail may be assumed to correspond to the features with equivalent reference numerals as discussed above, including any potential variations in the features.

In the alternative embodiments of FIG. 17, the anamorphic directional illumination apparatus is arranged as a vehicle reversing light apparatus 706 and a vehicle brake light apparatus 704.

Illumination optical cones 26a-n provide illumination region 520 on the rear ground or road surface 99, wherein the region comprises illumination regions 226a-n that may be individually controllable or may have a fixed pattern.

Camera 120 may be used to detect hazards of particular importance such that they are clearly illuminated and visible to the driver by way of the rear view mirror or back-up (reversing) camera 120. Advantageously hazard perception for reversing may be increased and risk reduced.

The operation of side lights 709 to achieve increased safety for occupants entering or leaving the vehicle 600 or for passing traffic will now be described.

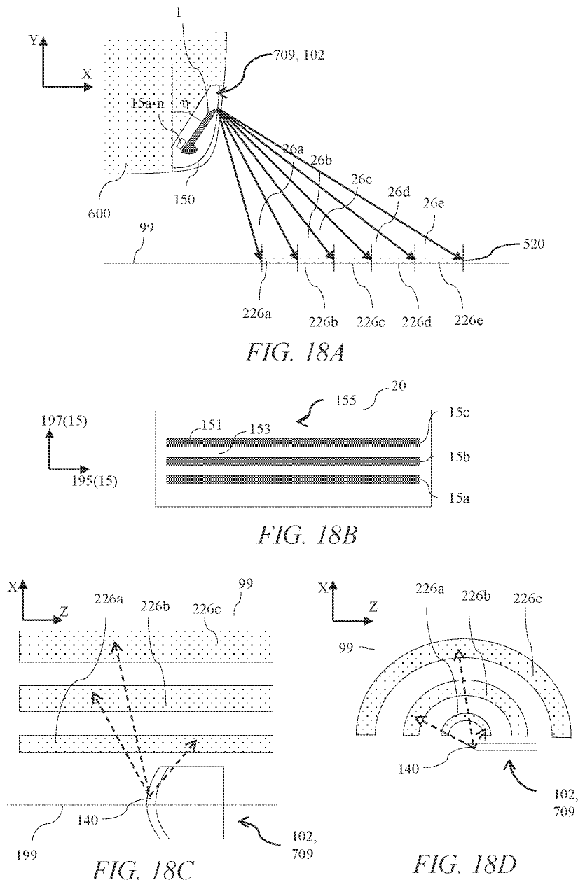

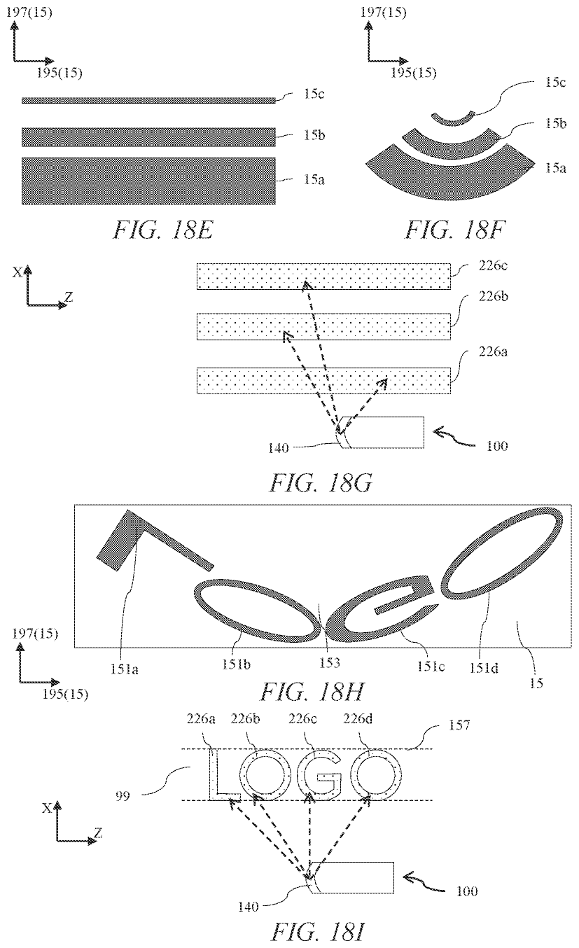

FIG. 18A is a schematic diagram illustrating in side view a side light 709 comprising vehicle external light 102. Features of the embodiment of FIG. 18A not discussed in further detail may be assumed to correspond to the features with equivalent reference numerals as discussed above, including any potential variations in the features.

In the alternative embodiment of FIG. 18A, waveguide 1 is provided at an angle η to the Y-axis and provides illumination optical cones 26a-n from respective light sources 15a-n that are directed towards the ground or road surface 99 to provide illumination region 520 comprising sub-regions 226a-n. Transmissive cover 150 may be provided with a curved shape to match the body panel of the vehicle 600.

The side light 709 may be provided in the sill, in the door, in the rear view mirror or other convenient location on the vehicle that is arranged to provide illumination of the road surface 99.

The regions 226a-n may be individually controllable or may be provided with a fixed illumination pattern that is determined at least by the arrangement of light sources 15a-n and waveguide 1 and control system.

Some of the regions 226a-n may be illuminated, and others may have no illumination to maximise contrast of an illumination pattern, for example to provide a zebra crossing appearance at the road surface. The illuminated pattern of regions 226a-n may be fixed or may vary with time, for example to provide communication from the vehicle to pedestrians or other road users, for example communicating a warning or an or indication of the vehicle advanced driver assistance system (ADAS) driving level, or an indication of the medical distress of the driver.

In an illustrative warning condition, a vehicle door close to the illumination regions 226 may be about to open, which may be hazardous to proximate cyclists, pedestrians or other road users. At least some of the illumination regions 226a-n may change in illuminance, colour or may be different colours in order to communicate information to the at-risk individual or vehicle.

Illumination may be provided that highlights hazards in the nearby region, for example kerbs, drains, debris or potholes.

No illumination in some regions 226a-n may for example be provided by turning off respective light sources 15a-n or by omitting light sources that would be arranged to illuminate the respective regions. Advantageously cost may be reduced.

The structure and operation of the vehicle external light 102 of FIG. 18A will now be described further.

FIG. 18B is a schematic diagram illustrating in front view an alternative array of light sources 15a-c for the side light 709 comprising vehicle external light 102 of FIG. 18A; FIG. 18C is a schematic diagram illustrating in top view illumination onto a road 99 of the vehicle external light 709, 102 comprising the array of light sources 15a-c of FIG. 18B when the angle η is 90°; and FIG. 18D is a schematic diagram illustrating in top view illumination onto a road 99 of the vehicle external light 709, 102 comprising the array of light sources 15a-c of FIG. 18B when the angle η is 0°. Features of the embodiments of FIGS. 18B-D not discussed in further detail may be assumed to correspond to the features with equivalent reference numerals as discussed above, including any potential variations in the features.

FIG. 18B illustrates that the array of light sources 15a-c comprise a backlight 20 and a mask 155 illuminated by the backlight 20, the mask 155 having an array of apertures 151 to form the light sources 15a-c.

FIG. 18C illustrates that for a horizontal waveguide 1 (η=0°) the illumination pattern for the mask 155 of FIG. 18B provides illumination regions 226a-c that are substantially straight but with increased blur due to aberrations away from the optical axis 199 of the vehicle external light 102.

FIG. 18D illustrates that for a horizontal waveguide 1 (η=90°) the illumination pattern for the mask 155 of FIG. 18B provides illumination regions 226a-c that are substantially curved and with increased blur due to aberrations away from the optical axis 199 of the vehicle external light 102.

FIG. 18E is a schematic diagram illustrating in front view an alternative array of light sources 15a-n for a vehicle external light 709, 102 comprising an array of elongate linear light sources 15a-c; FIG. 18F is a schematic diagram illustrating in front view an alternative array of light sources 15a-c for a vehicle external light 709, 102 comprising an array of elongate curved light sources 15a-c; and FIG. 18G is a schematic diagram illustrating in top view illumination onto a road 99 of the vehicle external light 709, 102 comprising the array of light sources 15a-c of FIG. 18E when the angle η is 90°, or comprising the array of light sources 15a-c of FIG. 18F when the angle η is 0°. Features of the embodiments of FIGS. 18E-G not discussed in further detail may be assumed to correspond to the features with equivalent reference numerals as discussed above, including any potential variations in the features.

In the alternative embodiments of FIGS. 18E-F, the widths of the light sources 15a are larger than those of the light sources 15c. Compensation for aberrations of the illumination regions 226a-c in FIG. 18G may be provided.

Further, the shape of the illumination regions 226a-c may be provided independently of the orientation of the waveguide 1. It may be desirable to provide other shape profiles for illumination.

FIG. 18H is a schematic diagram illustrating in front view an alternative array of light sources 15 for a vehicle external light 709, 102 comprising a mark 151a-d for a desirable angle η; and FIG. 18I is a schematic diagram illustrating in top view illumination onto a road 99 of the vehicle external light 709, 102 comprising the array of light sources 15 of FIG. 18H for the desirable angle η. Features of the embodiments of FIGS. 18H-I not discussed in further detail may be assumed to correspond to the features with equivalent reference numerals as discussed above, including any potential variations in the features.

The mask 151 may thus be provided with a mark that compensates for the geometric and Seidel aberrations of the anamorphic directional illumination system 100. Advantageously a low cost and high brightness illumination system may be provided.

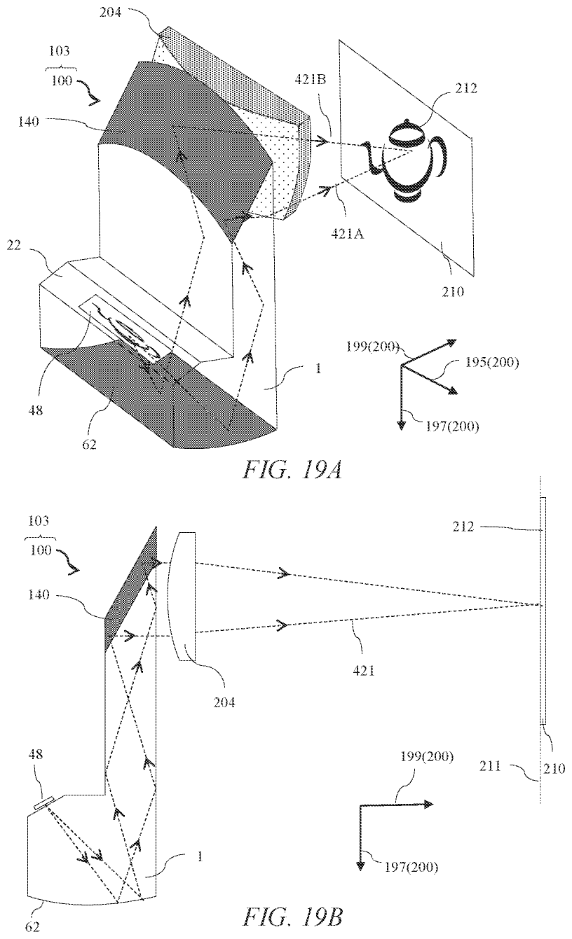

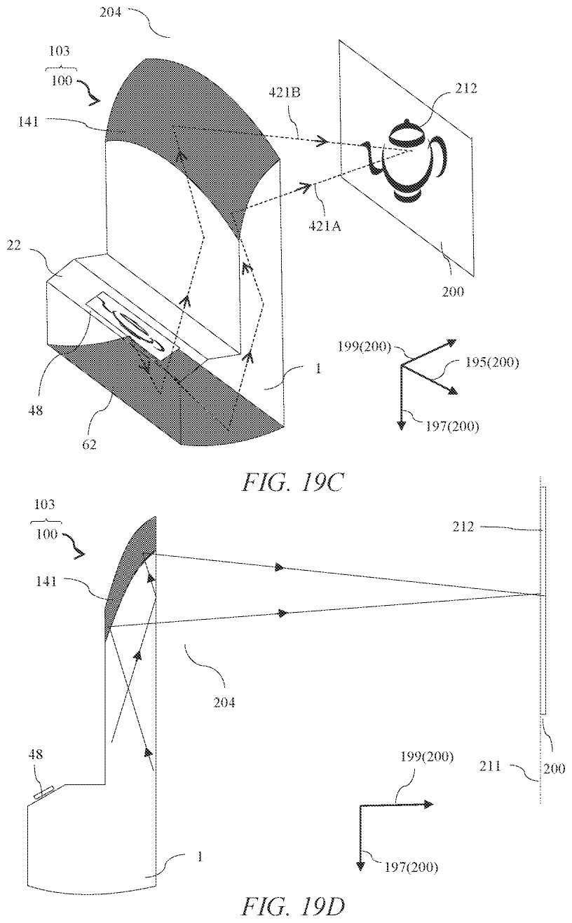

FIG. 19A is a schematic diagram illustrating in front perspective view an anamorphic image projection device 103 comprising a waveguide 1 with a curved reflective transverse anamorphic component 60, a curved reflective lateral anamorphic component 110 and a refractive image-forming lens 204 with positive optical power in lateral and transverse directions 195, 197 arranged to provide an image 212 on a screen 210; and FIG. 19B is a schematic diagram illustrating in side view the anamorphic image projection device 103 of FIG. 19A. Features of the embodiments of FIGS. 19A-B not discussed in further detail may be assumed to correspond to the features with equivalent reference numerals as discussed above, including any potential variations in the features.

In comparison to the embodiments of FIGS. 2C-D, in the alternative embodiment of FIGS. 19A-B the image projection device 103 comprises an anamorphic directional illumination device 100 as described hereinabove that is arranged to focus the output illumination on a focal plane 211 such that rays 421A. 421B converge to the focal plane 211. The image projection device 103 further comprises a lens 204 having positive optical power arranged to focus the output illumination 421 on the focal plane 211. Screen 210 may be arranged at or near the focal plane 211 so that image 212 may be observed when an image is provided on a spatial light modulator 48 arranged at the input face 22.

A compact image projector may advantageously be provided with high brightness and/or high efficiency. The image projector may be a portable display apparatus for example as a stand-alone element or may be embedded within other devices such as cell phones, laptops, cameras; or may be provided in a vehicle to project images onto a road surface, as illustrated in FIG. 18A hereinabove for example.

FIG. 19C is a schematic diagram illustrating in front perspective view an anamorphic image projection device 103 comprising a waveguide 1 with a curved reflective transverse anamorphic component 60, and a curved reflective lateral anamorphic component 110 arranged to provide an image on a screen; and FIG. 19D is a schematic diagram illustrating in side view the anamorphic image projection device 103 of FIG. 19C. Features of the embodiments of FIGS. 19C-D not discussed in further detail may be assumed to correspond to the features with equivalent reference numerals as discussed above, including any potential variations in the features.

In comparison to the embodiments of FIGS. 19A-B, in the alternative embodiment of FIGS. 19C-D, the lens 204 is omitted and the image projection device 103 comprises an extraction reflector 140 that has positive optical power in the lateral direction 195 and in the transverse direction 197. Said optical powers may be arranged to provide focal plane 211 so that image 212 may be provided.

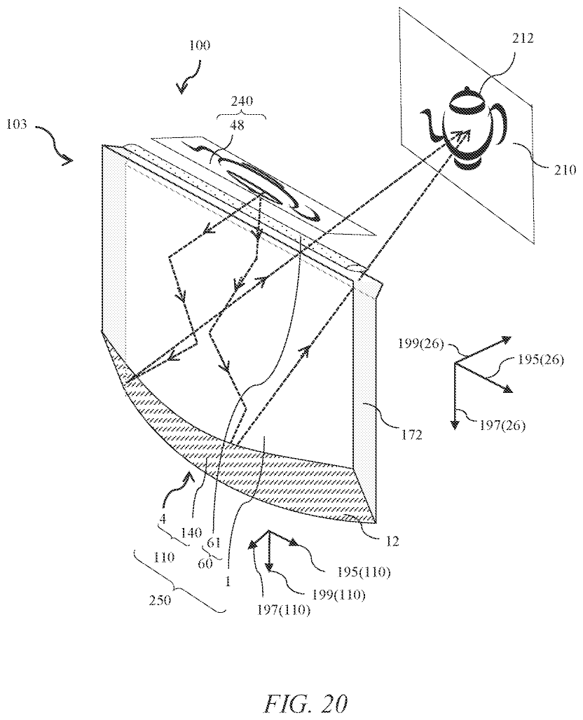

FIG. 20 is a schematic diagram illustrating in rear perspective view an anamorphic image projection device 103 comprising a waveguide 1 with a transmissive transverse anamorphic component 60 comprising a lens 61 and a curved reflective lateral anamorphic extraction reflector 140 arranged to provide an image 212 on a screen 210. Features of the embodiment of FIG. 20 not discussed in further detail may be assumed to correspond to the features with equivalent reference numerals as discussed above, including any potential variations in the features.

In comparison to the embodiment of FIG. 19C, in the alternative embodiment of FIG. 20, the transverse anamorphic component 60 is provided by a lens 61. Advantageously aberrations may be improved in the transverse direction 197 and improved image fidelity obtained.

Directional illumination devices 200 that provide one-dimensional arrays of illumination optical cones 26a-n will now be described.

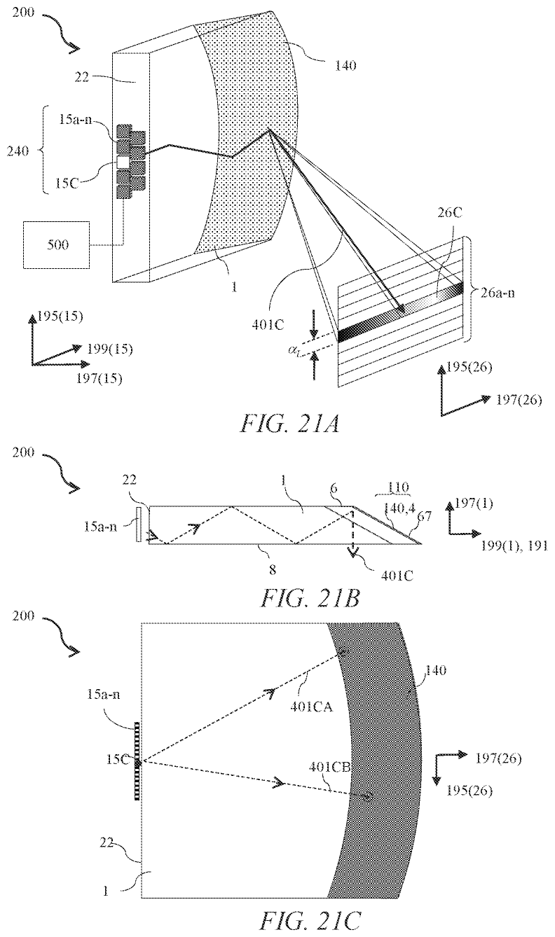

FIG. 21A is a schematic diagram illustrating in rear perspective view a directional illumination device 200 comprising a waveguide 1 with a curved reflective lateral anamorphic component 60 arranged to provide a one-dimensional array of illumination optical cones 26a-n; FIG. 21B is a schematic diagram illustrating in side view the directional illumination device 200 of FIG. 21A; and FIG. 21C is a schematic diagram illustrating in front view the directional illumination device 200 of FIG. 21A. Features of the embodiments of FIGS. 21A-C not discussed in further detail may be assumed to correspond to the features with equivalent reference numerals as discussed above, including any potential variations in the features.

In the embodiments of FIGS. 21A-C a directional illumination device 200 comprises an array of light sources 15a-n distributed in a lateral direction 195; and a waveguide 1 arranged to receive light from the array of light sources 15a-n. The light sources 15a-n may be light emitting diodes.

The waveguide 1 comprises front and rear guide surfaces 8, 6 arranged to guide light from the light sources 15a-n along the waveguide 1. Extraction reflector 140 is arranged to reflect light that has been guided along the waveguide 1, wherein the extraction reflector 140 has positive optical power in the lateral direction 195 and is oriented to extract light out of the waveguide 1 through at least one of the guide surfaces 8, 6 as output illumination. The output illumination aperture provided by the extraction reflector 140 is reduced in height, advantageously improving the aesthetic appearance in a vehicle headlight application. The region of the waveguide 1 that is not near the extraction reflector 140 may be hidden, in a similar manner to that described in FIG. 2A for example.

In comparison to the embodiments of FIG. 1A and FIG. 7A hereinabove, in the alternative embodiment of FIGS. 21A-C the transverse anamorphic component 60 is omitted. Advantageously cost and complexity of the waveguide 1 is reduced.

Illumination optical cones 26a-n are distributed across the lateral direction 195 wherein the optical window 26C has an angular pitch α_{L} and extended in the transverse direction 197. Advantageously cost and complexity of the control system 500 is reduced.

The front and rear guide surfaces 8, 6 of the waveguide 1 are planar and parallel. The waveguide 1 has no optical power in a transverse direction 197 that is perpendicular to the lateral direction 195 and the extraction reflector 140 is an end 4 of the waveguide 1.

In the embodiment of FIGS. 21A-C, the array of light sources 15a-n are also distributed in the transverse direction 197. In other embodiments the illumination apparatus 240 may comprise the scanning arrangements of FIG. 10B or FIGS. 11A-C.

The waveguide 1 has an end 2 that is an input face 22 through which the waveguide 1 is arranged to receive light from the illumination system 240 and the extraction reflector 140 is oriented to extract light out of the waveguide 1 through one of the front guide and rear guide surfaces 8 as output illumination.

The light from the light sources 15a-n may be visible light or infra-red light. The array of light sources 15a-n may comprise light sources 15a-n with different spectral outputs. The different spectral outputs include: a white light spectrum, plural different white light spectra, red light, orange light, and/or infra-red light.

At least one of an input face 22 of the waveguide 1, and the array of light sources 15a-n has a curvature in the lateral direction 195 that compensates for field curvature of the extraction reflector 140 as described elsewhere herein with respect to FIGS. 14A-F.

Folded arrangements of directional illumination device 200 will now be described.

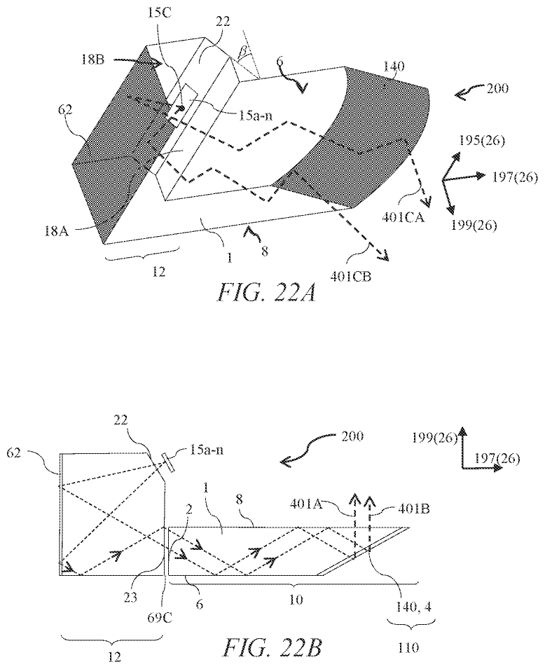

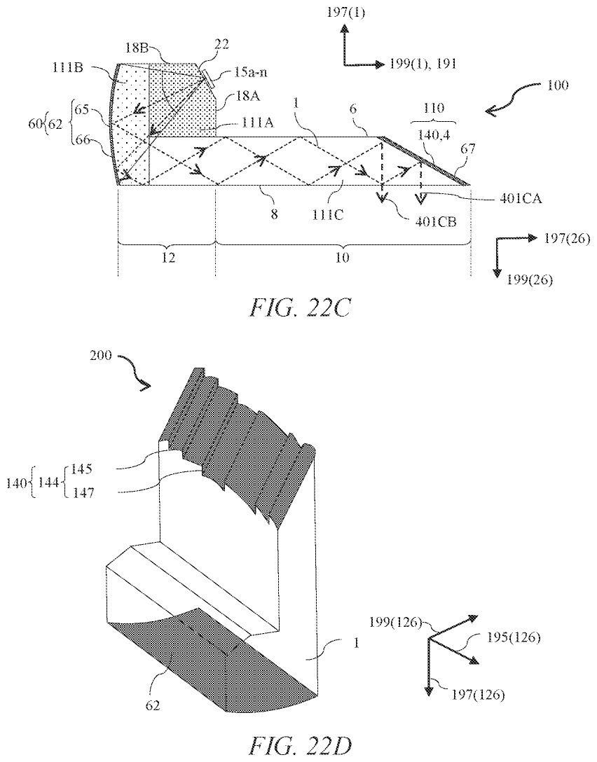

FIG. 22A is a schematic diagram illustrating in front perspective view a directional illumination device 200 comprising a waveguide 1 with a planar reflective end 62 and a lateral anamorphic component 60 comprising a curved extraction reflector 140. Features of the embodiment of FIG. 22A not discussed in further detail may be assumed to correspond to the features with equivalent reference numerals as discussed above, including any potential variations in the features.

The directional illumination device 200 further comprises an input section 12 comprising an input reflector 62 that is arranged to reflect the light from the illumination system 240 and direct it along the waveguide 1.

The input section 12 further comprises an input face 22 disposed outwardly (i.e. rearwardly) of the rear guide surface 6 and facing the input reflector 62, wherein the input section 12 is arranged to receive the light from the illumination system 240 through the input face 22.

The input face 22 is disposed outwardly of one of the front or rear guide surfaces 8, 6. More generally, the arrangements of the alternative embodiments disclosed hereinabove may be provided wherein the input reflector 62 is provided with no optical power, that it is provided by one or more planar surfaces. The complexity of tooling of the reflective end 62 may advantageously be reduced.

The input section 12 further comprises an input face 22 disposed on a front or rear side of the waveguide 1 and facing the input reflector 62, wherein the input section 12 is arranged to receive the light 401 from the illumination system 240 through the input face 22.

The input face 22 extends at an acute angle β to the front guide surface 8 in the case that the input face 22 is on the front side of the waveguide 1 or to the rear guide surface 6 in the case that the input face 22 is on the rear side of the waveguide 1.

In the embodiment of FIG. 22A, the input section 12 is integral with the waveguide 1. The waveguide 1 may be conveniently manufactured as described elsewhere herein in one part advantageously with reduced cost and complexity.

FIG. 22B is a schematic diagram illustrating in side view a directional illumination device 200 comprising a waveguide 1 with an input section 12 comprising planar reflective end 62 and a waveguide 1 comprising a lateral anamorphic component 110 comprising a curved extraction reflector 140. Features of the embodiment of FIG. 22B not discussed in further detail may be assumed to correspond to the features with equivalent reference numerals as discussed above, including any potential variations in the features.

In the alternative embodiment of FIG. 22B, the waveguide 1 has an end 2 that is an input face 22 through which the waveguide 1 is arranged to receive light from the illumination system 240, and the input section 12 is a separate element from the waveguide 1 that further comprises a separation face 23 and is arranged to direct light reflected by the input reflector 62 through the output face 23 and into the waveguide 1 through the input face 2 of the waveguide 1. The input section 12 further comprises a separation face 23 extending outwardly (i.e. rearwardly) from the rear guide surface 6 to the input face 22. Advantageously the cost and complexity of fabrication of the directional illumination device 200 may be reduced.

FIG. 22C is a schematic diagram illustrating in side view an alternative waveguide 1 wherein the waveguide 1 is formed of materials 111A. 111B. 111C with different light absorption properties. Features of the embodiment of FIG. 22C not discussed in further detail may be assumed to correspond to the features with equivalent reference numerals as discussed above, including any potential variations in the features.

By way of comparison with FIG. 1C, the alternative embodiment of FIG. 22C illustrates that the waveguide 1 may be formed of a first section comprising material 111A, a second section comprising material 111B and a third section comprising material 111C. The material 111A may comprise light absorption properties that tolerate high luminous flux of input light from the light sources 15 without degradation, for example a glass material. By comparison, material 111B may be well-suited to forming of the shape of the input reflector 62, for example by polishing that may also comprise a glass. By further comparison material 111C may be well-suited to moulding, for example a polymer material advantageously achieving reduced cost and weight. Alternatively the material 111B may be the same as one of the materials 111A, 111C to reduce complexity of fabrication. The materials 111A, 111B, 111C may be bonded by suitable adhesives to reduce stray light.

It may be desirable to provide an output aperture with alternative appearance.

FIG. 22D is a schematic diagram illustrating in rear perspective view an alternative waveguide 1 wherein the extraction reflector 140 comprises a Fresnel reflector 144. Features of the embodiment of FIG. 22D not discussed in further detail may be assumed to correspond to the features with equivalent reference numerals as discussed above, including any potential variations in the features.

By way of comparison with FIG. 1A, the alternative embodiment of FIG. 22D provides an extraction reflector 140 that is a Fresnel mirror 144 comprising extraction facets 145 and draft facets 147. The extraction reflector has an output aperture shape that is more rectangular than illustrated hereinabove that may advantageously achieve a more desirable cosmetic appearance.

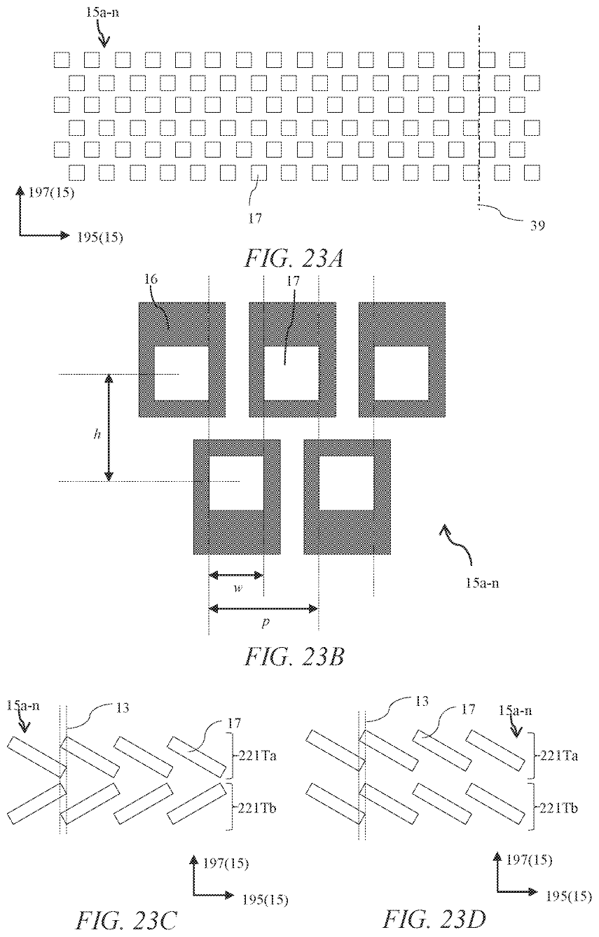

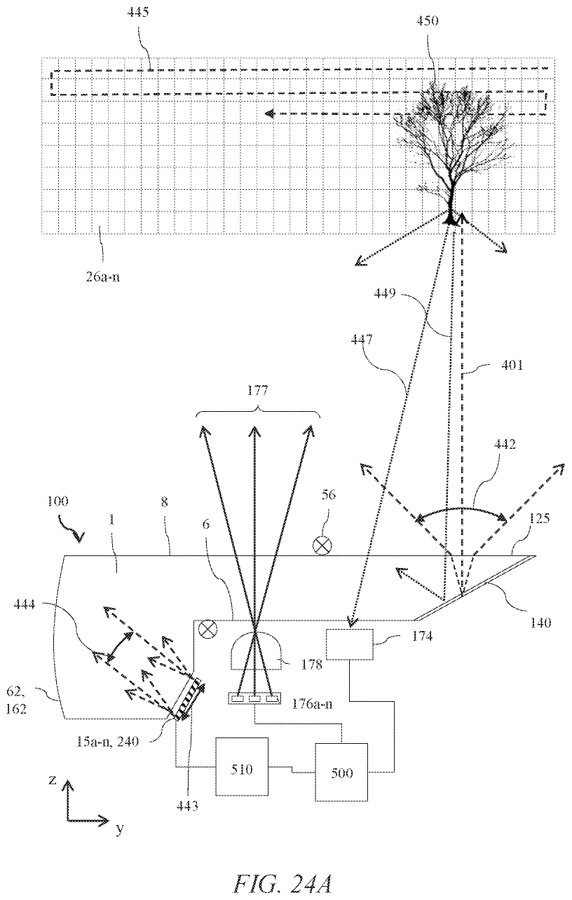

FIG. 23A is a schematic diagram illustrating in front view a light source array 15a-n comprising contiguous columns of light sources 15 for use in the directional illumination device 200 of FIGS. 21A-C and FIG. 22A. Features of the embodiment of FIG. 23A not discussed in further detail may be assumed to correspond to the features with equivalent reference numerals as discussed above, including any potential variations in the features.

In the alternative embodiment of FIG. 23A, the light sources 15a-n may comprise a staggered array of emitting apertures 17 that may be defined by emitting element 230 size or by the wells 234 of colour converted LEDs as described elsewhere herein. Non-emitting regions 37 are provided between the emitting apertures. The array of light sources 15a-n have an arrangement such that an intensity of light emitted by the light sources 15a-n summed along each line 39 through the light sources 15a-n in the transverse direction 197 is the same. The output uniformity across a one-dimensional array of illumination optical cones 26a-n, for example as illustrated in FIG. 21A, may be increased.

Advantageously the illumination optical cones 26a-n may be provided with high uniformity in the lateral direction 195 in arrangements wherein the packages 16 are physically separated by gaps on a PCB. Advantageously the cost and complexity of the light source 15a-n arrangement may be reduced while achieving desirable uniformity across the respective light cones 26a-n.

FIG. 23B is a schematic diagram illustrating in front view an alternative light source array comprising contiguous columns of light emitters for use in the directional illumination device of FIGS. 21A-C and FIG. 22A. Features of the embodiment of FIG. 23B not discussed in further detail may be assumed to correspond to the features with equivalent reference numerals as discussed above, including any potential variations in the features.

In the alternative embodiment of FIG. 23B, the light sources may be arranged in two rows of light sources. Advantageously the cost and complexity of assembly and addressing may be reduced. The light sources 15a-n each comprise a package 16 and light emitting aperture 17 that may be a white light emitting region or may be some other colour, for example red for rear vehicle external lights. The colour of the light sources 15a-n may be the same across the array. Advantageously the output illumination profiles may have uniform colour.

In an alternative embodiment the colour of the light sources 15a-n may vary with lateral location across the input face 22. For example some light sources may have different colour temperatures or peak wavelengths, such that the angular profiles may vary in colour with angle. Advantageously different regions of the illuminated scene may be provided with different colours to increase visual differentiation of scenes.

Typically light source packages 16 arranged in a linear array have gaps between the emitting apertures 17.

It would be desirable to provide a uniform illumination profile across adjacent illumination optical cones 26a-n. Such a uniform profile may be provided by providing at least some of the light sources 15 that are contiguous in the direction laterally across waveguide 1. At least some of the light sources 15 are separated by distance h in the direction perpendicular to the direction laterally across the waveguide 1 (x-axis). The light sources 15 are arranged in two rows and are offset so that the pitch p of the light sources 15 is twice the width w of the emitting regions. Advantageously the emitting apertures 17 are contiguous in the direction laterally across waveguide 1 and illumination optical cones 26a-n are provided with contiguous angular profiles.

Further the packages 16 have non-emitting regions that may be larger than the thickness of the waveguide 1. Such non-emitting regions may be provided to extend away from the surfaces 6, 8. Advantageously desirable sized heat-sink and control components may be provided within the packages 16 while achieving contiguous angular profiles of cones 26.

FIGS. 23C-D are schematic diagrams illustrating in front view a light source array 15a-n comprising columns of overlapping light sources 15 for use in the directional illumination device 200 of FIGS. 21A-C and FIG. 22A. Features of the embodiments of FIGS. 23C-D not discussed in further detail may be assumed to correspond to the features with equivalent reference numerals as discussed above, including any potential variations in the features.

In comparison to the embodiment of FIG. 23A, the light emitting apertures 17 of the light sources 15a-n are rotated so at the edges of the light sources provide an overlap region 13 between adjacent rows 221Ta. 221Tb so that the light emitted by the light sources 15a-n summed along each line through the light sources 15a-n in the transverse direction 197 is the same. The output uniformity across a one-dimensional array of illumination optical cones 26a-n, for example as illustrated in FIG. 21A may be increased.

Whilst the embodiments described above refer to a vehicle external light to provide illumination of scene exterior to the vehicle, in another alternative the illumination devices 100, 200 may provide a vehicle internal light arranged to provide illumination of the internal zones or surfaces of the vehicle. For example, directional illumination may be provided to direct light onto limited surface areas, for example by directing light onto a door during opening, onto control stalks during operation or onto a lap to enable a passenger to read. Advantageously stray light may be reduced while high illuminance may be achieved in desirable directions. In other embodiments, the light sources may comprise ultra-violet light sources, such as UV-C radiating sources that are arranged to provide sterilisation of bacterial and viral matters. Advantageously the light sources may be directed onto surfaces such as steering wheels, and other surfaces which users handle, without stray light being directed to the eyes of occupants. Advantageously retinal damage risk is reduced. Alternatively, the UV light source may be operated remotely when the vehicle is unoccupied.

It may be desirable to provide further illumination and detection functions.

FIG. 24A is a schematic diagram illustrating in side view a waveguide 1 arranged to illuminate a scene wherein the directional illumination device 100 further comprises additional sensors 174 and light sources 176 wherein light rays 177, 447 are transmitted through at least part of the waveguide 1 without guiding.

In the alternative embodiment of FIG. 24A, an illumination arrangement 104 comprises the anamorphic directional illumination device 100 and further comprises further light sources 176a-n arranged behind the rear guide surface 6 of the waveguide 1 to output light through the waveguide 1. The light sources 176a-n may alternatively comprise a single light source 176. An optional lens 178 may be arranged to provide directional light rays 177 from the light sources 176a-n. Advantageously additional optical illumination arrangements may be provided. For example, the light sources 176a-n may provide a different illumination spectral band to the output illumination from the directional illumination device 100, for example one spectral band may be visible light and the other spectral band may be infra-red light.

The front and rear guide surfaces 8, 6 of the waveguide 1 have an anti-reflection coating 56. Advantageously light transmission for rays 447, 177 is increased.

Alternatively a different profile of illumination output may be provided. As examples, the light sources 176a-n may provide direction indicator functions, decorative lighting, vehicle self-driving status indication, additional fog lighting of the road surface or daylight running light functions at transverse field angles that are not conveniently provided by the directional illumination device 100. A compact packaging of multiple light functions may be conveniently provided.

In the alternative embodiment of FIG. 24A, a light sensor 174 is arranged behind rear guide surface 6 of the waveguide 1 to receive light through the waveguide 1. Such sensor 174 may be a camera, a photodetector, a photo-diode array, an infra-red sensing apparatus or other known optical sensing apparatus. Advantageously a compact arrangement with sensing capability may be achieved.

Alternatively the array of light sources 15a-n may comprise light sources 15a-n with different spectral outputs. For example visible and infra-red spectral outputs may be provided. Illumination optical cones 26a-n may comprise visible light, infra-red light or both types.

In an alternative embodiment of FIG. 24A, the anamorphic directional illumination device 100 further comprises an apparatus for a light detection and ranging (LIDAR) apparatus 105, wherein the light from the light sources 15a-n comprise infra-red light sources, in which case light sources 176a-n need not be provided or may operate in a different wavelength range for example. Thus a light detection and ranging apparatus 105 comprises an anamorphic directional illumination device 100.

The light detection and ranging apparatus 105 further comprises a control system 510 arranged to selectively control the illumination system 240 to operate the light sources 15a-n successively for scanning 442 of the output illumination 401. The illumination of the light sources 15a-n may be arranged to scan as indicated by arrow 445 by scanning the location of emission on the array of light sources 15a-n as indicated by arrows 443. The output of light directions 444 within the waveguide 1 provide a scanned optical output 442 such that scanning pattern 445 is provided across illumination optical cones 26a-n.

Light reflected 447 from scene 450 is detected by sensor 174, and control system 500 is arranged to collect and analyse the corresponding scene 450 data. The scene 450 may then be appropriately illuminated by visible light sources 15a-n. The scene 450 data may further be provided to autonomous vehicle operating mode controllers. A compact, high efficiency and high resolution scene detection apparatus may advantageously be provided.

The scene 450 may comprise road scenes, airborne, office, home or other environments in which scene measurement may be of value.

FIG. 24B is a schematic diagram illustrating in front view an alternative light source array for the directional illumination device 100 of FIG. 24A. Features of the embodiment of FIG. 24B not discussed in further detail may be assumed to correspond to the features with equivalent reference numerals as discussed above, including any potential variations in the features.

In comparison to the embodiment of FIG. 3B for example, in the alternative embodiment of FIG. 24B, the well 234 may further comprise light emission element 231 that for example emits light at a wavelengths suitable for LIDAR. For example the central wavelength of emission element 231 may be 1550 nm or 905 nm. Advantageously a compact illumination apparatus 240 may be provided.

The scanning of the illumination profile may be one dimensional in which case columns of emission elements 231 are scanned or may be two dimensional in which case scanning is across the array of emission elements 231 in lateral and transverse directions 195, 197.

It may be desirable to provide a directional illumination and light detection device, for example to provide a directional LIDAR detector.

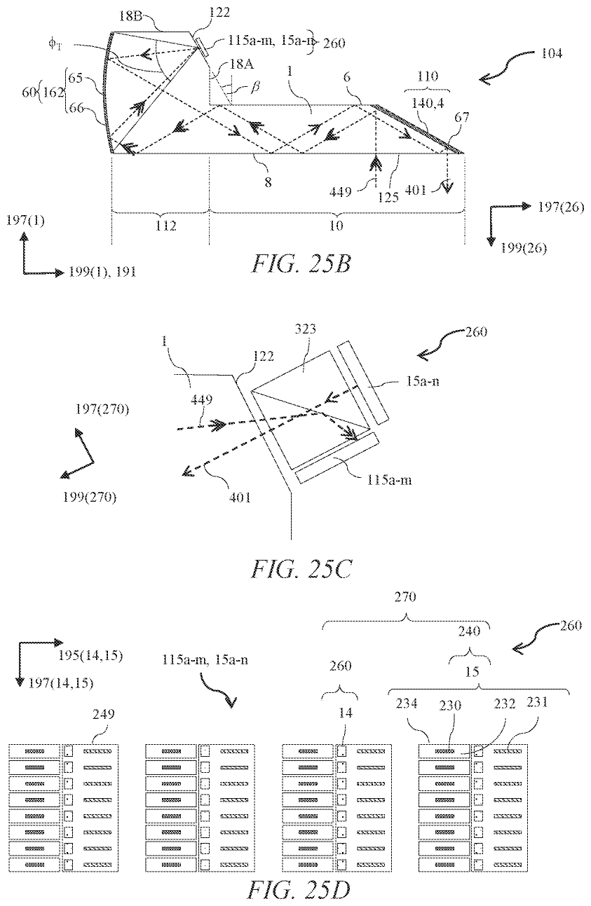

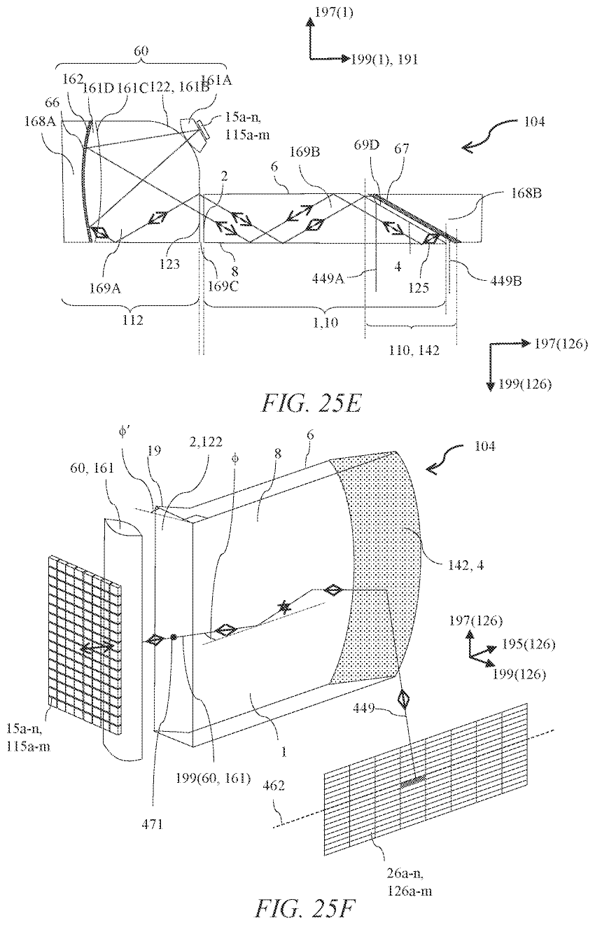

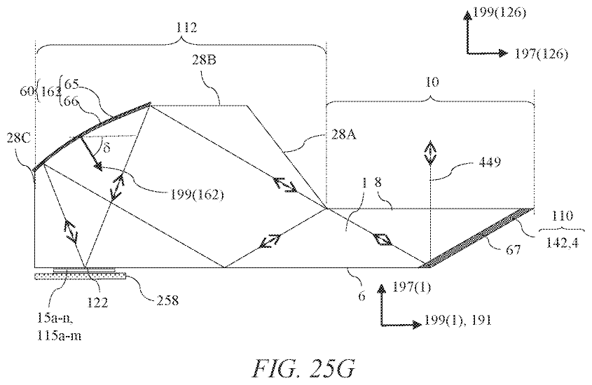

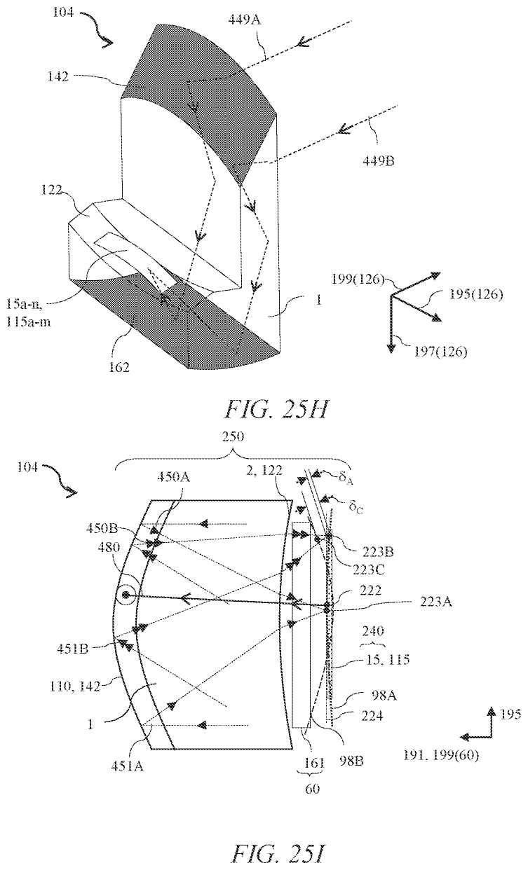

FIG. 25A is a schematic diagram illustrating in front perspective view an anamorphic directional illumination and light detection device 104 comprising a waveguide 1 with a curved reflective transverse anamorphic component 60 comprising transverse collecting reflector 262 and a curved reflective lateral anamorphic component 110 comprising lateral collecting reflector 264. Features of the embodiment of FIG. 25A not discussed in further detail may be assumed to correspond to the features with equivalent reference numerals as discussed above, including any potential variations in the features.

The alternative embodiment of FIG. 25A illustrates a directional illumination and light detection device 104 comprising: an illumination and light detection system 260 comprising a) an illumination system that comprises an array of light sources 15a-n as described hereinabove and b) a detection system that comprises an array of light detectors 115a-m distributed in a lateral direction 195 in an area overlapping with the array of light sources 15a-n, for example by interlacing the light sources 15a-n and light detectors 115a-m. The directional illumination and light detection device 104 further comprises an optical system 250 arranged as described above to receive light from the illumination system and output it as output illumination. In addition, the optical system 250 is arranged to input light 449 from a remote scene 450 and direct the input light 449 to the detection system in an opposite direction through the optical system 250 from the light received from the illumination system.

In comparison to the anamorphic directional illumination device 100 embodiments of FIGS. 1A-J hereinabove, in the embodiment of FIG. 25A, the anamorphic directional illumination and light detection device 104 comprises the optical system 250 and alternatively to the illumination system 240 comprises a detection system 260 comprising detector array 115a-n. In general, the optical system 250 in the embodiment of FIG. 25A and the subsequent embodiments of FIG. 25B, and FIGS. 25E-I may be replaced by any of the optical systems 250 disclosed herein with reference to an anamorphic directional illumination device 100. The directional illumination device 100 and directional detection device 104 have similar structure and operation for illumination light output from array of light sources 15a-n or detected light input to array of detectors 115a-m respectively. In the two cases, the light is directed through the optical system 250 in opposite directions along the same ray lines. Variations of directional illumination device 100 described hereinabove may be considered to apply to the directional detection device 104 of the present embodiments wherein extraction reflector 140 may be replaced by injection reflector 142; input reflector 62 may be replaced by output reflector 162; input face 22 may be replaced by output face 122; array of light sources 15a-n may be replaced by array of detectors 115a-m; input section 12 may be replaced by output section 112; lens 61 may be replaced by lens 161; illumination optical cone 26 may be replaced by detection optical cone 126; and control system 500 may be replaced or supplemented by detection system 560.

In operation, anamorphic directional illumination and light detection device 104 is arranged to collect light rays 449A. 449B from a remote scene and direct them by means of reflection from the lateral collecting reflector 264, guiding in waveguide 1, reflection from the transverse collecting reflector 262 and input face 22 onto a detection system 260 comprising detector array 115a-n. The structure, and optical operation of the optical system 250 may be similar or identical to those described elsewhere herein for the anamorphic directional illumination devices 100.

The reflectors 262, 264 may be broadband reflectors comprising metallic materials for example or may be narrowband reflectors comprising dielectric coatings for example. Advantageously signal-to-noise ratio of detection may be improved.

The scene may be illuminated by a separate light source 176 to provide probing light 455 wherein separate light source 455 may comprise lasers, for example vertical cavity surface emitting or edge emitting lasers emitting at infra-red wavelengths and made from gallium arsenide or indium phosphide for example.

The detection system 260 may further comprise an optical filter 249 used to help discriminate the wanted reflection from bright ambient light for example. Filter 249 may be an infra-red pass filter, or a narrow band infra-red pass filter matched to the LIDAR scene probing wavelength from scene illumination light source 176.

In operation, the scene may be illuminated by light source 176, for example by scanning, flash illumination or other known illumination method. Light rays 449 are detected from detection optical cones 126a-n that are equivalent in angular space to the illumination cones 26a-n of FIG. 1A for example.

The directional illumination and light detection device 104 further comprises a light source 176 arranged behind the rear guide surface of the waveguide 1 to output light 445 through the waveguide 1 wherein the light source 176 is arranged to output infra-red light and the light detectors 115a-m are arranged to detect infra-red light.

The visible array of light sources 15a-n may illuminate with visible light in a first phase of operation and an infra-red array of light sources 15a-n may illuminate with infra-red light and the detectors may detect the infra-red light in a second phase of operation. In an alternative embodiment, the infra-red illumination may be provided by a different light source to the array of light sources 15a-n and the array of detectors 115a-m may detect light in a second phase different from the first phase. Advantageously signal to noise ratio may be improved for the detection.

It may be desirable to provide a more compact illumination and detection apparatus.

FIG. 25B is a schematic diagram illustrating in side view an anamorphic directional illumination and light detection device 104; FIG. 25C is a schematic diagram illustrating in side view a light detector array 115a-m and light source array 15a-n for the anamorphic directional illumination and light detection system 260 of FIG. 25B; and FIG. 25D is a schematic diagram illustrating in front view a light detector array 115a-n and light source array 15a-n for the anamorphic directional illumination and light detection device 104 of FIG. 25B. Features of the embodiments of FIGS. 25B-D not discussed in further detail may be assumed to correspond to the features with equivalent reference numerals as discussed above, including any potential variations in the features.

The output face 122 is disposed outwardly of one of the front or rear guide surfaces 8, 6 and in the illustrative embodiment of FIG. 25B is disposed outwardly of the rear guide surface 6.

FIG. 25B illustrates that the optical system 250 comprising transverse anamorphic component 60 and lateral anamorphic component 110 may provide directional illumination for light rays 401 and directional detection for light rays 449. The waveguide 1 of FIG. 25B may alternatively be provided by the illumination waveguides 1 illustrated elsewhere herein.

The alternative embodiment of FIG. 25C illustrates that the illumination and light detection system 260 may comprise a beam-splitter 323 arranged to direct light rays 401 from the light source array 15a-n into the waveguide and to direct light rays 449 towards the array of light detectors 115a-m. The array of light sources 15a-n and array of light detectors 115a-m may comprise different material systems, advantageously improving performance, advantageously reducing cost of the respective arrays 15a-n, 115a-m.

The alternative embodiment of FIG. 25D illustrates that the illumination and light detection system 260 may comprise a hybrid source-detector array 270 comprising a detector array 14a-m and light source array 15a-n that in the embodiment of FIG. 25D are interleaved. Complexity of assembly and thickness may be advantageously reduced.

The light source array 15a-n may comprise visible light sources such as emitters 230, wavelength conversion material 232 arranged in wells 234. Light source array 15a-n may additionally comprise infra-red light sources 231. The number of infra-red light sources 231 may be the same or different to the number of visible light sources 230, 232. Alternatively the visible light sources 230, 232 may be omitted.

The light generation elements 230 for visible scene illumination may be interleaved with the light generation elements 231 for LIDAR scene illumination. The light generation elements 231 may also be interleaved with elements of light detector array 14a-m. The light detector array 14a-m and light sources 231 of the light source array 15a-n may comprise an infra-red filter 249 to aid discrimination of detected light 449 reflected from the scene.

A compact LIDAR and headlight apparatus may be provided in a small package at low cost and complexity.

In the alternative embodiment of FIG. 25B, and variations of optical system 250 as described elsewhere herein, and further comprising the hybrid source-detector array 270 of FIG. 25D then the directional illumination device 100 and directional detection device 104 are combined and operation for illumination light output from array of light sources 15a-n and detected light input to array of detectors 115a-m is achieved. The directional illumination and detection device 100, 104 may comprise extraction reflector 140 which is also injection reflector 142; input reflector 62 which is also output reflector 162; input face 22 which is also output face 122; array of light sources 15a-n which is also array of detectors 115a-m; input section 12 which is also output section 112; lens 61 which is also lens 161 and control system 500 is provided as well as detection system 560.

FIG. 25D further illustrates that the array of light detectors 115a-m are also distributed in the transverse direction 197. Each detection optical cone of the array of detection optical cones 126a-n is directed onto the corresponding detector of the array of detectors 115a-n by the optical system 250. The light detector array 115a-n may comprise a photo diode array, an avalanche photo diode array, or other detector adapted to receive infra-red light reflected from objects in the scene.

The array of light detectors 115a-m may have pitches in the lateral and transverse directions 195, 197 with a ratio that is the same as the inverse of the ratio of optical powers K_{L}, K_{T} of the lateral and transverse anamorphic optical elements 110, 60. In operation the detection optical cones 126 have the same angular extent in the lateral and transverse directions 195, 197.

The control system 560 illustrated in FIG. 25A is arranged to determine the received signal from the detection optical cones 126a-n and reconstruct the scene geometry. The detection method may be of the “time of flight” type where the elapsed time between an emitted light pulse and its detection when reflected back from objects in the scene is measured and converted to a distance given the known speed of light. This type of emitter does not need to have high coherence. Alternatively, the detectors may be of the homodyne type where the phase difference of the reflected light is compared to the phase of the emitted light to infer a distance within a period of 2π. In this case the light emission elements 231 need to have reasonable coherence. Alternatively, the light emission elements 231 may comprise lasers emitting a frequency modulated or chirped frequency signal. The reflected signal may be compared with the emitted signal to derive a distance based on the frequency difference. This approach need not have the 2π distance repeat interval, or “wrap around”. The detector system 260 may further comprise optical components (not shown) such as beam splitters and electronic signal processing to facilitate homodyne signal detection.

Alternative arrangements of various components of the waveguide 1 will now be described.

FIG. 25E is a schematic diagram illustrating in side view an alternative arrangement of an anamorphic directional illumination and light detection device 104 comprising plural members 168A, 168B, 169A and the waveguide 1. Features of the embodiment of FIG. 25E not discussed in further detail may be assumed to correspond to the features with equivalent reference numerals as discussed above, including any potential variations in the features.

In the alternative embodiment of FIG. 25E, the transverse anamorphic component 60 further comprises a lens 61. The waveguide 1 has an end 2 that is an output face 122 that is arranged to output the light that has been guided between the front and rear guide surfaces 8, 6, and the output section 112 is a separate element from the waveguide 1 that further comprises an input face 123 and is arranged to receive the light output from the waveguide 1 through the input face 123.

The transverse anamorphic component 60 comprises a lens 161, that is optionally a compound lens 161A-E, for example that is similar to the compound lens 61A-E of FIG. 7B hereinabove.

The output section 112 further comprises a separation face 123 extending outwardly from the one of the front or rear guide surfaces 8, 6 to the output face 122. The various advantages of the alternative embodiment of FIG. 25E are similar or the same to the advantages described for FIG. 1F described hereinabove.

FIG. 25F is a schematic diagram illustrating in front perspective view an anamorphic directional illumination and light detection device 104 comprising a waveguide 1 comprising a curved reflective lateral anamorphic component 110 that is an injection reflector 142 and a transverse anamorphic component 60 that is a lens 161. Features of the embodiment of FIG. 25F not discussed in further detail may be assumed to correspond to the features with equivalent reference numerals as discussed above, including any potential variations in the features.

The waveguide 1 has an end 2 that is an output face 122 that is arranged to output the light that has been guided between the front and rear guide surfaces 8, 6, the illumination and light detection system 260 being arranged to receive the light output through the output face 122 of the waveguide 1. The transverse anamorphic component 60 is disposed outside the waveguide 1, and the illumination and light detection system 260 is arranged to receive light from the waveguide 1 through the transverse anamorphic component 60.

The direction of the optical axis 199 through the transverse anamorphic component 60 is inclined at an acute angle α with respect to the front and rear guide surfaces 8, 6 of the waveguide 1 and the output face 122 is inclined at an acute angle α′ with respect to the front and rear guide surfaces 8, 6 of the waveguide 1.

The various advantages of the alternative embodiment of FIG. 25F are similar or the same to the advantages described for FIGS. 7A-C and FIG. 8 described hereinabove for illumination purposes may be applied with corresponding advantages for detection purposes.

FIG. 25G is a schematic diagram illustrating in side view an alternative arrangement of anamorphic directional illumination and light detection device 104 wherein the rear guide surface 6 and output face 122 are arranged on a common surface. Features of the embodiment of FIG. 25G not discussed in further detail may be assumed to correspond to the features with equivalent reference numerals as discussed above, including any potential variations in the features.

The output face 122 extends parallel to the front guide surface 8 in the case that the output face 122 is on the front side of the waveguide 1 or to the rear guide surface in the case that the output face 122 is on the rear side of the waveguide 1. The output face 122 is coplanar with the front guide surface 8 in the case that the output face 122 is on the front side of the waveguide 1 or with the rear guide surface in the case that the output face 122 is on the rear side of the waveguide 1.

The direction of the optical axis 199 through the transverse anamorphic component 60 is inclined at an acute angle δ with respect to the front and rear guide surfaces 8, 6 of the waveguide 1.

In general, the optical system 250 in the embodiment of FIG. 25A may be replaced by any of the optical systems disclosed herein with reference to an anamorphic directional illumination device 100.

The various advantages of the alternative embodiment of FIG. 25G are similar or the same to the advantages described for FIG. 1K and the various alternatives of FIGS. 1G-J and FIGS. 1L-N described hereinabove for illumination purposes may be applied with corresponding advantages for detection purposes.

FIG. 25H is a schematic diagram illustrating in rear perspective view an anamorphic directional illumination and light detection device 104 comprising a curved output face 122 and a curved detector array 115a-m; and FIG. 25I is a schematic diagram illustrating in front view an anamorphic directional illumination and light detection device 104 wherein the output end 2 of the waveguide 1 has curvature in the lateral direction 195. Features of the embodiments of FIGS. 25H-I not discussed in further detail may be assumed to correspond to the features with equivalent reference numerals as discussed above, including any potential variations in the features.

In the alternative embodiment of FIGS. 25H-I, at least one of an output face 122, the transverse anamorphic component 60 and the array of light detectors 115a-m has a curvature in the lateral direction 195 that compensates for field curvature of the injection reflector 142.

The various advantages of the alternative embodiment of FIGS. 25H-I are similar or the same to the advantages described for FIG. 13 and FIG. 14A and the various alternatives of FIGS. 14B-E described hereinabove for illumination purposes may be applied with corresponding advantages for detection purposes.

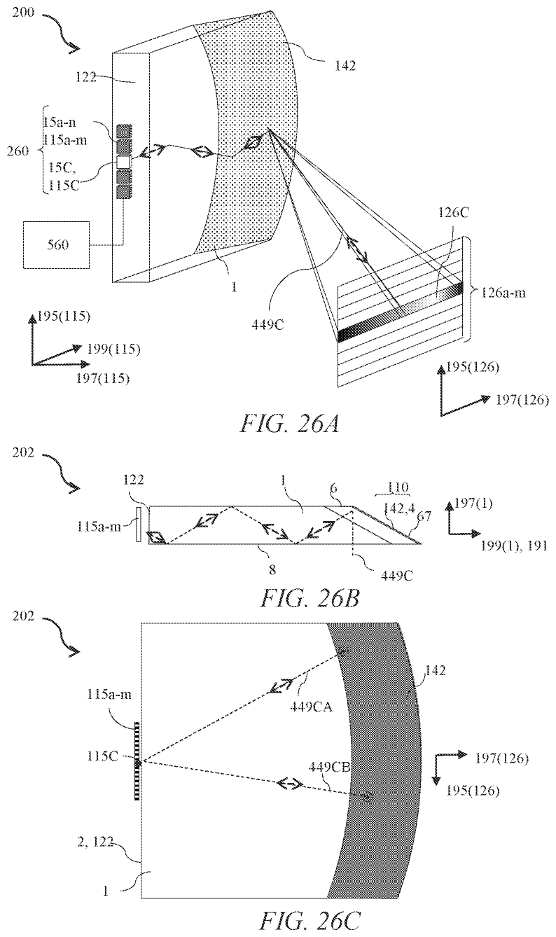

FIG. 26A is a schematic diagram illustrating in front perspective view a directional illumination and light detection device 104 comprising a waveguide 1 with a curved reflective lateral anamorphic component 110 arranged to detect a one-dimensional array of illumination and light detection optical cones 126a-m; FIG. 26B is a schematic diagram illustrating in side view the directional illumination and light detection device 104 of FIG. 26A; and FIG. 26C is a schematic diagram illustrating in front view the directional illumination and light detection device 104 of FIG. 26A. Features of the embodiments of FIGS. 26A-C not discussed in further detail may be assumed to correspond to the features with equivalent reference numerals as discussed above, including any potential variations in the features.

In the alternative embodiment of FIGS. 26A-C, the optical system 250 has no optical power in a transverse direction 197 that is perpendicular to the lateral direction 195.

Further, the waveguide 1 has an end 2 that is an output face 122 that is arranged to output the light 449 that has been guided between the front and rear guide surfaces 8, 6, the illumination and light detection system 260 being arranged to receive the light output through the output face 122 of the waveguide 1.

The various advantages of the alternative embodiment of FIGS. 26A-C are similar or the same to the advantages described for FIGS. 21A-C described hereinabove for illumination purposes may be applied with corresponding advantages for detection purposes.

As may be used herein, the terms “substantially” and “approximately” provide an industry-accepted tolerance for its corresponding term and/or relativity between items. Such an industry-accepted tolerance ranges from zero percent to ten percent and corresponds to, but is not limited to, component values, angles, et cetera. Such relativity between items ranges between approximately zero percent to ten percent.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

1. An anamorphic directional illumination device comprising:
an illumination system comprising an array of light sources distributed in a lateral direction, the illumination system being arranged to output light from the light sources; and
an optical system arranged to receive light from the illumination system, wherein the optical system has an optical axis and has anamorphic properties in the lateral direction and a transverse direction that are perpendicular to each other and perpendicular to the optical axis, wherein the optical system comprises:
a transverse anamorphic component having positive optical power in the transverse direction, wherein the transverse anamorphic component is arranged to receive light from the illumination system and the illumination system is arranged so that light output from the transverse anamorphic component is directed in directions that are distributed in the transverse direction; and
a waveguide comprising:
front and rear guide surfaces arranged to guide light from the transverse anamorphic component along the waveguide;
an extraction reflector arranged to reflect light that has been guided along the waveguide, wherein the extraction reflector is a lateral anamorphic component having positive optical power in the lateral direction and the extraction reflector is oriented to extract light out of the waveguide through at least one of the guide surfaces as output illumination.

2. An anamorphic directional illumination device according to claim 1, wherein the optical system comprises an input section comprising an input reflector that is the transverse anamorphic component and is arranged to reflect the light from the illumination system and direct it along the waveguide.

3. An anamorphic directional illumination device according to claim 2, wherein the transverse anamorphic component further comprises a lens.

4. An anamorphic directional illumination device according to claim 2, wherein the input section further comprises an input face disposed on a front or rear side of the waveguide and facing the input reflector, and the input section is arranged to receive the light from the illumination system through the input face.

5. An anamorphic directional illumination device according to claim 4, wherein the input face extends at an acute angle to the front guide surface in the case that the input face is on the front side of the waveguide or to the rear guide surface in the case that the input face is on the rear side of the waveguide.

6. An anamorphic directional illumination device according to claim 4, wherein the input face extends parallel to the front guide surface in the case that the input face is on the front side of the waveguide or to the rear guide surface in the case that the input face is on the rear side of the waveguide.

7. An anamorphic directional illumination device according to claim 6, wherein the input face is coplanar with the front guide surface in the case that the input face is on the front side of the waveguide or with the rear guide surface in the case that the input face is on the rear side of the waveguide.

8. An anamorphic directional illumination device according to claim 4, wherein the input face is disposed outwardly of one of the front or rear guide surfaces.

9. An anamorphic directional illumination device according to claim 8, wherein the input section further comprises a separation face extending outwardly from the one of the front or rear guide surfaces to the input face.

10. An anamorphic directional illumination device according to claim 2, wherein the input section is integral with the waveguide.

11. An anamorphic directional illumination device according to claim 2, wherein
the waveguide has an end that is an input face through which the waveguide is arranged to receive light from the illumination system, and
the input section is a separate element from the waveguide that further comprises an output face and is arranged to direct light reflected by the input reflector through the output face and into the waveguide through the input face of the waveguide.

12. An anamorphic directional illumination device according to claim 1, wherein the transverse anamorphic component comprises a lens.

13. An anamorphic directional illumination device according to claim 12, wherein the lens of the transverse anamorphic component is a compound lens.

14. An anamorphic directional illumination device according to claim 1, wherein the waveguide has an end that is an input face through which the waveguide is arranged to receive light from the illumination system.

15. An anamorphic directional illumination device according to claim 14, wherein the transverse anamorphic component is disposed outside the waveguide, and the waveguide is arranged to receive light from the transverse anamorphic component through the input face.

16. An anamorphic directional illumination device according to claim 14, wherein the direction of the optical axis through the transverse anamorphic component is inclined at an acute angle with respect to the front and rear guide surfaces of the waveguide.

17. An anamorphic directional illumination device according to claim 14, wherein the input face is inclined at an acute angle with respect to the front and rear guide surfaces of the waveguide.

18. An anamorphic directional illumination device according to claim 1, wherein the extraction reflector is an end of the waveguide.

19. An anamorphic directional illumination device according to claim 1, wherein at least one of an input face of the waveguide, the transverse anamorphic component and the array of light sources has a curvature in the lateral direction that compensates for field curvature of the extraction reflector.

20. An anamorphic directional illumination device according to claim 1, wherein the front and rear guide surfaces of the waveguide are planar and parallel.

21. An anamorphic directional illumination device according to claim 1, wherein the array of light sources comprises a spatial light modulator.

22. An anamorphic directional illumination device according to claim 1, wherein the light sources are light emitting diodes.

23. An anamorphic directional illumination device according to claim 22, wherein the light emitting diodes each comprise:
a well;
a light generation element disposed in the well and arranged to generate light in an emission band; and
wavelength conversion material disposed in the well and arranged to convert at least some of light in the emission band into a conversion band,
wherein the light generation elements are disposed at different positions within the wells in which they are disposed, the different positions being arranged to compensate for chromatic dispersion in the output illumination.

24. An anamorphic directional illumination device according to claim 1, wherein the array of light sources comprise a backlight and a mask illuminated by the backlight, the mask having an array of apertures to form the light sources.

25. An anamorphic directional illumination device according to claim 1, wherein the array of light sources are also distributed in the transverse direction so that the light output from the transverse anamorphic component is directed in the directions that are distributed in the transverse direction.

26. An anamorphic directional illumination device according to claim 25, wherein the array of light sources have pitches in the lateral and transverse directions with a ratio that is the same as the inverse of the ratio of optical powers of the lateral and transverse anamorphic optical elements.

27. An anamorphic directional illumination device according to claim 25, wherein the array of light sources comprises two sub-arrays of light sources, each sub-array of light sources being distributed in both the lateral direction and the transverse direction, wherein the sub-arrays of light sources have pitches in the lateral and transverse directions that are different as between the sub-arrays.

28. An anamorphic directional illumination device according to claim 25, further comprising a mask extending across the array of light sources, the mask being arranged to shape a transverse boundary of the output illumination.

29. An anamorphic directional illumination device according to claim 1, wherein the illumination system further comprises a deflector element arranged to deflect light output from the transverse anamorphic component by a selectable amount, the deflector element being selectively operable to direct the light output from the transverse anamorphic component in the directions that are distributed in the transverse direction.

30. An anamorphic directional illumination device according to claim 1, wherein the extraction reflector is oriented to extract light out of the waveguide through the front guide surfaces as output illumination.

31. An anamorphic directional illumination device according to claim 1, wherein the illumination system comprises plural arrays of light sources and a light combiner arranged to combine light from each of the arrays of light sources to form the output light of the illumination system.

32. An anamorphic directional illumination device according to claim 1, further comprising a further light source arranged behind the rear guide surfaces of the waveguide to output light through the waveguide.

33. An anamorphic directional illumination device according to claim 1, further comprising a light sensor arranged behind the rear guide surfaces of the waveguide to receive light through the waveguide.

34. An anamorphic directional illumination device according to claim 1, wherein the anamorphic directional illumination device comprises plural illumination systems and plural optical systems, wherein each optical system is arranged to receive light from a respective illumination system, and the waveguides of each optical system are stacked to provide output illumination in a common direction.

35. An anamorphic directional illumination device according to claim 34, wherein each illumination system and the corresponding optical system are arranged to provide output illumination into optical cones having angular pitches that are different in at least one of the transverse and lateral directions.

36. An anamorphic directional illumination device according to claim 1, wherein the light from the light sources is visible light or infra-red light.

37. An anamorphic directional illumination device according to claim 1, wherein the array of light sources comprises light sources with different spectral outputs.

38. An anamorphic directional illumination device according to claim 37, wherein the different spectral outputs include: a white light spectrum, plural different white light spectra, red light, orange light, and/or infra-red light.

39. An anamorphic directional illumination device according to claim 1, further comprising a control system arranged to selectively control the illumination system.

40. An anamorphic directional illumination device according to claim 1, being a directional illumination device for vehicle external light apparatus, wherein the light from the light sources is visible light.

41. A vehicle external light apparatus comprising:
a housing for fitting to a vehicle;
a transmissive cover extending across the front guide surface of the waveguide; and
an anamorphic directional illumination device according to claim 40 mounted on the housing and arranged to direct the output illumination through the transmissive cover.

42. A vehicle external light apparatus according to claim 41, wherein the output illumination is collimated output illumination.

43. A vehicle external light apparatus according to claim 41, further comprising an actuator arranged to move the array of light sources in the transverse direction.

44. A vehicle external light apparatus according to claim 41, being a vehicle headlight apparatus wherein optionally the luminous flux of output illumination is at least 100 lumens.

45. A vehicle external light apparatus according to claim 41, being a vehicle reversing light apparatus or a vehicle brake light apparatus.

46. An anamorphic directional illumination device according to claim 1 being an anamorphic directional illumination device for a light detection and ranging apparatus, wherein the light from the light sources is infra-red light.

47. A light detection and ranging apparatus comprising an anamorphic directional illumination device according to claim 46.

48. A light detection and ranging apparatus according to claim 47, further comprising a control system arranged to selectively control the illumination system to operate the light sources successively for scanning of the output illumination.

49. An image projection apparatus comprising an anamorphic directional illumination device according to claim 1 that is arranged to focus the output illumination on a focal plane.

50. An image projection apparatus according to claim 49, further comprising a lens having positive optical power arranged to focus the output illumination on the focal plane.

51. An image projection apparatus according to claim 49, wherein the extraction reflector has positive optical power in the lateral direction and in the transverse direction.

52. A directional illumination device comprising:
an array of light sources distributed in a lateral direction; and
a waveguide arranged to receive light from the array of light sources, wherein the waveguide comprises:
front and rear guide surfaces arranged to guide light from the light sources along the waveguide; and
an extraction reflector arranged to reflect light that has been guided along the waveguide, wherein the extraction reflector has positive optical power in the lateral direction and is oriented to extract light out of the waveguide through at least one of the guide surfaces as output illumination.

53. A directional illumination device according to claim 52, wherein the optical system has no optical power in a transverse direction that is perpendicular to the lateral direction.

54. A directional illumination device according to claim 52, wherein the array of light sources have an arrangement such that an intensity of light emitted by the light sources summed along each line through the light sources in the transverse direction is the same.

55. A directional illumination device according to claim 54, wherein the array of light sources are also distributed in the transverse direction.

56. A directional illumination device according to claim 52, wherein the extraction reflector is an end of the waveguide.

57. A directional illumination device according to claim 52, wherein the waveguide has an end that is an input face through which the waveguide is arranged to receive light from the illumination system.

58. A directional illumination device according to claim 52, further comprising an input section comprising an input reflector that is arranged to reflect the light from the illumination system and direct it along the waveguide.

59. A directional illumination device according to claim 58, wherein the input section further comprises an input face disposed on a front or rear side of the waveguide and facing the input reflector, wherein the input section is arranged to receive the light from the illumination system through the input face.

60. A directional illumination device according to claim 59, wherein the input face extends at an acute angle to the front guide surface in the case that the input face is on the front side of the waveguide or to the rear guide surface in the case that the input face is on the rear side of the waveguide.

61. A directional illumination device according to claim 59, wherein the input face extends parallel to the front guide surface in the case that the input face is on the front side of the waveguide or to the rear guide surface in the case that the input face is on the rear side of the waveguide.

62. A directional illumination device according to claim 61, wherein the input face is coplanar with the front guide surface in the case that the input face is on the front side of the waveguide or with the rear guide surface in the case that the input face is on the rear side of the waveguide.

63. A directional illumination device according to claim 59, wherein the input face is disposed outwardly of one of the front or rear guide surfaces.

64. A directional illumination device according to claim 56, wherein the input section further comprises a separation face extending outwardly from the one of the front or rear guide surfaces to the input face.

65. A directional illumination device according to claim 58, wherein the input section is integral with the waveguide.

66. A directional illumination device according to claim 58, wherein
the waveguide has an end that is an input face through which the waveguide is arranged to receive light from the illumination system, and
the input section is a separate element from the waveguide that further comprises an output face and is arranged to direct light reflected by the input reflector through the output face and into the waveguide through the input face of the waveguide.

67. A directional illumination device according to claim 52, wherein the front and rear guide surfaces of the waveguide are planar and parallel.

68. A directional illumination device according to claim 52, wherein at least one of an input face of the waveguide, the transverse anamorphic component and the array of light sources has a curvature in the lateral direction that compensates for field curvature of the extraction reflector.

69. A directional illumination device according to claim 52, wherein the light sources are light emitting diodes.

70. A directional illumination device according to claim 52, wherein the extraction reflector is oriented to extract light out of the waveguide through the front guide surfaces as output illumination.

71. A directional illumination device according to claim 52, wherein the light from the light sources is visible light or infra-red light.

72. A directional illumination device according to claim 52, wherein the array of light sources comprises light sources with different spectral outputs.

73. A directional illumination device according to claim 72, wherein the different spectral outputs include: a white light spectrum, plural different white light spectra, red light, orange light, and/or infra-red light.

74. A directional illumination device according to claim 52 that is also a light detection device and further comprises:
a light detection system comprising an array of light detectors distributed in a lateral direction in an area overlapping with the array of light sources, wherein
the optical system is also arranged to input light from a remote scene and direct the input light to the light detection system in an opposite direction through the optical system from the light received from the illumination system.
